(19) United States
(12) Patent Application Publication
(10) Pub. No.: US 2026/0350139 A1
(43) Pub. Date: Nov. 5, 2026

(54) AI Agent-Based Access Entitlement Management via User Interface Interaction in Enterprise Systems

(71) Applicant: RedBlock Security, Inc., San Ramon, CA (US)

(72) Inventors: Indus KHAITAN, Dublin, CA (US); Rajvardhan KHAITAN, Dublin, CA (US); Basem RIZK, Pleasant Hill, CA (US); Aviral SRIVASTAVA, Bengaluru (IN)

(73) Assignee: RedBlock Security, Inc., San Ramon, CA (US)

(21) Appl. No.: 19/666,229

(22) Filed: May 2, 2026

Related U.S. Application Data
(60) Provisional application No. 63/799,167, filed on May 2, 2025.
(60) Provisional application No. 63/799,176, filed on May 2, 2025.
(60) Provisional application No. 63/799,184, filed on May 2, 2025.
(60) Provisional application No. 63/799,188, filed on May 2, 2025.
(60) Provisional application No. 63/799,193, filed on May 2, 2025.
(60) Provisional application No. 63/799,199, filed on May 2, 2025.
(60) Provisional application No. 63/810,356, filed on May 22, 2025.
(60) Provisional application No. 63/837,276, filed on Jul. 2, 2025.
(60) Provisional application No. 63/872,640, filed on Aug. 29, 2025.
(60) Provisional application No. 63/872,656, filed on Aug. 29, 2025.
(60) Provisional application No. 63/872,665, filed on Aug. 29, 2025.
(60) Provisional application No. 63/878,629, filed on Sep. 9, 2025.
(60) Provisional application No. 63/880,059, filed on Sep. 11, 2025.
(60) Provisional application No. 63/881,837, filed on Sep. 15, 2025.
(60) Provisional application No. 63/887,721, filed on Sep. 25, 2025.

(51) Int. Cl. G06F 21/45; G06F 21/44; G06F 21/60; G06F 21/62; G06V 10/764

(52) U.S. Cl. CPC G06F 21/45; G06F 21/44; G06F 21/602; G06F 21/6209; G06V 10/764; G06F 2221/2113; G06F 2221/2141

(57) ABSTRACT

The present disclosure provides a computer-implemented method for automated management of user entitlements across a set of enterprise applications, including applications not integrated with identity and access management (IAM) systems. The method includes receiving an audit trigger from an identity governance system, querying entitlement data such as user identifiers, roles, and role-specific attributes from connected and disconnected applications and identifying entitlement violations based on predefined access control policies. The system performs corrective actions by revoking or modifying access privileges using either native application programming interfaces (APIs) or an artificial intelligence agent configured to interact with application graphical user interfaces (GUIs). The AI agent incorporates a computer vision module to detect entitlement-related GUI elements and a language models to interpret semantic context, thereby enabling automated remediation in systems lacking programmable interfaces. The disclosed invention ensures continuous entitlement compliance, minimizes manual effort, and extends governance coverage beyond traditional IAM boundaries.

### PRIORITY DATA

This application claims the benefit of U.S. Provisional Patent Application No. 63/799,167, filed on May 2, 2025, titled “SYSTEM AND METHOD FOR AGGREGATING API KEYS FROM APPLICATIONS USING ARTIFICIAL INTELLIGENCE” (Atty. Docket No. RDBL1000USP01); U.S. Provisional Patent Application No. 63/799,176, filed on May 2, 2025, titled “SYSTEM AND METHOD FOR UPDATING AND PROPAGATING API KEYS USING ARTIFICIAL INTELLIGENCE” (Atty. Docket No. RDBL1001USP01); U.S. Provisional Patent Application No. 63/799,184, filed on May 2, 2025, titled “SYSTEM FOR REPORTING AND ACTIONING OF USER ROLES IN IDENTITY GOVERNANCE CONTEXT USING ARTIFICIAL INTELLIGENCE” (Atty. Docket No. RDBL1002USP01); U.S. Provisional Patent Application No. 63/799,188, filed on May 2, 2025, titled “SYSTEM FOR DETECTION AND REMEDIATION OF SECURITY CONFIGURATION DRIFTS IN WEB APPLICATIONS USING INTERFACE-CENTRIC AI AGENTS” (Atty. Docket No. RDBL1003USP01); U.S. Provisional Patent Application No. 63/799,193, filed on May 2, 2025, titled “SYSTEM AND METHOD FOR CAPTURING AND AUDITING WEB-BASED AI AGENT INTERACTIONS” (Atty. Docket No. RDBL1004USP01); U.S. Provisional Patent Application No. 63/799,199, filed on May 2, 2025, titled “SYSTEM AND METHOD FOR AUTOMATED CREDENTIAL GENERATION AND PROPAGATION BASED ON ARTIFICIAL INTELLIGENCE AGENTS” (Atty. Docket No. RDBL1005USP01); U.S. Provisional Patent Application No. 63/810,356, filed on May 22, 2025, titled “System and Method for Deterministic Validation of Automation Workflows Guided by Large Language Models” (Atty. Docket No. RDBL1006USP01); U.S. Provisional Patent Application No. 63/837,276, filed on Jul. 2, 2025, titled “SYSTEM AND METHOD FOR AUTOMATED EXPLORATION OF APPLICATION SOFTWARE” (Atty. Docket No. RDBL1007USP01); U.S. Provisional Patent Application No. 63/880,059, filed on Sep. 11, 2025, titled “SYSTEM AND METHOD FOR AUTOMATED EXPLORATION OF APPLICATION SOFTWARE” (Atty. Docket No. RDBL1007USP02); U.S. Provisional Patent Application No. 63/872,640, filed on Aug. 29, 2025, titled “SYSTEM AND METHOD FOR INTEGRATING NON-API APPLICATIONS WITH IDENTITY PLATFORMS BASED ON ARTIFICIAL INTELLIGENCE” (Atty. Docket No. RDBL1008USP01); U.S. Provisional Patent Application No. 63/878,629, filed on Sep. 9, 2025, titled “SYSTEM AND METHOD FOR INTEGRATING NON-API APPLICATIONS WITH IDENTITY PLATFORMS BASED ON ARTIFICIAL INTELLIGENCE” (Atty. Docket No. RDBL1008USP02); U.S. Provisional Patent Application No. 63/887,721, filed on Sep. 25, 2025, titled “HIERARCHICAL STRUCTURING OF GRAPHICAL USER INTERFACE ELEMENTS IN APPLICATION SOFTWARE PAGES” (Atty. Docket No. RDBL1009USP01); U.S. Provisional Patent Application No. 63/872,656, filed on Aug. 29, 2025, titled “SYSTEM AND METHOD FOR IDENTITY-CENTRIC ACTIVITY LOG CAPTURE FROM APPLICATIONS LACKING PROGRAMMATIC INTERFACES” (Atty. Docket No. RDBL1010USP01); U.S. Provisional Patent Application No. 63/872,665, filed on Aug. 29, 2025, titled “AGENTIC ARTIFICIAL INTELLIGENCE FOR AUTOMATED CONNECTOR CONFIGURATION AND APPLICATION ONBOARDING IN IDENTITY PLATFORMS” (Atty. Docket No. RDBL1011USP01); and U.S. Provisional Patent Application No. 63/881,837, filed on Sep. 15, 2025, titled “TASK-SPECIFIC HIGH-LEVEL LANGUAGE FRAMEWORK FOR STRUCTURED INTERACTION WITH LARGE LANGUAGE MODELS” (Atty. Docket No. RDBL1012USP01). All of the foregoing provisional applications are hereby incorporated by reference for all purposes.

### TECHNICAL FIELD

The technology disclosed relates to artificial intelligence type computers and digital data processing systems and corresponding data processing methods and products for emulation of intelligence (i.e., knowledge based systems, reasoning systems, and knowledge acquisition systems); and including systems for reasoning with uncertainty (e.g., fuzzy logic systems), adaptive systems, machine learning systems, and artificial neural networks. Specifically, the technology relates to enterprise identity governance systems and, more particularly, to a system and method for automated reporting and actioning of user roles and entitlements across connected and disconnected applications within an enterprise software environment.

### BACKGROUND OF THE INVENTION

Modern enterprises operate across hundreds of software applications spanning cloud-native platforms, legacy on-premises systems, and disconnected enterprise tools. Each employee holds access entitlements that must be modified or revoked as the employee transitions between roles, completes projects, or departs the organization. Identity and access management (IAM) platforms automate provisioning and deprovisioning for applications integrated through programmatic interfaces, including application programming interfaces (APIs), directory services, and federated identity protocols. However, a significant portion of enterprise applications, including legacy accounting systems, proprietary compliance dashboards, partner-hosted financial platforms, field service applications, and disconnected document archives, do not expose programmatic interfaces and remain accessible for entitlement management only through a user interface. The IAM platform is unable to communicate programmatically with these applications, and user access entitlements in these applications fall outside the automated governance boundary. The result is a coverage gap that produces orphan accounts after employee departure, retention of role-inappropriate privileges after role transitions, and recurring compliance violations under regulatory frameworks such as the Sarbanes-Oxley Act (SOX), the Health Insurance Portability and Accountability Act (HIPAA), and the General Data Protection Regulation (GDPR).

Identity governance and administration (IGA) platforms attempt to address the coverage gap through periodic access reviews on recurring schedules, such as every thirty, sixty, or ninety calendar days, but these reviews are passive and retrospective. The IGA platform generates reports, while the actual modification of access privileges, including revoking access or downgrading the role of a user, requires manual intervention by an administrator who navigates the user interface of each application individually. Robotic process automation (RPA) technologies have been applied as an alternative to manual remediation, but conventional RPA bots operate on static, pre-programmed user interface scripts tightly coupled to a specific layout, label set, and navigation structure. When the application vendor repositions user interface elements, modifies labels, or restructures navigation menus, the RPA script fails and requires manual reconfiguration by a developer. Conventional RPA bots also have limited capacity to interpret the semantic meaning of user interface elements and do not reliably distinguish between a button labeled “Revoke Access” and a button labeled “Modify Role” based on textual content alone. Accordingly, a need exists for a system that automatically discovers, evaluates, and remediates user access entitlements across both programmatically integrated and disconnected enterprise applications, that adapts to changes in user interface layouts and labels without reconfiguration, and that produces tamper-evident audit records of every entitlement modification across the full enterprise application estate.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates an exemplary system architecture of an application management platform for deploying one or more artificial intelligence (AI) agent systems for enterprise application management, according to certain embodiments.

FIG. 1B illustrates an exemplary system architecture of a single AI agent system deployed within a network environment including a plurality of enterprise users, a plurality of agent command systems, and a set of enterprise applications, according to certain embodiments.

FIG. 1C illustrates an alternative system architecture of the application management platform in which the AI agent system is communicatively coupled to agent command systems and a set of enterprise applications through a plurality of networks, according to certain embodiments.

FIG. 2A illustrates an architectural diagram depicting an evolution of enterprise infrastructure models from network centric paradigms to application and data centric paradigms, according to certain embodiments.

FIG. 2B is a block diagram of an AI agent-based enterprise identity orchestration and credential automation platform, according to certain embodiments.

FIG. 2C is an architectural diagram illustrating integration of AI agent-based identity governance across connected applications and disconnected applications within a hybrid enterprise infrastructure, according to certain embodiments.

FIG. 2D is a connectivity framework diagram between enterprise users, an identity control system, and a plurality of applications integrated with an AI agent system, according to certain embodiments.

FIG. 2E is a system workflow diagram showing an AI agent driven remediation process initiated by contextual security signals and executed across enterprise applications, according to certain embodiments.

FIG. 2F illustrates a conceptual diagram depicting AI agent behavioral learning for autonomous execution of identity lifecycle tasks across a large set of business applications, according to certain embodiments.

FIG. 3A illustrates an exemplary internal architecture of an agentic AI platform including a perception module, a planning module, an execution module, and supporting identity governance modules deployed within an enterprise network infrastructure, according to certain embodiments.

FIG. 3B illustrates a system architecture of a graphical user interface (GUI)-based agentic AI credential automation system configured to interface with producer applications, consumer applications, and a credential vault via GUI-based interactions, according to certain embodiments.

FIG. 4 is a block diagram of a system for managing user entitlements across a plurality of enterprise applications, according to certain embodiments.

FIG. 5 is a high-level process flow diagram depicting a computer-implemented method for managing user entitlements across a plurality of enterprise applications, according to certain embodiments.

FIG. 6 is a method flowchart depicting an entitlement management workflow with dual-pathway decision logic, according to certain embodiments.

FIG. 7 illustrates a semantic interpretation module processing pipeline for generating per-element structured records from on-screen textual content, according to certain embodiments.

FIG. 8 is an architectural diagram illustrating a dual-pathway entitlement discovery process across programmatically accessible and user-interface-accessible enterprise applications, according to certain embodiments.

FIG. 9 illustrates the sequential operation of an AI agent three-module pipeline on the user interface of an enterprise application, according to certain embodiments.

FIG. 10 is a block diagram illustrating a dual-pathway enforcement architecture with post-modification verification, according to certain embodiments.

FIG. 11 is a reference diagram illustrating trigger taxonomy, access control policy types, and violation categories, according to certain embodiments.

FIG. 12 is a sequence diagram illustrating a credential vault authentication process for the AI agent, according to certain embodiments.

FIG. 13 illustrates an audit log record structure and a centralized governance dashboard, according to certain embodiments.

FIG. 14 illustrates a dynamic user interface adaptation process for the AI agent, according to certain embodiments.

FIG. 15 is a flowchart illustrating a continuous monitoring and anomaly detection process, according to certain embodiments.

FIG. 16 is a flowchart illustrating a severity classification and dual execution path process, according to certain embodiments.

FIG. 17 is a schematic representation of an encoder-decoder architecture.

FIG. 18 shows an overview of an attention mechanism added onto an RNN encoder-decoder architecture.

FIG. 19 is a schematic representation of the calculation of self-attention showing one attention head.

FIG. 20 is a depiction of several attention heads in a Transformer block.

FIG. 21 is an illustration that shows how one can use multiple workers to compute the multi-head attention in parallel, as the respective heads compute their outputs independently of one another.

FIG. 22 is a portrayal of one encoder layer of a Transformer network.

FIG. 23 shows a schematic overview of a Transformer model.

FIG. 24 is a depiction of a Vision Transformer (ViT).

FIG. 25 illustrates a processing flow of the Vision Transformer (ViT).

FIG. 26 shows example software code that implements a Transformer block.

FIG. 27 illustrates an example configuration of a computing device that can be used to implement the systems and techniques described herein.

### DETAILED DESCRIPTION

In the drawings, like reference numerals designate identical or corresponding parts throughout several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

### Overview

The implementations described herein introduce systems and methods for managing access entitlements across a plurality of enterprise systems through automated graphical user interface interaction performed by an artificial intelligence (AI) agent. In some implementations, an entitlement management system 400 obtains entitlement data from a plurality of enterprise systems including at least one enterprise system accessible for entitlement management only through a user interface. The entitlement management system identifies entitlement violations by evaluating the entitlement data against access control policies and by performing a cross-source comparison with user status data and role assignment data maintained in an identity governance system 402. The entitlement management system then executes at least one entitlement modification through an AI agent that detects user interface elements rendered on the user interface using a perception module applying a computer vision algorithm, interprets textual content associated with the user interface elements using a semantic interpretation module applying a language model, and applies the at least one entitlement modification using an execution module that generates and executes simulated user interactions with a target user interface element identified by the semantic interpretation module.

The disclosed approach addresses a coverage gap in enterprise identity governance that arises specifically from the architectural division between enterprise applications that expose programmatic interfaces and enterprise applications that do not. The disclosed mechanisms execute through processor instructions, operate on specific data structures, perform computer vision and natural language processing operations on rendered user interface content, and produce structured electronic outputs including tamper-evident log records and certifiable compliance reports. The disclosed mechanisms therefore improve the functioning of the computing infrastructure that performs identity governance operations, rather than implementing a known practice on a generic computer.

### Indicia of Novelty, Inventiveness, Non-Obviousness, and Subject-Matter Eligibility

Modern enterprise environments deploy hundreds, and in many cases thousands, of software applications across heterogeneous infrastructure that includes cloud-hosted services, on-premises legacy systems, third-party vendor portals, and partner-hosted applications. A first technical class of the enterprise applications exposes programmatic interfaces, including representational state transfer (REST) application programming interfaces (APIs), system for cross-domain identity management (SCIM) endpoints, and security assertion markup language (SAML) interfaces. A second technical class does not expose any programmatic interface and is accessible for entitlement management only through a user interface rendered on a screen. The two classes differ at the architectural level. Identity and access management (IAM) platforms, identity governance and administration (IGA) platforms, and privileged access management (PAM) platforms communicate with the first class through the programmatic interfaces and apply provisioning, deprovisioning, and entitlement modification operations through structured machine-to-machine commands. The same identity platforms have no machine-readable communication channel to the second class because the second class exposes no programmatic interface. The result is a coverage gap rooted in the technical architecture of the enterprise application estate.

The coverage gap is not a process or workflow problem solvable by procedural reorganization. The coverage gap is a technical incompatibility between the input expectations of the identity platforms (structured commands transmitted over programmatic interfaces) and the input expectations of the second class of enterprise applications (graphical user interactions performed on rendered user interface elements). When an enterprise application of the second class displays a “Revoke Access” button on a rendered user interface, the identity platform cannot transmit a command to that button, because the only mechanism the enterprise application accepts is a graphical user interaction performed on the rendered button. The coverage gap therefore exists precisely because the two classes of enterprise applications speak different machine languages, and the existing identity platforms speak only one of those languages.

The coverage gap produces measurable security exposures rooted in the operation of the computing infrastructure. When an employee departs the organization, the identity platform revokes access in enterprise applications of the first class through the programmatic interfaces and leaves access in enterprise applications of the second class undisturbed because the platform cannot transmit any command to those applications. The active access entitlements that remain in the second class constitute orphan accounts. Orphan accounts represent a documented attack surface. In one documented enterprise incident, a former employee's credentials to a disconnected enterprise application remained active after the employee's departure, were subsequently compromised through a dark web credential breach, and resulted in unauthorized access to sensitive enterprise data, exfiltration of confidential records, disruption of business operations, and escalation of regulatory scrutiny.

Existing approaches to closing the coverage gap fall into two categories, each with technical limitations rooted in the architecture of the approach. A first category, manual remediation, requires human administrators to log into each enterprise application of the second class, navigate to an entitlement management section of the user interface, and manually perform the entitlement modifications through human interactions with the rendered user interface elements. Manual remediation does not scale to the operational frequency required for compliance regimes including the Sarbanes-Oxley Act (SOX), the Health Insurance Portability and Accountability Act (HIPAA), and the General Data Protection Regulation (GDPR), each requiring timely and demonstrable enforcement. Manual remediation also produces no machine-readable audit trail tied to the specific user interface elements that were interacted with, leaving compliance auditability dependent on the contemporaneous notes of the human administrator. A second category, robotic process automation (RPA), uses scripted automation to record sequences of user interactions and replay the sequences against the user interface of the enterprise application. RPA scripts are bound to specific user interface element identifiers, including document object model selectors, coordinate positions, and hardcoded element labels, captured at the time the script is recorded. When the enterprise application modifies its user interface (repositioning a button, renaming a label, restructuring a form), the bound identifiers no longer resolve, and the RPA script fails. The brittleness of RPA at the user interface element binding level is a technical limitation rooted in the architecture of identifier-based scripting, not a workflow deficiency.

The technology disclosed introduces an AI agent that operates on rendered user interface content as a perceptual input rather than as a set of pre-bound identifiers. The AI agent comprises three modules that operate sequentially as a computational pipeline on the rendered user interface content. A perception module applies a computer vision algorithm to the rendered user interface content to detect and classify user interface elements associated with access privilege controls. The computer vision algorithm comprises convolutional neural networks, autoencoder-based models, or other deep learning architectures trained to recognize user interface element categories including entitlement selectors, user-role dropdowns, access revocation buttons, and user deactivation controls. The perception module produces, as output, a classification of each detected user interface element by its function relative to access privilege management, where the classification is determined from visual characteristics including shape, position, and spatial relationships to adjacent user interface elements rather than from any pre-bound identifier. The perception module therefore operates on the rendered user interface as image data and produces a structured representation of the user interface elements through a computer vision computational mechanism.

A semantic interpretation module receives the user interface elements detected and classified by the perception module and applies a language model to interpret the meaning of textual content associated with the detected user interface elements. The language model comprises a natural language processing model, a large language model, or a transformer-based text classification model. The semantic interpretation module distinguishes between user interface elements associated with different access privilege actions, including labels indicating revocation of access, modification of a role, deactivation of an account, and downgrading of privileges, by analyzing the semantic content of each label and mapping each label to a corresponding access privilege action. The semantic interpretation module selects from among the user interface elements detected by the perception module, a target user interface element corresponding to the entitlement modification determined by an entitlement actioning module. The semantic interpretation module therefore operates on rendered textual content as natural language input and produces a semantic mapping through a language model computational mechanism.

An execution module receives the target user interface element identified by the semantic interpretation module and applies the entitlement modification by generating and executing simulated user interactions with the target user interface element. The simulated user interactions comprise mouse click simulation, keyboard input simulation, and form field population. The execution module produces, as output, a sequence of programmatic instructions that simulate physical human interactions with the rendered user interface elements at the operating system input event level. The execution module therefore operates as a computational mechanism that translates the semantic output of the semantic interpretation module into operating system input events delivered to the enterprise application.

The three-module sequential architecture of the AI agent (the perception module, the semantic interpretation module, and the execution module) is a non-conventional and non-generic arrangement of computer vision, natural language processing, and input event simulation components, where each component operates on the output of the preceding component. The architecture does not bind to any pre-recorded user interface element identifier, and the architecture does not require reconfiguration when the enterprise application modifies its user interface. When the enterprise application repositions user interface elements, modifies labels, or updates interface layouts, the perception module re-detects the user interface elements from the rendered content, the semantic interpretation module re-interprets the textual content of the re-detected elements, and the execution module generates new simulated user interactions appropriate to the updated interface. The technical brittleness that limits RPA at the user interface element binding level is therefore eliminated through the three-module computational architecture, not through workflow modification.

The technology disclosed further introduces a cross-source comparison mechanism that operates on two distinct data sources. A first data source is entitlement data extracted by the AI agent from the user interfaces of the enterprise applications. A second data source is user status data and role assignment data maintained in the identity governance system. The user status data comprises, for each user, an indication of the user's organizational status including at least an active status, a terminated status, a departed status, or a leave-of-absence status. The role assignment data comprises, for each user, an identifier of one or more roles currently assigned to the user, an identifier of one or more roles previously assigned to the user, and an effective date of each role assignment. A policy evaluation engine receives both data sources and performs a cross-source comparison between the entitlement data extracted by the AI agent and the user status data and the role assignment data maintained in the identity governance system. The cross-source comparison identifies a mismatch between the two data sources when the entitlement data extracted from a user interface indicates an active user account in an enterprise application for a user whose user status data in the identity governance system indicates termination or departure, or when the entitlement data extracted from a user interface indicates access privileges exceeding the access privileges defined for a current role of the user by the role assignment data. The cross-source comparison is a computational operation performed on two structured electronic data sources and produces, as output, a structured representation of the mismatches identified between the two data sources.

The cross-source comparison mechanism is a non-conventional combination of two heterogeneous data acquisition pathways. The first pathway acquires entitlement data through computer vision and natural language processing operations performed on rendered user interface content, and the second pathway acquires user status data and role assignment data through programmatic queries to the identity governance system. Neither pathway alone produces the cross-source comparison output. The mechanism therefore creates a computational capability that did not exist prior to the architectural combination of the AI agent with the policy evaluation engine.

The technology disclosed further introduces a severity-driven dual-path execution architecture. The policy evaluation engine determines, for each identified entitlement violation, a severity classification based on a degree of semantic mismatch between the entitlement data and at least one of predefined access control policies, the user status data, and the role assignment data. The severity classification comprises at least a first severity level and a second severity level. The first severity level comprises an active user account for a user whose employment has been terminated, the active user account constituting an orphan account, or an active user account with administrative or privileged access for a user whose current role assignment does not include administrative or privileged access. The second severity level comprises a user possessing access privileges that exceed those defined for the user's current role where the user's employment status remains active, or a user retaining access privileges associated with a previously held role where the predefined access control policies specify a grace period for role transitions. An entitlement actioning module selects, based on the severity classification, between an immediate execution path and an asynchronous execution path. For first severity level violations, the entitlement actioning module directs the execution module to apply the entitlement modification autonomously and without transmission of an approval request and external authorization. For second severity level violations, the entitlement actioning module 430 suspends the execution module, generates a certifiable compliance report comprising at least the user identifier, the identifier of the enterprise application, a description of the detected excess privileges, the recommended entitlement modification, and a reference to the applicable predefined access control policy, and transmits an approval request to a designated reviewer. Upon receiving a cryptographic approval token signed by the designated reviewer or a programmatic approval signal received via an application programming interface of the identity governance system, the entitlement actioning module directs the execution module to resume generating and executing simulated user interactions to apply the approved entitlement modification.

The severity-driven dual-path execution architecture is a non-conventional control mechanism that selects, on a per-violation basis, between two technically distinct execution flows with different authorization, approval, and logging characteristics. The architecture is implemented through computational operations on the severity classification produced by the policy evaluation engine and the approval signal produced by the designated reviewer, both of which are structured electronic data values. The architecture does not select among the execution flows through human judgment exercised in the moment. The selection is performed by the entitlement actioning module from the severity classification computed by the policy evaluation engine.

### System Architecture

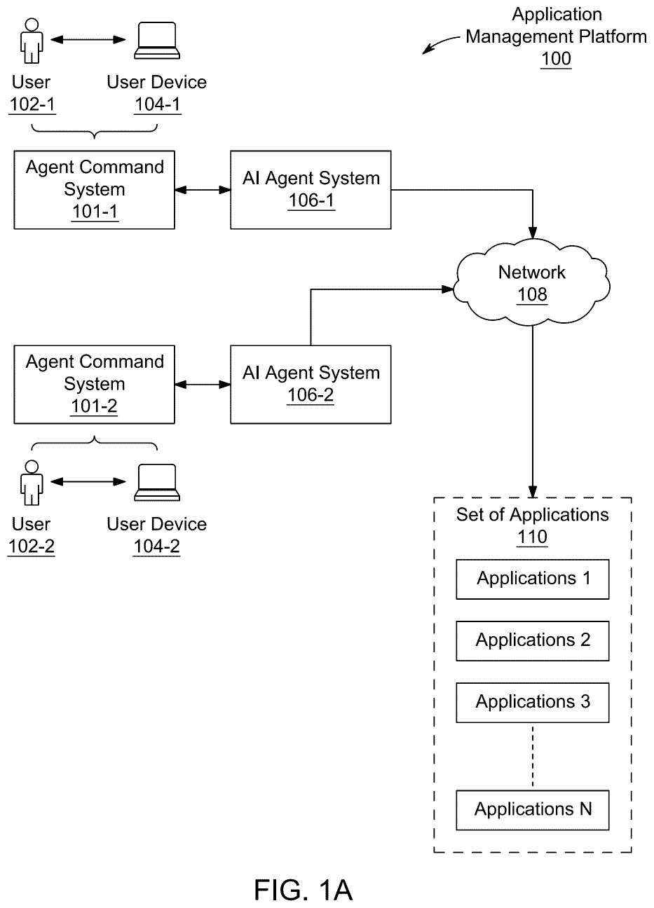

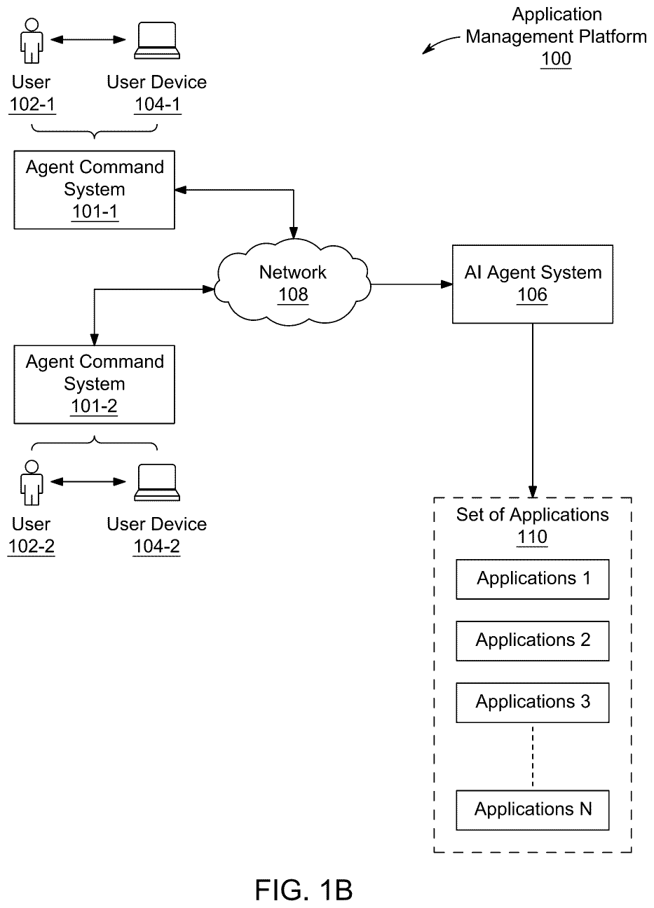

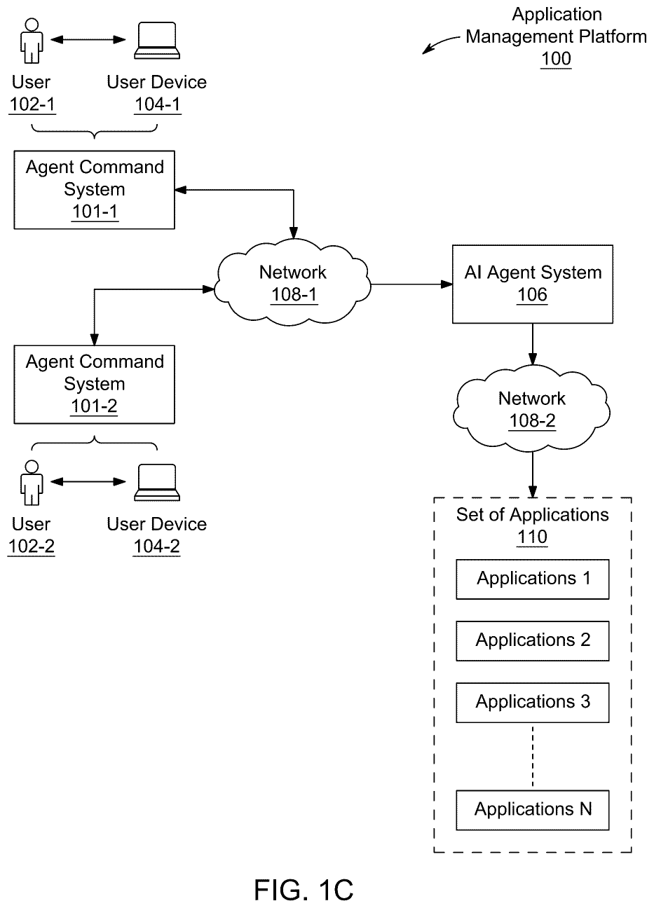

FIG. 1A illustrates an exemplary network diagram depicting an overall system architecture for deploying the application management platform 100, as disclosed in various embodiments. FIG. 1A depicts interaction among a plurality of enterprise users, a plurality of user devices, a plurality of agent command systems, a plurality of AI agent systems, and a set of applications over a communication network.

The application management platform 100 includes a plurality of users 102-1 and 102-2, each operating a respective user device 104-1 and 104-2. The user devices 104-1 and 104-2, collectively referred to as user devices 104, may be any computing devices capable of initiating or supporting interaction with components of the application management platform 100. The user devices 104 may include desktop computers, laptops, tablets, smartphones, or other network-enabled terminals. The user devices 104-1 and 104-2 are communicatively linked to other components of the application management platform 100 via a network 108. The network 108 may include any combination of communication technologies including wired connections, wireless protocols, cellular networks, local area networks (LANs), wide area networks (WANs), metropolitan area networks (MANs), the Internet, or any suitable data transmission medium.

The agent command systems 101-1 and 101-2, collectively referred to as agent command systems 101 and as illustrated in FIG. 1A, refer to command-initiating modules that trigger task execution requests within the AI agent systems 106. The agent command systems 101 operate as entry points into an AI agent execution layer and may originate from a variety of operational contexts within the enterprise environment. Functionally, each agent command system 101 is configured to broker identity and access management instructions, including credential creation, access revocation, entitlement modification, or credential verification, by transmitting structured or unstructured commands to a corresponding AI agent system 106.

In one exemplary embodiment, an agent command system 101 may be realized as an enterprise human resources platform, such as Workday or SuccessFactors, which automatically triggers a new-user provisioning task upon successful onboarding of an employee. Alternatively, an agent command system 101 may be a cloud identity orchestration platform or identity governance solution, such as Okta Workflows or SailPoint, which detects a status change and delegates an appropriate downstream action to an agentic automation layer.

In another scenario, an agent command system 101 may comprise an enterprise-grade ticketing or service desk tool, such as ServiceNow or Jira, where an administrator raises a request for access removal or a credential reset. Once the ticket receives approval, the agent command system 101 generates a task trigger, which an AI agent system 106 receives for execution across relevant applications.

Additionally, an agent command system 101 may be embodied as a Python script or a lightweight command-line utility maintained by enterprise information technology teams. The agent command system 101 may invoke credential management tasks based on custom logic, policy thresholds, or compliance audit findings. For example, a script may be scheduled to review stale accounts or trigger revocation flows for temporary users whose access is due to expire.

The scope of the agent command systems 101 also extends to externally hosted platforms. For example, a partner organization operating an integration gateway may initiate access modification workflows through representational state transfer (RESTful) callbacks or secure webhooks when a role matrix of a joint project is updated. Similarly, identity-centric middleware, such as Active Directory Federation Services (AD FS) or Azure Conditional Access policies, may initiate dynamic policy enforcement actions through integration with the application management platform 100.

Furthermore, websites that serve as operational hubs for user provisioning, including custom-built contractor registration portals or partner self-service applications, may function as instances of the agent command systems 101. These web portals collect user metadata, roles, and authorization preferences and transmit the metadata, the roles, and the authorization preferences as task directives to the agentic execution layer for automated credential provisioning.

The AI agent systems 106-1 and 106-2, collectively referred to as AI agent systems 106, serve as intermediary execution and orchestration layers between the agent command systems 101 and the set of applications 110. In the embodiment of FIG. 1A, the plurality of AI agent systems 106 may be deployed to manage tasks across various application domains, organizational units, or enterprise environments. Each AI agent system 106 receives task instructions or event triggers from a corresponding agent command system 101 and performs operations with respect to one or more applications in the set of applications 110.

A set of applications 110 is denoted as application 1, application 2, application 3, and continuing through application N. The applications within the set of applications 110 represent tools, platforms, and services utilized by enterprises in operational workflows. Illustrative examples include customer relationship management platforms such as Salesforce, regulatory filing portals such as Securities and Exchange Commission (SEC) submission websites, internal field service management systems, and partner-managed applications hosted on third-party infrastructure. Within the set of applications 110, some applications may be sanctioned enterprise applications that have been vetted and formally approved for use within the enterprise environment. However, not all sanctioned applications are programmatically integrated with enterprise identity systems. For example, Salesforce may be both sanctioned and programmatically connected through secure application programming interfaces (APIs), whereas other sanctioned tools, including a field service application hosted in a partner cloud, may lack programmatic integrations entirely and may be accessible through graphical user interfaces.

In cases of applications lacking programmatic integration, an AI agent system 106 is positioned to bridge the integration gap by executing graphical user interface (GUI)-based workflows. The AI agent system 106 functions across both API-enabled and GUI-only applications without requiring custom connectors for every application, thereby supporting a wide spectrum of use cases. The applications denoted by reference numeral 110, including application 1 through application N, represent the diversity in application connectivity and accessibility.

The application management platform 100 provides an operational control plane for deployment, configuration, and update management of the AI agent systems 106 across the enterprise environment. The application management platform 100 may further serve as an interface through which deployment packages, including deployment application template (DAT) files containing task templates and user interface locators, are delivered and version controlled. Version-controlled deployment ensures that application-specific logic can be updated without requiring modification to enterprise systems or target applications.

Operationally, when a task is initiated, including onboarding a new employee or revoking access for a departing contractor, the AI agent system 106 identifies relevant applications, determines whether the relevant applications are sanctioned or unsanctioned, and further determines whether programmatic access is available. Where APIs exist, the AI agent system 106 may utilize the APIs. Where no APIs are exposed, the AI agent system 106 performs interface-based automation by identifying credential fields, invoking generation elements, interacting with application controls, and confirming task completion through visual confirmation or response logging.

FIG. 1B illustrates an exemplary architecture of the AI agent system 106 deployed in a network environment. As depicted in FIG. 1B, a plurality of users 102-1 through 102-N operate respective user devices 104-1 through 104-N, the user devices being communicatively connected to the AI agent system 106 via the network 108. In the embodiment of FIG. 1B, a single AI agent system 106 serves the plurality of users 102-1 through 102-N and coordinates task execution across the set of applications 110.

The users 102 represent individuals or entities that require interaction with the AI agent system 106 for accessing enterprise functionalities or initiating enterprise workflows. The users 102 may include enterprise employees, external customers, partners, vendors, and contractors. Within an enterprise, the users 102 may take the form of managers, analysts, administrative staff, or compliance officers. For example, a marketing manager may request insights into sales performance metrics, while a data analyst may query historical usage patterns to train predictive models. Each interaction is facilitated through the user devices 104, which may include desktop computers, laptops, mobile phones, or tablets configured to transmit queries or task instructions to the AI agent system 106.

The AI agent system 106 functions as an intelligent middleware layer, interfacing with user instructions or task directives and performing corresponding task executions within the enterprise infrastructure. Upon receiving requests from the user devices 104-1 through 104-N or task directives from the agent command systems 101, the AI agent system 106 interprets an objective of the request or directive, references one or more semantic models, and orchestrates an execution strategy. The execution may involve data extraction from enterprise databases, task automation across enterprise applications, generation of alerts and recommendations, or credential and entitlement management operations.

An underlying semantic model employed by the AI agent system 106 maps concepts, relationships, and terminologies specific to the enterprise and an operational domain of the enterprise. The semantic model may incorporate language-specific and language-independent elements and may maintain a knowledge graph that encapsulates industry-specific vocabularies, inter-entity relationships, and organizational hierarchies. The semantic model allows the AI agent system 106 to provide meaningful and contextually accurate responses, even when user inputs are ambiguous, multilingual, or incomplete. For example, the AI agent system 106 may infer that a query about “partner logins” likely pertains to privileged account access in partner-facing systems and may respond accordingly.

The AI agent system 106 is capable of initiating omni-channel communication, providing task updates, delivering alerts, recommending actions, and handling real-time queries via chat, voice, or system notification interfaces. The AI agent system 106 may also proactively interact with the users 102 to suggest workflow improvements or to flag policy violations. For example, if a departing employee retains access to sensitive systems, the AI agent system 106 may initiate a revocation task and notify a security team.

The architecture is adaptable to various industry verticals including manufacturing, financial services, healthcare, oil and gas, and telecommunications. The AI agent system 106 is designed to accommodate industry-specific models, allowing the AI agent system 106 to process domain-relevant queries and execute tasks with high specificity and compliance.

The network 108 facilitates data transfer between the user devices 104-1 through 104-N and the AI agent system 106. In some embodiments, multiple interconnected networks 108 may be present between the user devices 104-1 through 104-N and the AI agent system 106. The network 108 may be a private network, a public network, or a hybrid network. The network 108 may be a local area network (LAN) or a wide area network (WAN).

The network 108 may be connected via wired or wireless links. Wired links may include digital subscriber line (DSL), coaxial cable lines, Ethernet, fiber optic links, or other links used for network infrastructure. Wireless links may include cellular, BLUETOOTH, Wi-Fi, Worldwide Interoperability for Microwave Access (WiMAX), infrared channels, satellite bands, or other wireless networking technologies. Wireless links may also include any cellular network standards used to communicate among mobile devices, including standards that qualify as 1G, 2G, 3G, 4G, 5G, or Long Term Evolution (LTE). Network standards may qualify as one or more generations of mobile telecommunication standards by fulfilling a specification or standards including specifications maintained by the International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include Advanced Mobile Phone System (AMPS), Global System for Mobile Communications (GSM), General Packet Radio Service (GPRS), Universal Mobile Telecommunications System (UMTS), High Speed Packet Access (HSPA), LTE, LTE Advanced, Mobile WiMAX, and WiMAX Advanced. Cellular network standards may use various channel access methods, including frequency division multiple access (FDMA), time division multiple access (TDMA), code division multiple access (CDMA), or space division multiple access (SDMA). In some embodiments, different types of data may be transmitted via different links and standards. In other embodiments, the same types of data may be transmitted via different links and standards.

The network 108 may be any type and form of network. The geographical scope of the network 108 may vary widely. The network 108 can be a body area network (BAN), a personal area network (PAN), a LAN including an Intranet, a metropolitan area network (MAN), or a WAN including the Internet. The topology of the network 108 may be of any form and may include point-to-point, serial, bus, star, ring, mesh, or tree topologies. The network 108 may be an overlay network that is virtual and sits on top of one or more layers of other networks. The network 108 may be of any network topology capable of supporting the operations described herein. The network 108 may utilize different techniques and layers or stacks of protocols, including the Ethernet protocol, the Internet protocol suite including Transmission Control Protocol over Internet Protocol (TCP/IP) and User Datagram Protocol over Internet Protocol (UDP/IP), the Asynchronous Transfer Mode (ATM) technique, the Synchronous Optical Networking (SONET) protocol, or the Synchronous Digital Hierarchy (SDH) protocol. The TCP/IP Internet protocol suite may include an application layer, a transport layer, an Internet layer including IPv6, or a link layer. The network 108 may be a type of broadcast network, telecommunications network, data communication network, or computer network.

In some implementations, one or more of the users 102-1 through 102-N may access the AI agent system 106 using one or more of the user devices 104-1 through 104-N. The AI agent system 106 may include one or more user interfaces, including browsers and textual or graphical user interfaces, through which the users 102-1 through 102-N may access the AI agent system 106.

The user devices 104-1 through 104-N and the AI agent system 106 may exist on a shared or segmented network. In some embodiments, the users 102 may access the AI agent system 106 remotely via virtual private networks (VPNs) or federated identity mechanisms, while in other embodiments, the users 102 may be co-located within an enterprise premise. The AI agent system 106 may access one or more databases communicatively coupled to the user devices 104-1 through 104-N through the network 108.

The database may be persistent storage that is capable of storing data. The persistent storage may be a local storage unit or a remote storage unit. The persistent storage may be a magnetic storage unit, an optical storage unit, a solid-state storage unit, an electronic storage unit including main memory, or a similar storage unit. The persistent storage may also be a monolithic single device or a distributed set of devices. Each component may include hardware including processing devices, including processors, central processing units (CPUs), and graphics processing units (GPUs), memory including random access memory (RAM), storage devices including a hard disk drive (HDD) and a solid-state drive (SSD), and other hardware devices including a sound card and a video card. The computing system may comprise any suitable type of computing device or machine that has a programmable processor including server computers, desktop computers, laptop computers, tablet computers, smartphones, and set-top boxes. In some examples, the computing system may comprise a single machine or may include multiple interconnected machines including multiple servers configured in a cluster. The computing system may be implemented by a common entity or organization or may be implemented by different entities or organizations.

FIG. 1C illustrates an alternative embodiment of the application management platform 100 depicting a distributed deployment environment of the AI agent system 106 in connection with an enterprise infrastructure. The architecture reflects system elements distributed across a plurality of communication networks 108-1 and 108-2 and demonstrates interactions between enterprise users, agent command systems, and applications.

As depicted in FIG. 1C, the enterprise users 102-1 and 102-2 operate corresponding user devices 104-1 and 104-2, respectively. The user devices 104-1 and 104-2 may include any computing device capable of establishing a network connection and interfacing with enterprise systems, including desktop computers, laptops, mobile phones, or tablet devices. Each user device may interact with a corresponding agent command system 101-1 or 101-2. The agent command systems 101-1 and 101-2 may be communicatively coupled to the AI agent system 106 through a first network 108-1, and the AI agent system 106 may be communicatively coupled to the set of applications 110 through a second network 108-2.

The AI agent system 106 interfaces with the agent command systems 101 and the set of applications 110 across the plurality of networks 108-1 and 108-2 and acts as an intermediary that facilitates intelligent, automated task execution based on enterprise identity controls. The AI agent system 106 may be communicatively coupled with the application management platform 100 that oversees and orchestrates deployment, access provisioning, and lifecycle management of AI-agent-based automation. The applications form a collective set of applications 110 of enterprise-deployed software systems, comprising commonly used platforms including Salesforce, customer relationship management systems, regulatory filing portals, or internally hosted operational tools. The set of applications 110 varies in accordance with each enterprise. The set of applications 110 is a customized set tailored to address the specific requirements of each enterprise.

The architecture of FIG. 1C emphasizes the role of distributed user interactions wherein different users, command-originating systems, and applications may be connected over different network interfaces. Unlike monolithic enterprise systems, the arrangement of FIG. 1C represents the practical reality of hybrid information technology environments where not all applications are uniformly connected or orchestrated under a single identity governance mechanism.

The AI agent system 106 mediates communication and operational requests between command-originating enterprise systems and the managed application ecosystem. The AI agent system 106 may incorporate logic for parsing user instructions or task directives, orchestrating task flows, validating access policies, updating credential states, and sending execution notifications. The AI agent system 106 enables agentic automation even in cases where application integration is incomplete or where manual processes are still used, by employing techniques including interface automation, synthetic API generation, or remote workflow triggers.

By situating the AI agent system 106 between disparate agent command systems and applications, the architecture shown in FIG. 1C supports a flexible, secure, and intelligent mechanism for managing complex enterprise workflows while maintaining identity and access policies enforced across multiple application types and endpoints.

### Exemplary System Architecture

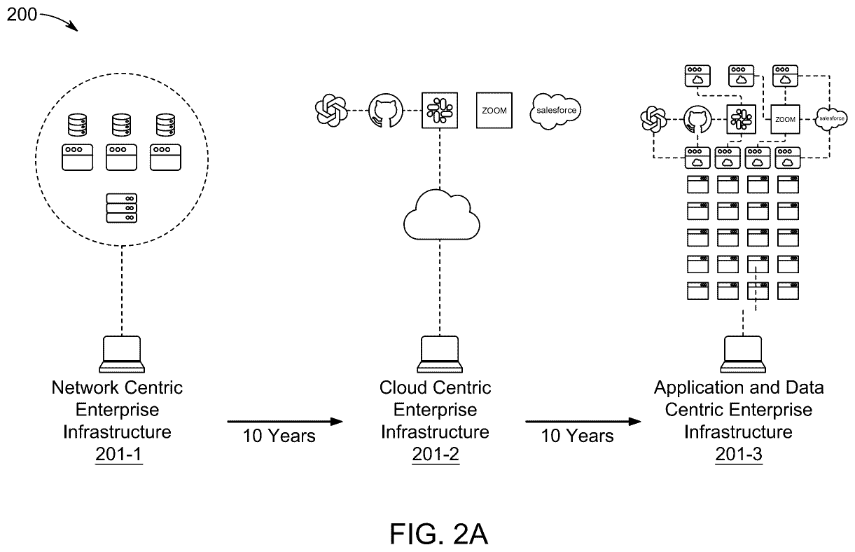

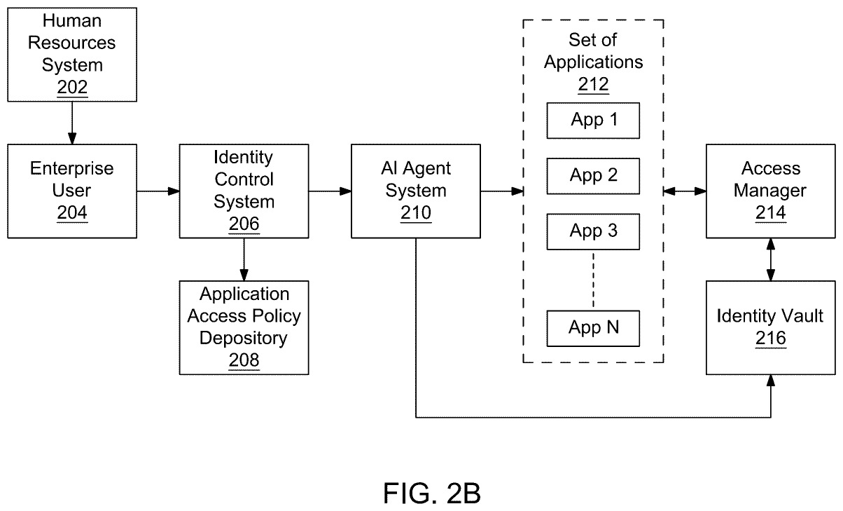

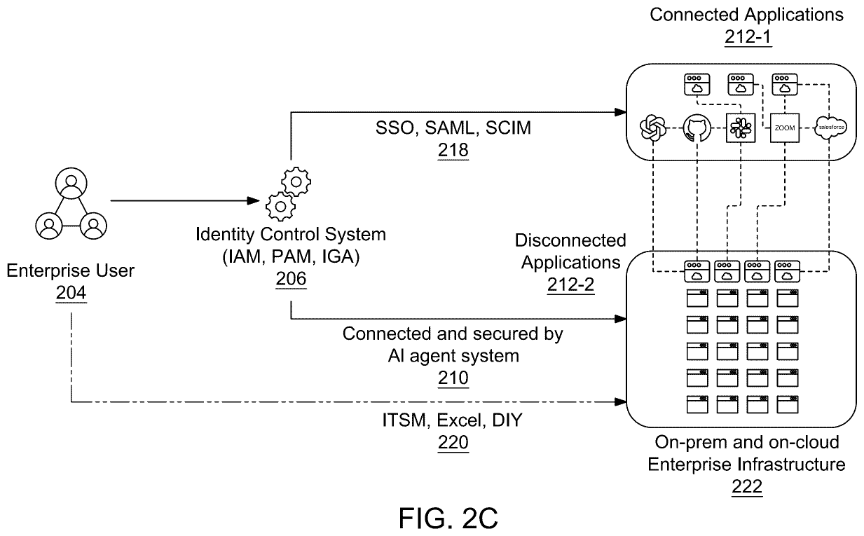

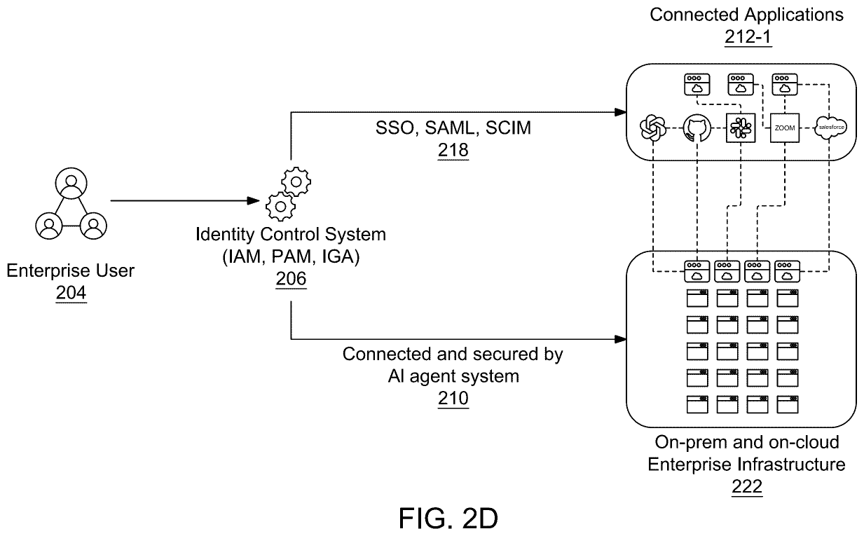

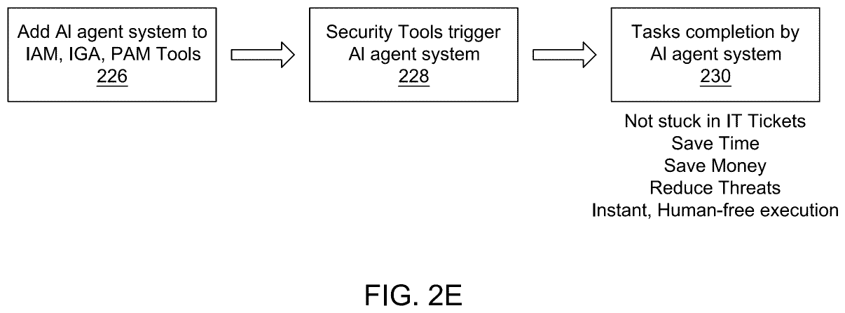

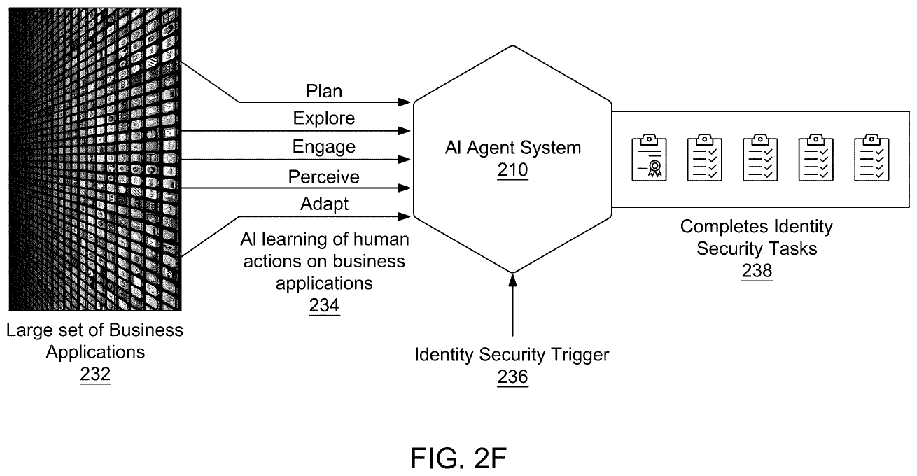

FIG. 2A illustrates an architectural diagram of an exemplary system 200 depicting the evolution of enterprise infrastructure models from network-centric paradigms to application- and data-centric paradigms, in accordance with certain embodiments of the present disclosure. The architectural diagram depicts three successive stages of enterprise infrastructure evolution spanning approximately two decades. A first stage depicts a network-centric enterprise infrastructure 201-1, in which enterprise applications and services are organized around physical network boundaries, on-premises data centers, and perimeter-based security models. A second stage depicts a cloud-centric enterprise infrastructure 201-2, in which enterprise applications and services migrate to cloud-hosted environments, introducing distributed access patterns and multi-tenant service delivery. A third stage depicts an application- and data-centric enterprise infrastructure 201-3, in which enterprise security and identity perimeter shifts from a network layer to application and data layers, and individual applications and data stores become primary units of access control, policy enforcement, and identity governance. Each transition between successive stages spans approximately ten years. The evolution from the network-centric enterprise infrastructure 201-1 to the application- and data-centric enterprise infrastructure 201-3 creates a heterogeneous application landscape in which enterprise organizations simultaneously operate legacy on-premises applications, cloud-native services, and third-party platforms with varying degrees of integration, connectivity, and programmatic accessibility. The heterogeneity of the application- and data-centric enterprise infrastructure 201-3 forms the operational context in which the AI agent system described herein operates.

FIG. 2B illustrates an exemplary system 200 of an AI agent-based enterprise identity orchestration and credential automation platform, in accordance with certain embodiments of the present disclosure. The system 200 is implemented within a secure enterprise network environment and comprises a plurality of functional modules and system components, including a human resources system 202, an enterprise user 204, an identity control system 206, an application access policy depository 208, an AI agent system 210, a set of applications 212 comprising application 1 through application N, an access manager 214, and an identity vault 216.

The human resources system 202 is a centralized enterprise repository that maintains user-specific attributes and employment metadata, including designation, department, employment status, access eligibility criteria, and historical access records. For example, upon onboarding a new employee into a marketing department, the human resources system 202 stores the relevant role, project assignment, and department-specific flags that inform downstream access decisions. When an employee transitions from one department to another or exits the organization, the human resources system 202 updates the employment status accordingly.

The enterprise user 204 may be an internal administrative system, service entity, or administrative user operating within the enterprise infrastructure that fetches the employee details from the human resources system 202. The employee details include identity attributes, department-based entitlements, project-specific roles, and policy flags that define a scope of application access for the employee. For example, the enterprise user 204 may detect that an employee assigned to a financial audit project is eligible for limited access to an enterprise financial ledger application while being denied access to engineering development platforms.

The identity control system 206 serves as a decision engine that interprets enterprise-defined access control policies and determines an eligible set of applications each employee is permitted to access. The identity control system 206 may utilize static policy rules, dynamic access condition evaluation, or role-based access control logic to determine entitlements. For example, a data analyst joining a compliance team may be granted view-only access to compliance dashboards, whereas a senior compliance officer may be granted editing and submission privileges. Based on the determined scope of access, the identity control system 206 triggers either a credential creation task upon employee onboarding or a revocation task upon employee exit or access expiration.

The application access policy depository 208 is a dedicated storage layer or configuration store that maintains policy documents, compliance checklists, access templates, and entitlement definitions. The application access policy depository 208 may include per-application authentication modes, credential types, and compliance requirements. For example, a customer relationship management system may require multi-factor authentication using time-based tokens, while a regulatory submission platform may require access through a secure virtual private network (VPN). The identity control system 206 consults the application access policy depository 208 when making determinations regarding access provisioning or deprovisioning.

The AI agent system 210 functions as an intelligent execution layer that translates an intent derived from the identity control system 206 into a series of task executions across multiple heterogeneous applications. The AI agent system 210 orchestrates a credential creation, modification, or removal process and communicates with both connected and disconnected applications. For example, a customer relationship management platform may be a sanctioned and programmatically accessible application supporting standard authentication protocols, while a third-party treasury interface hosted on a partner cloud infrastructure may require interface automation using robotic process automation (RPA) or semantic uniform resource locator (URL)-based mapping. The AI agent system 210 handles both categories with equal agility, providing consistent and audit-friendly execution.

The set of applications 212, comprising application 1 through application N, represents a portfolio of enterprise tools and applications that employees may need to access. The set of applications 212 includes customer relationship management platforms, regulatory submission platforms, internal operational tools hosted on private cloud, and third-party partner interfaces. Some applications within the set of applications 212 are classified as sanctioned and support direct programmatic access, while other applications may be unlisted, disconnected, or legacy systems that do not expose modern application programming interfaces. For example, a sanctioned system may allow secure identity federation, while an unsanctioned procurement portal may require screen-based automation or manual form parsing.

The access manager 214 supervises overall task execution and maintains auditability. The access manager 214 verifies that credential lifecycle management activities, including provisioning, updates, and revocations, are completed successfully, logged appropriately, and aligned with enterprise compliance expectations. For example, in scenarios where a deprovisioning task fails due to an unreachable application, the access manager 214 may escalate an issue to an administrator and trigger a retry loop. The access manager 214 may also enforce temporal access constraints, including expiring credentials issued for short-term contractors, and may maintain versioned audit logs to support forensic analysis and compliance reporting.

The identity vault 216 functions as a secure storage module for credentials issued to enterprise users. The identity vault 216 may store usernames, passwords, application programming interface tokens, multi-factor secrets, and biometric templates. For example, when an employee is granted access to a cloud database, generated credentials are securely stored in the identity vault 216 in compliance with encryption-at-rest policies, audit logging, access expiration, and role-based retrieval constraints. The identity vault 216 may support zero-trust integrations with endpoint agents to facilitate secure credential injection at runtime.

The components of the system 200 operate in coordination to provide seamless, policy-compliant, and secure identity orchestration within complex enterprise environments. The AI-driven architecture of the system 200 provisions user access in accordance with verified human resources data and policy data, and executes tasks including application programming interface key refresh and user deactivation proactively, even for applications not directly connected to enterprise identity systems.

FIG. 2C illustrates an architectural diagram depicting integration of AI agent-based identity governance across connected applications and disconnected applications within a hybrid enterprise infrastructure, in accordance with certain embodiments of the present disclosure. FIG. 2C depicts the enterprise user 204 coupled to the identity control system 206 implementing identity and access management (IAM), privileged access management (PAM), and identity governance and administration (IGA) functions. The identity control system 206 is communicatively coupled to the AI agent system 210, which is communicatively coupled to both a set of connected applications 212-1 and a set of disconnected applications 212-2 within an on-premises and on-cloud enterprise infrastructure 222. The connected applications 212-1 are integrated with the identity control system 206 via standardized protocols including single sign-on (SSO), security assertion markup language (SAML), and system for cross-domain identity management (SCIM) 218. The disconnected applications 212-2 are applications that lack native protocol integration and are managed using alternative methods, including information technology service management (ITSM) tickets, spreadsheet-based tracking, or custom-built tools 220. The AI agent system 210 bridges a gap between the connected applications 212-1 and the disconnected applications 212-2 by providing automated identity governance capabilities across both categories of applications irrespective of availability of a programmatic interface.

FIG. 2D illustrates an exemplary connectivity framework between enterprise users, the identity control system, and a plurality of applications integrated with the AI agent system, in accordance with certain embodiments of the present disclosure. FIG. 2D depicts the enterprise user 204 coupled to the identity control system 206 implementing IAM, PAM, and IGA functions. The identity control system 206 is communicatively coupled to the AI agent system 210, which is communicatively coupled to the connected applications 212-1 deployed on the on-premises and on-cloud enterprise infrastructure 222 via SSO, SAML, and SCIM 218. FIG. 2D illustrates an alternative embodiment in which an enterprise application landscape comprises primarily connected applications 212-1, and the AI agent system 210 operates alongside standardized identity federation and provisioning protocols.

FIG. 2E is a system workflow diagram showing an AI agent-driven remediation process initiated by contextual security signals and executed across enterprise applications, in accordance with certain embodiments of the present disclosure. FIG. 2E depicts three sequential stages. At a first stage 226, the AI agent system 210 is added to IAM, IGA, and PAM tools, integrating agentic automation capabilities into existing identity governance infrastructure. At a second stage 228, security tools trigger the AI agent system 210 in response to identity lifecycle events, policy violations, or security incidents. At a third stage 230, the AI agent system 210 completes identity security tasks across an enterprise application estate, achieving instant, human-free execution, time savings, cost reduction, and threat mitigation.

FIG. 2F is a conceptual diagram depicting AI agent behavioral learning for autonomous execution of identity lifecycle tasks in enterprise applications, in accordance with certain embodiments of the present disclosure. FIG. 2F depicts the AI agent system 210 that learns from human actions on business applications 234 within a large set of business applications 232. The AI agent system 210 acquires behavioral patterns through a sequence of learning stages comprising plan, explore, engage, perceive, and adapt. Upon receiving an identity security trigger 236, the AI agent system 210 completes identity security tasks 238 across the large set of business applications 232 by applying learned behavioral patterns to autonomously navigate, interpret, and interact with enterprise application interfaces.

### Internal Functional Modules

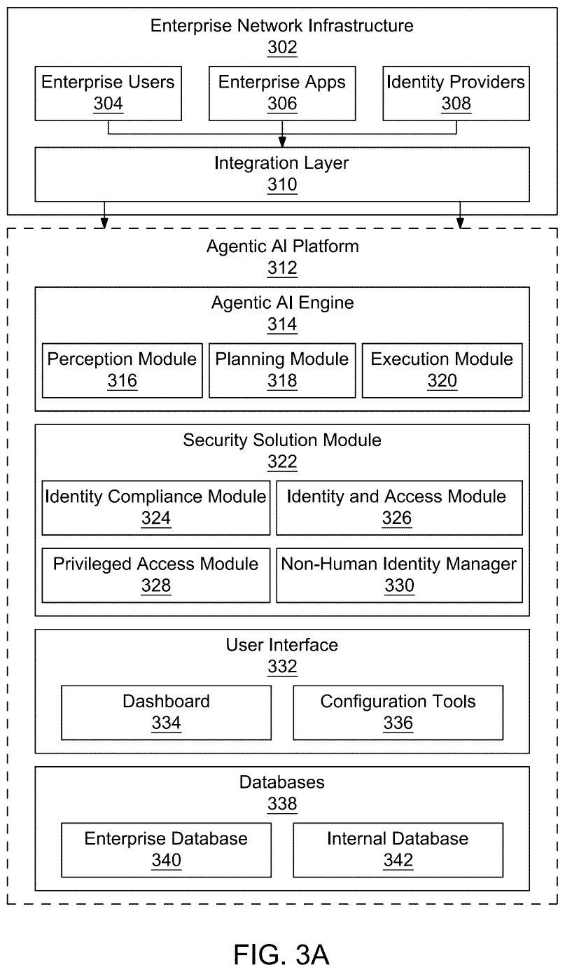

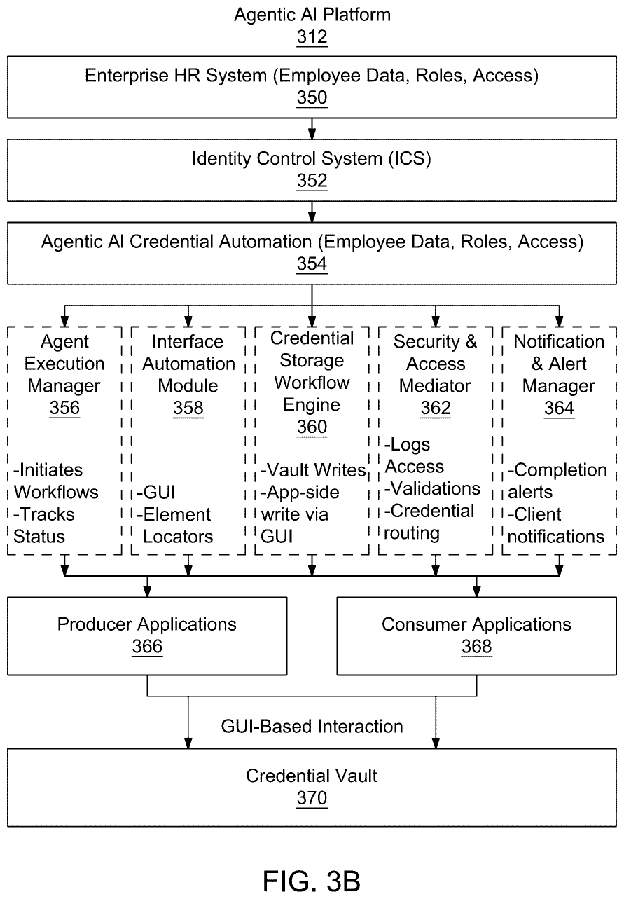

FIG. 3A illustrates an exemplary system architecture depicting internal functional modules of the agentic AI platform, in accordance with certain embodiments of the present disclosure. The architecture is deployed within an enterprise network infrastructure 302 and is communicatively coupled to enterprise users 304, enterprise applications 306, and identity providers 308 via an integration layer 310.

The architecture comprises an agentic AI platform 312 containing an agentic AI engine 314. The agentic AI engine 314 comprises a perception module 316, a planning module 318, and an execution module 320. The perception module 316 is configured to detect and interpret user interface elements rendered on graphical interfaces of enterprise applications using computer vision and image recognition techniques. The planning module 318 is configured to decompose identity governance intents into structured execution plans by interpreting user instructions, evaluating policy constraints, and determining a sequence of actions to be performed across target enterprise applications. The execution module 320 is configured to carry out actions determined by the planning module 318 by generating and executing simulated user interactions with the enterprise application interfaces, including mouse-click simulation, keyboard-input simulation, and form-field population.

The agentic AI platform 312 further comprises a security solution module 322, an identity compliance module 324, an identity and access module 326, a privileged access module 328, and a non-human identity manager 330. The security solution module 322 provides security validation and enforcement across platform workflows. The identity compliance module 324 monitors and enforces compliance with regulatory and organizational access control policies. The identity and access module 326 manages user identity lifecycle operations including provisioning, deprovisioning, and entitlement review. The privileged access module 328 manages elevated access privileges and privileged session controls. The non-human identity manager 330 manages credentials and access privileges associated with service accounts, machine identities, and automated processes.

The architecture further comprises a user interface 332 including a dashboard 334 and configuration tools 336 accessible to enterprise administrators and compliance personnel. The architecture is communicatively coupled to databases 338 including an enterprise database 340 and an internal database 342 that store identity records, access policies, credential metadata, and audit logs.

### Agentic AI Credential Automation System

FIG. 3B illustrates the agentic AI platform 312, described with reference to FIG. 3A, configured as an agentic AI credential automation system for performing graphical user interface (GUI)-based orchestration for enterprise identity workflows, in accordance with certain embodiments of the present disclosure. FIG. 3B depicts a credential automation subsystem within the agentic AI platform 312, bridging enterprise policy engines with application endpoints through an intelligent middleware capable of credential generation, injection, and lifecycle management.

The agentic AI platform 312, as depicted in FIG. 3B, comprises an enterprise human resources (HR) system 350 that functions as an authoritative data source for user identity attributes, including employee data, roles, and access entitlements. The enterprise HR system 350 maintains updated metadata about each employee and acts as an originator of identity provisioning or deprovisioning events.

An identity control system (ICS) 352 receives the user identity attributes from the enterprise HR system 350 and evaluates organizational access policies. The identity control system 352 determines application access, triggers credential creation or removal, and stores policy metadata. For example, upon offboarding, the identity control system 352 triggers workflows to remove application-level access, which are then delegated to the credential automation subsystem.

An agentic AI credential automation module 354 functions as a middleware execution engine configured to translate access decisions into executable actions. The agentic AI credential automation module 354 receives the employee data, the roles, and the access entitlements from the identity control system 352 and serves as a core protocol abstraction layer capable of interacting with a heterogeneous application ecosystem. The agentic AI credential automation module 354 orchestrates credential issuance, revocation, and updates across both connected and disconnected systems.

The agentic AI credential automation module 354 comprises an agent execution manager 356, an interface automation module 358, a credential storage workflow engine 360, a security and access mediator 362, and a notification and alert manager 364. The agent execution manager 356 initiates workflows and tracks execution status by decomposing incoming identity intents into atomic sub-tasks and routing the sub-tasks to appropriate modules. For example, upon receiving an instruction to generate a new application programming interface key, the agent execution manager 356 may trigger the credential storage workflow engine 360 and a credential generation workflow in parallel.

The interface automation module 358 facilitates GUI-level automation for applications that lack standard application programming interface connectivity. The interface automation module 358 includes logic for identifying GUI elements including input fields, buttons, dropdowns, and dynamic frames using element locators. The interface automation module 358 enables the agentic AI platform 312 to perform programmatic interactions with external systems in a human-like manner. The credential storage workflow engine 360 manages secure handling and routing of credentials. The credential storage workflow engine 360 supports vault write operations to a centralized credential vault 370 and application-side write operations via GUI interfaces. For example, a newly created application programming interface key for a field service application may be stored in the credential vault 370 while also being simultaneously injected into an application user management portal.

The security and access mediator 362 logs access events, performs policy validations, and manages credential routing during workflow execution. The security and access mediator 362 monitors transactional success or failure and is configured to enforce conditional logic including time-based access expiry and escalation rules.

The notification and alert manager 364 handles completion alerts and client notifications across the agentic AI platform 312. Upon successful completion of credential-related operations, the notification and alert manager 364 sends alerts to appropriate stakeholders including system administrators, compliance officers, or application owners.

Producer applications 366 represent internal enterprise systems configured to generate credentials, including credential generators, application programming interface key generators, and internal administrative user interfaces. Consumer applications 368 are target systems that rely on generated credentials for user access, including regulatory submission applications, customer relationship management platforms, field operations tools, and treasury systems. The agentic AI credential automation module 354 interacts with both the producer applications 366 and the consumer applications 368 via GUI-based interaction.

The credential vault 370 serves as a centralized storage repository for enterprise credentials. The credential vault 370 is updated via the credential storage workflow engine 360 and supports credential rotations and time-to-live (TTL) enforcement. The credential vault 370 stores credentials including passwords, application programming interface keys, and authentication tokens in an encrypted format, and maintains credentials that are valid and within expiration boundaries.

The agentic AI platform 312, as depicted in FIG. 3B, facilitates a GUI-driven, application-agnostic, and audit-enforced identity orchestration mechanism that reduces dependency on application-specific application programming interfaces. The agentic AI platform 312 is updatable through deployment application template (DAT) files, allowing new applications to be integrated without system reengineering.

### System Architecture for Managing User Entitlements Across a Plurality of Enterprise Applications

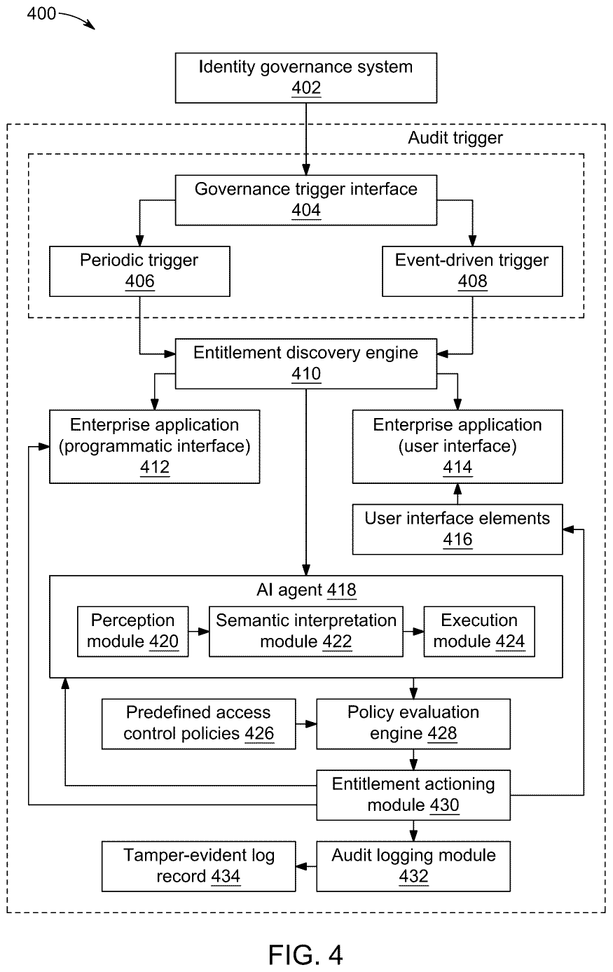

FIG. 4 illustrates a system 400 for managing user entitlements across a plurality of enterprise applications. The system 400, also referred to as the entitlement management system 400, is configured to perform automated reporting and actioning of user roles and entitlements in response to audit triggers generated by an identity governance platform. The system 400 implements an entitlement governance architecture in which entitlement data is retrieved from both enterprise applications that expose a programmatic interface and enterprise applications accessible for entitlement management through a user interface, evaluated against predefined access control policies, and acted upon through automated entitlement modifications. The system 400 supports entitlement management across both integrated and non-integrated applications within a heterogeneous enterprise environment, minimizing manual overhead and enforcing least privilege access principles. The system 400 can be implemented in various identity governance applications, including access certification, entitlement review, orphan account detection, role-based access enforcement, and compliance audit automation. In one implementation, the system 400 is implemented on a computer processor executing instructions stored in a non-transitory computer-readable storage medium, and the computer processor performs the actions described herein by executing the stored instructions.

The system 400 is communicatively coupled to an identity governance system 402. The identity governance system 402 is an external platform or access management system that initiates entitlement review workflows by transmitting audit triggers to the system 400. The identity governance system 402 may be implemented as a centralized identity and access management (IAM) platform, a governance, risk, and compliance (GRC) tool, or a standalone access management system that maintains authoritative records of user identities, role assignments, and organizational status. For example, the identity governance system 402 may track employee onboarding, role transitions, and offboarding events, and may integrate with a human resources system that maintains structured records for each employee, including organizational role, access eligibility, department alignment, project involvement, and historical credentialing events.

The system 400 comprises a governance trigger interface 404 communicatively coupled to the identity governance system 402. The governance trigger interface 404 is configured to receive an audit trigger from the identity governance system 402. The audit trigger is a signal or message that initiates the entitlement management workflow and causes the governance trigger interface 404 to activate downstream processes within the system 400. The governance trigger interface 404 may be implemented as an application programming interface endpoint, a message queue listener, a webhook receiver, or any other communication interface capable of receiving structured trigger signals from the identity governance system 402.

The audit trigger received by the governance trigger interface 404 comprises at least one of a periodic trigger 406 or an event-driven trigger 408. The periodic trigger 406 is generated on a recurring audit cycle. The recurring audit cycle comprises at least one of a 30-day, 60-day, or 90-day audit cycle. For example, an organization may configure the identity governance system 402 to generate a periodic trigger 406 every 90 calendar days to verify that all user entitlements across the enterprise application estate remain consistent with current role assignments. The event-driven trigger 408 is generated in response to at least one of a user's organizational departure, a user role reassignment, a project completion event, or a security incident requiring immediate access review. For example, when an employee departs the organization and the human resources system updates the employee's status to “terminated,” the identity governance system 402 detects the status change and generates an event-driven trigger 408 that is transmitted to the governance trigger interface 404. In another example, when a developer is reassigned from a security team to a marketing team, the identity governance system 402 generates an event-driven trigger 408 in response to the role reassignment, prompting an immediate review of the developer's access privileges.

The system 400 further comprises an entitlement discovery engine 410 coupled to the governance trigger interface 404. The entitlement discovery engine 410 is configured to retrieve entitlement data from the plurality of enterprise applications upon receiving the audit trigger. The entitlement data comprises user identifiers, roles, and role-specific attributes. The user identifiers are unique values that distinguish individual users across the enterprise application estate, and may include employee identifiers, email addresses, or login names. The roles represent the organizational functions or job responsibilities assigned to each user. The role-specific attributes represent the permissions, privileges, and access levels associated with each role, including read access, write access, administrative access, and application-specific permissions. For example, the entitlement discovery engine 410 may retrieve entitlement data indicating that a user has administrator privileges in a collaboration platform while also holding read-only access in a financial dashboard.

The entitlement discovery engine 410 retrieves entitlement data through a dual-pathway architecture. The first pathway involves querying enterprise applications that expose a programmatic interface 412 to retrieve entitlement data via the programmatic interface. The enterprise application (programmatic interface) 412 represents an enterprise application that provides a programmatic interface through which entitlement data can be retrieved programmatically. For example, the enterprise application (programmatic interface) 412 may expose a representational state transfer (REST) application programming interface (API), a system for cross-domain identity management (SCIM) endpoint, or a security assertion markup language (SAML) interface. The second pathway involves navigating, by an AI agent 418, the user interface of at least one enterprise application accessible for entitlement management through a user interface 414. The enterprise application (user interface) 414 represents an enterprise application that does not expose a programmatic interface and is accessible for entitlement management through a user interface. The enterprise application (user interface) 414 may comprise at least one of a legacy on-premises application, a third-party web application, a graphical user interface (GUI) only platform, or a disconnected enterprise tool not integrated with an identity and access management system. For example, a proprietary internal document management system, a legacy accounting platform with no API access, or a third-party vendor portal with user management available exclusively through a web-based interface may each constitute an enterprise application (user interface) 414. The AI agent 418 autonomously navigates to an entitlement management section of the enterprise application (user interface) 414 and extracts user roles and role-specific entitlements displayed within the user interface. The entitlement data obtained from both the enterprise application (programmatic interface) 412 and the enterprise application (user interface) 414 produces a unified entitlement dataset spanning the full enterprise application estate, enabling entitlement violation identification across both programmatically accessible and user-interface-accessible enterprise applications.

The system 400 further comprises the AI agent 418 communicatively coupled to the enterprise application (user interface) 414. The AI agent 418 comprises one or more modules configured to process user interface elements of the enterprise application (user interface) 414. The user interface elements are associated with access privilege controls 416. The user interface elements associated with access privilege controls 416 represent the graphical controls, input fields, buttons, dropdown menus, toggles, and other interactive elements rendered on the user interface of the enterprise application (user interface) 414 that are functionally associated with managing user access privileges.

The AI agent 418 comprises a perception module 420, a semantic interpretation module 422, and an execution module 424. The perception module 420, the semantic interpretation module 422, and the execution module 424 operate sequentially. The perception module 420 first detects and classifies user interface elements rendered on the user interface, the semantic interpretation module 422 then interprets the detected elements to identify the user interface element corresponding to the entitlement modification to be performed, and the execution module 424 then generates and executes simulated user interactions with the identified user interface element.

The perception module 420 is configured to detect and classify user interface elements associated with access privilege controls using computer vision. Computer vision refers to the application of image recognition, object detection, and visual classification techniques that enable the perception module 420 to identify and distinguish graphical elements rendered on the user interface of the enterprise application (user interface) 414. The perception module 420 employs computer vision algorithms, including convolutional neural networks, autoencoder-based models, or other deep learning architectures trained to recognize common user interface patterns. The perception module 420 is configured to detect user interface elements comprising at least one of entitlement selectors, user role dropdowns, access revocation buttons, or user deactivation controls, and to classify each detected element by its function relative to access privilege management. For example, the perception module 420 may detect a “Revoke Access” button rendered on the user interface and classify the button as an access revocation control based on the visual characteristics of the button, including the button's shape, position, and spatial relationship to adjacent user interface elements.

The semantic interpretation module 422 is configured to interpret the meaning of textual content associated with the detected user interface elements using a language model. A language model refers to a natural language processing model, a large language model, or a transformer-based text classification model capable of processing natural language text to derive contextual meaning. The semantic interpretation module 422 is configured to distinguish between user interface elements associated with different access privilege actions, including distinguishing between labels indicating at least revocation of access, modification of a role, deactivation of an account, and downgrading of privileges. For example, the semantic interpretation module 422 distinguishes between options labelled “Revoke Access,” “Modify Role,” and “Deactivate Account” by analyzing the semantic content of each label and mapping each label to a corresponding access privilege action. The semantic interpretation module 422 selects the user interface element corresponding to the entitlement modification determined by the entitlement actioning module 430.

The execution module 424 is configured to apply the entitlement modification by generating and executing simulated user interactions with the detected user interface elements. Simulated user interactions are programmatic actions that replicate the behavior of a human user interacting with a graphical user interface. The execution module 424 is configured to perform simulated user interactions comprising at least one of mouse click simulation, keyboard input simulation, or form field population. For example, the execution module 424 may simulate a mouse click on a “Revoke Access” button detected by the perception module 420 and interpreted by the semantic interpretation module 422, followed by keyboard input to confirm the revocation in a confirmation dialog, thereby completing the entitlement modification through the user interface.

In one implementation, the AI agent 418 is further configured to dynamically adapt to changes in the user interface of the enterprise application (user interface) 414, including repositioned user interface elements, modified labels, and updated interface layouts, without requiring reconfiguration of the AI agent 418. The dynamic adaptation operates by the perception module 420 re-detecting user interface elements associated with access privilege controls after a change in the user interface layout, and the semantic interpretation module 422 re-interpreting textual content associated with the re-detected elements to maintain correct identification of access privilege actions despite the layout change.

In another implementation, the AI agent 418 is configured to authenticate to the enterprise application (user interface) 414 prior to interacting with the user interface, using credentials retrieved from a credential vault 370. The credential vault 370 stores credentials associated with the enterprise application (user interface) 414 in an encrypted format and supports credential versioning, rotation, and time-to-live enforcement. The AI agent 418 retrieves credentials that are valid and within expiration boundaries at the time of authentication.

The system 400 further comprises predefined access control policies 426 and a policy evaluation engine 428. The predefined access control policies 426 represent a set of rules and constraints that specify permissible user-role combinations for the plurality of enterprise applications. The predefined access control policies 426 may further comprise at least one of department-based access policies specifying that users assigned to a particular department are permitted access to a defined set of enterprise applications, least privilege policies specifying that users are permitted the minimum access privileges necessary for their current role, or separation of duties policies specifying that a single user is prohibited from holding access privileges to two or more enterprise applications that together create a conflict of interest. For example, a predefined access control policy may specify that users assigned to the marketing department are permitted access to a content management system but are not permitted administrative access to a financial reporting system. The predefined access control policies 426 are stored as a data store or policy repository accessible to the policy evaluation engine 428.

The policy evaluation engine 428 is communicatively coupled to the entitlement discovery engine 410 and receives the obtained entitlement data. The policy evaluation engine 428 is configured to evaluate the retrieved entitlement data against the predefined access control policies 426 to identify one or more entitlement violations. An entitlement violation occurs when the obtained entitlement data indicates that a user possesses access privileges inconsistent with the predefined access control policies 426. The entitlement violations include at least one of a user retaining access privileges after organizational departure, a user retaining access privileges associated with a previously held role, or a user possessing access privileges exceeding those defined for the user's current role by the predefined access control policies 426. For example, the policy evaluation engine 428 may identify an entitlement violation when a user who has departed the organization retains an active account with administrative access in a legacy enterprise application.

The policy evaluation engine 428 is further configured to determine a severity classification for each identified entitlement violation based on a degree of semantic mismatch between the obtained entitlement data and the predefined access control policies 426. The severity classification comprises at least a first severity level and a second severity level. The first severity level comprises at least one of an active user account in the enterprise application (user interface) 414 for a user whose employment has been terminated, the active user account constituting an orphan account, or an active user account with administrative or privileged access for a user whose current role assignment in the predefined access control policies 426 does not include administrative or privileged access. The second severity level comprises at least one of a user possessing access privileges that exceed those defined for the user's current role where the user's employment status remains active, or a user retaining access privileges associated with a previously held role where the predefined access control policies 426 specify a grace period for role transitions.

The system 400 further comprises an entitlement actioning module 430. The entitlement actioning module 430 is configured to execute at least one entitlement modification in response to the identified entitlement violations. The entitlement modification comprises at least one of revoking access privileges, downgrading access privileges to a lower privilege level, suspending access privileges, or reassigning a user to a different role. The entitlement actioning module 430 operates through a dual-pathway enforcement architecture. For enterprise applications that expose a programmatic interface 412, the entitlement actioning module 430 executes the entitlement modification by issuing commands via the programmatic interface, including commands to revoke access tokens, remove users from privileged groups, or modify role assignments. For the enterprise application (user interface) 414, the entitlement actioning module 430 invokes the AI agent 418 to interact with the user interface to control the access privileges. The AI agent 418 identifies and interprets user interface elements associated with access privilege controls 416 rendered on the user interface, and applies the entitlement modification by generating and executing simulated user interactions with the identified user interface elements.

The entitlement actioning module 430 selects, based on the severity classification, between an immediate execution path and an asynchronous execution path. For entitlement violations classified at the first severity level, the entitlement actioning module 430 selects the immediate execution path, in which the execution module 424 generates and executes simulated user interactions to apply the entitlement modification without transmitting an approval request and without awaiting external authorization. For example, upon detecting an orphan account constituting a first severity level violation, the entitlement actioning module 430 directs the AI agent 418 to immediately deactivate the user account by the execution module 424 generating and executing simulated user interactions with user deactivation controls detected by the perception module 420 and identified by the semantic interpretation module 422.

For entitlement violations classified at the second severity level, the entitlement actioning module 430 selects the asynchronous execution path. In the asynchronous execution path, the entitlement actioning module 430 suspends the execution module 424, generates a certifiable compliance report comprising at least the user identifier, the identifier of the enterprise application, a description of the detected excess privileges, the recommended entitlement modification, and a reference to the applicable predefined access control policy, and transmits an approval request to a designated reviewer via the identity governance system 402. Upon receiving a cryptographic or programmatic approval signal from the designated reviewer, the entitlement actioning module 430 directs the execution module 424 to resume generating and executing simulated user interactions to apply the approved entitlement modification. The approval signal comprises at least one of a cryptographic approval token signed by the designated system owner or compliance reviewer, the token comprising at least an identifier of the reviewer, a timestamp of the approval, and a reference to the entitlement modification being approved, or a programmatic approval signal received via an application programming interface of the identity governance system 402.

In one implementation, the AI agent 418, upon applying the entitlement modification, verifies that the modification has been successfully applied by inspecting a resulting state of the user interface after the simulated user interactions have been executed.

The system 400 further comprises an audit logging module 432. The audit logging module 432 is configured to generate, for each entitlement modification, a tamper-evident log record 434. The tamper-evident log record 434 is a structured record stored in a secure repository in a manner that prevents unauthorized alteration or deletion. The tamper-evident log record 434 comprises at least a user identifier, an identifier of the enterprise application in which the modification was applied, a timestamp of the modification, a description of the modification performed, a result status indicating whether the modification was successfully applied, and the severity classification assigned to the entitlement violation by the policy evaluation engine 428. For example, if the AI agent 418 deactivates a user's account in a legacy accounting system, the audit logging module 432 generates a tamper-evident log record 434 comprising the user identifier of the deactivated user, the identifier of the legacy accounting system, the timestamp of the deactivation, a description indicating “user account deactivated,” a result status indicating “successful,” and the severity classification indicating “first severity level.”

In one implementation, the tamper-evident log record 434 further comprises an indication of whether the entitlement modification was executed via the programmatic interface or via the AI agent 418 interacting with the user interface. In another implementation, the tamper-evident log record 434 further comprises a reasoning trace generated by the semantic interpretation module 422, the reasoning trace recording which user interface elements were detected, how the semantic interpretation module 422 interpreted each detected element, and which user interface element was selected for the entitlement modification. In yet another implementation, the tamper-evident log record 434 further comprises an indication of whether the entitlement modification was executed via the immediate execution path or the asynchronous execution path, and for entitlement modifications executed via the asynchronous execution path, an identifier of the designated reviewer, a timestamp of the approval signal, a cryptographic hash or signature of the approval signal, and a duration between detection of the entitlement violation and execution of the entitlement modification. The tamper-evident log records 434 may be formatted for compliance reporting under at least one of the Sarbanes-Oxley Act (SOX) requiring demonstrable control over user access to financial systems, the Health Insurance Portability and Accountability Act (HIPAA) requiring audit trails for access to protected health information, or the General Data Protection Regulation (GDPR) requiring verifiable access control and data subject rights enforcement. In one implementation, the tamper-evident log records 434 are surfaced in a centralized governance dashboard accessible to administrator and compliance personnel, the centralized governance dashboard providing real-time visibility into entitlement modification status across all queried enterprise applications.

The records maintained by the identity governance system 402 include user status data and role assignment data. The user status data comprises, for each user, an indication of the user's organizational status, including at least an active status, a terminated status, a departed status, or a leave-of-absence status. The role assignment data comprises, for each user, an identifier of one or more roles currently assigned to the user, an identifier of one or more roles previously assigned to the user, and an effective date of each role assignment. The user status data and the role assignment data are made available to the policy evaluation engine 428 for cross-source comparison with the entitlement data extracted by the AI agent 418 from the user interfaces of the enterprise applications.

In one implementation, the entitlement discovery engine 410 is configured for continuous monitoring by periodically monitoring entitlement data from the enterprise application (user interface) 414 to identify access anomalies or policy drifts prior to receipt of the audit trigger. Upon detection of an entitlement violation prior to a scheduled audit cycle, the entitlement discovery engine 410 generates an alert to the identity governance system 402 or to designated compliance personnel.

In an illustrative use case, an employee named Jane Doe exits the organization. Thirty days later, the identity governance system 402 issues a periodic trigger 406 to the governance trigger interface 404. The entitlement discovery engine 410 queries both the enterprise application (programmatic interface) 412 and the enterprise application (user interface) 414, and discovers that Jane Doe still has access to a patent analytics tool not connected to the identity and access management framework. The AI agent 418 logs into the user interface of the patent analytics tool, where the perception module 420 detects the entitlement control section using computer vision, the semantic interpretation module 422 identifies the label “Deactivate User” using the language model, and the execution module 424 performs the revocation action by generating and executing simulated user interactions with the deactivation control. The policy evaluation engine 428 confirms that Jane Doe's continued access violates the offboarding access policy defined in the predefined access control policies 426. The entitlement actioning module 430 proceeds with the revocation via the immediate execution path, and the audit logging module 432 records the operation in a tamper-evident log record 434. In another example, a developer changes teams and is no longer authorized to access a proprietary machine learning pipeline hosted in a disconnected system. The entitlement discovery engine 410 detects the mismatch through a periodic scan. The AI agent 418 is invoked by the entitlement actioning module 430 to log into the legacy system, and upon locating the entitlement management section, the execution module 424 modifies the developer's access level from “Contributor” to “Viewer” by generating and executing simulated user interactions with the role assignment controls. The update is registered and logged by the audit logging module 432 in a tamper-evident log record 434.

Through the integration of the governance trigger interface 404, the entitlement discovery engine 410, the AI agent 418, the policy evaluation engine 428, the entitlement actioning module 430, and the audit logging module 432, the system 400 of FIG. 4 enables consistent, real-time, and policy-aligned entitlement governance across the plurality of enterprise applications irrespective of the integration capabilities of each enterprise application.

### Method for Managing User Entitlements Across a Plurality of Enterprise Applications

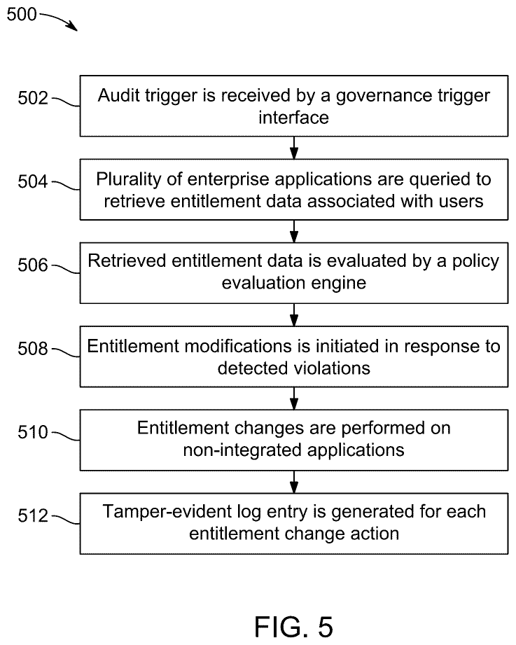

FIG. 5 illustrates an exemplary process flow 500 diagram depicting a computer-implemented method for managing user entitlements across a plurality of enterprise applications, including both identity and access management (IAM)-integrated and non-integrated systems.

At step 502, an audit trigger is received by a governance trigger interface from an identity governance system. The trigger may be issued periodically, such as every thirty calendar days, or may be event-driven, for instance, upon detection of a user's organizational departure or role reassignment.

At step 504, an entitlement discovery engine queries a plurality of enterprise applications to retrieve entitlement data associated with users. The entitlement data comprises user identifiers, assigned roles, and one or more role-specific attributes. The query spans applications integrated with IAM frameworks and extends to disconnected or GUI-only applications that do not expose programmatic APIs.

At step 506, the retrieved entitlement data is evaluated by a policy evaluation engine against a predefined set of access control policies. The access control policies may define permissible user-role combinations, department-based access rights, or role-specific data handling privileges. The policy evaluation engine identifies entitlement violations, such as a user retaining elevated access after leaving a project or organization.

At step 508, an entitlement actioning module initiates entitlement modifications in response to detected violations. The entitlement modification includes revoking access privileges, reassigning roles, or applying privilege downgrades. For applications that expose native APIs, the modifications are executed through direct API calls. For applications lacking API access, the entitlement actioning module invokes an AI agent to perform the modification via graphical user interface (GUI) interaction.

At step 510, the AI agent performs entitlement changes on non-integrated applications by interacting with the application's user interface. The AI agent comprises a perception module configured to detect GUI elements such as buttons and dropdowns, a semantic interpretation module configured to understand the contextual meaning of on-screen labels, and an execution module configured to simulate human interactions such as clicks and keystrokes. The AI agent autonomously navigates to the entitlement management section of the application and executes the required modification.

At step 512, an audit logging module generates a tamper-evident log entry for each entitlement change action. The log entry includes at least a user identifier, the application name, the timestamp of the action, a description of the modification performed, and the result status. The audit record is stored in a secure repository and may be surfaced to compliance personnel through a centralized governance dashboard.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Entitlement Management Workflow

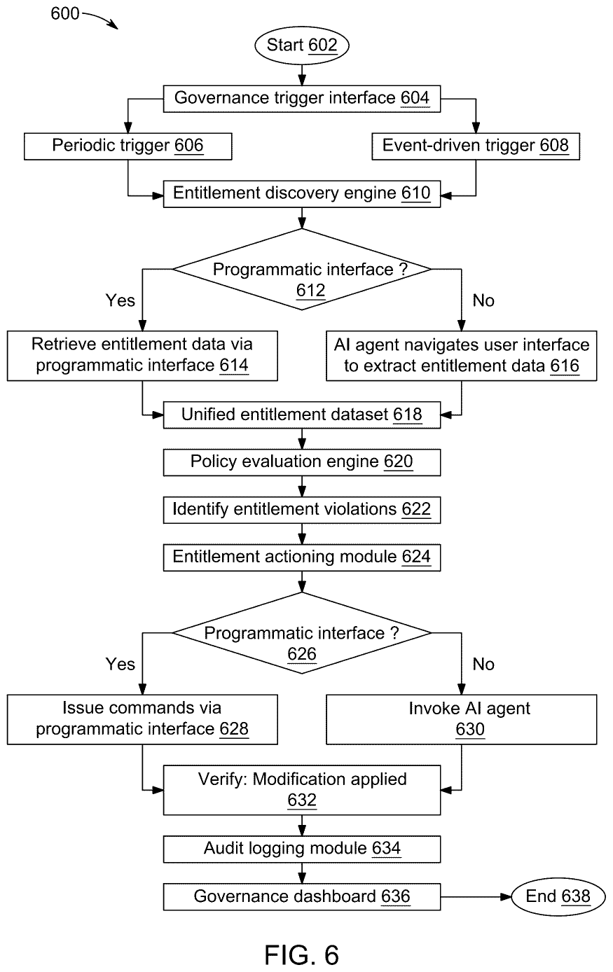

FIG. 6 illustrates a method 600 for managing user entitlements across a plurality of enterprise applications, in accordance with the system 400 described with reference to FIG. 4. The method 600 depicts the operational flow of the entitlement management workflow from trigger reception through entitlement discovery, policy evaluation, entitlement modification, verification, and audit logging. The method 600 implements a dual-pathway decision logic at two stages of the workflow, a first decision at the entitlement discovery stage and a second decision at the entitlement actioning stage, in which the method 600 selects between a programmatic interface path and a user interface path based on the integration capabilities of each enterprise application.

The method 600 begins at a start step 602. At step 604, a governance trigger interface (described as governance trigger interface 404 with reference to FIG. 4) receives an audit trigger from an identity governance system. The audit trigger comprises at least one of a periodic trigger 606 generated on a recurring audit cycle or an event-driven trigger 608 generated in response to a user's organizational departure or role reassignment. The periodic trigger 606 is generated at predetermined time intervals, including at least one of a 30-day, 60-day, or 90-day audit cycle. The event-driven trigger 608 is generated in response to at least one of a user's organizational departure, a user role reassignment, a project completion event, or a security incident requiring immediate access review. Upon receipt of the audit trigger, the governance trigger interface initiates the entitlement management workflow by forwarding the audit trigger to an entitlement discovery engine at step 610.

At step 610, an entitlement discovery engine (described as entitlement discovery engine 410 with reference to FIG. 4) queries the plurality of enterprise applications to obtain entitlement data comprising user identifiers, roles, and role-specific attributes. The method 600 reaches a first decision point at step 612, where the entitlement discovery engine determines whether each enterprise application exposes a programmatic interface. For enterprise applications that expose a programmatic interface, the method 600 proceeds along the “Yes” path to step 614, where the entitlement discovery engine retrieves entitlement data via the programmatic interface. For enterprise applications that do not expose a programmatic interface and are accessible for entitlement management through a user interface, the method 600 proceeds along the “No” path to step 616, where an AI agent (described as AI agent 418 with reference to FIG. 4) navigates the user interface of the enterprise application to extract entitlement data therefrom. At step 616, the AI agent autonomously navigates to an entitlement management section of the enterprise application and extracts user roles and role-specific entitlements displayed within the user interface.

At step 618, the entitlement data retrieved via the programmatic interface at step 614 and the entitlement data extracted by the AI agent at step 616 are combined into a unified entitlement dataset. The unified entitlement dataset spans both enterprise applications queried via programmatic interfaces and enterprise applications accessed through user interfaces, enabling entitlement violation identification across the full enterprise application estate.

At step 620, a policy evaluation engine (described as policy evaluation engine 428 with reference to FIG. 4) evaluates the unified entitlement dataset against predefined access control policies to identify one or more entitlement violations at step 622. The entitlement violations identified at step 622 include at least one of a user retaining access privileges after organizational departure, a user retaining access privileges associated with a previously held role, or a user possessing access privileges exceeding those defined for the user's current role by the predefined access control policies. The policy evaluation engine further determines a severity classification for each identified entitlement violation, the severity classification comprising at least a first severity level and a second severity level, as described with reference to FIG. 4.

At step 624, an entitlement actioning module (described as entitlement actioning module 430 with reference to FIG. 4) receives the identified entitlement violations and initiates entitlement modifications in response to the identified entitlement violations. The entitlement modifications comprise at least one of revoking access privileges or downgrading access privileges. The method 600 reaches a second decision point at step 626, where the entitlement actioning module determines whether the target enterprise application exposes a programmatic interface. For enterprise applications that expose a programmatic interface, the method 600 proceeds along the “Yes” path to step 628, where the entitlement actioning module issues commands via the programmatic interface to execute the entitlement modification. The commands issued at step 628 may include commands to revoke access tokens, remove users from privileged groups, or modify role assignments. For enterprise applications that do not expose a programmatic interface, the method 600 proceeds along the “No” path to step 630, where the entitlement actioning module invokes the AI agent. At step 630, the AI agent applies the entitlement modification by generating and executing simulated user interactions with user interface elements associated with access privilege controls rendered on the user interface of the enterprise application, as described with reference to FIG. 4.

At step 632, the method 600 performs a verification operation. The AI agent inspects a resulting state of the user interface after the simulated user interactions have been executed to verify that the entitlement modification has been successfully applied. The verification at step 632 confirms that the modification has taken effect by re-examining the user interface elements through the perception module and the semantic interpretation module of the AI agent.

At step 634, an audit logging module (described as audit logging module with reference to FIG. 4) generates a tamper-evident log record for each entitlement modification executed at step 628 or step 630. The tamper-evident log record comprises at least a user identifier, an identifier of the enterprise application in which the modification was applied, a timestamp of the modification, a description of the modification performed, and a result status indicating whether the modification was successfully applied.

At step 636, the tamper-evident log records generated at step 634 are surfaced in a centralized governance dashboard accessible to administrator and compliance personnel. The centralized governance dashboard provides real-time visibility into entitlement modification status across all queried enterprise applications. The method 600 concludes at an end step 638.

### Semantic Interpretation Module Processing Pipeline

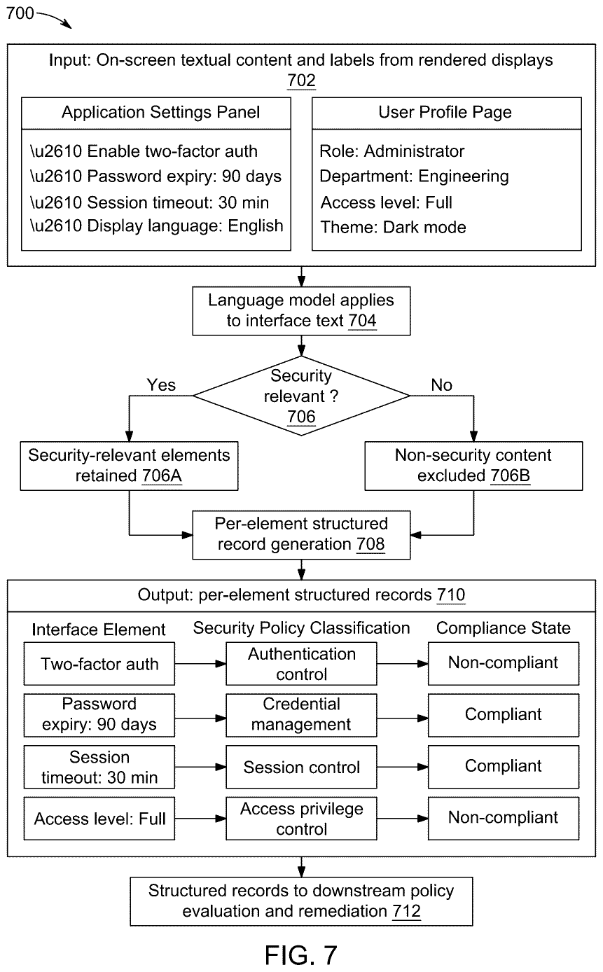

FIG. 7 illustrates a semantic interpretation module processing pipeline 700 depicting how the semantic interpretation module (described as semantic interpretation module 422 with reference to FIG. 4) processes on-screen textual content captured from the user interface of an enterprise application accessible for entitlement management through a user interface. The pipeline 700 depicts the stages of textual content intake, language model application, security relevance filtering, per-element structured record generation, and output of per-element structured records with security policy classification and compliance state for downstream policy evaluation and remediation.

The pipeline 700 begins at an input stage 702. The input stage 702 receives on-screen textual content and labels from rendered displays of the enterprise application. FIG. 7 illustrates two representative display panels within the input stage 702. A first panel depicts an application settings panel containing interface elements including “enable two-factor auth,” “password expiry: 90 days,” “session timeout: 30 min,” and “display language: English.” A second panel depicts a user profile page containing interface elements including “role: Administrator,” “department: Engineering,” “access level: Full,” and “theme: Dark mode.” The on-screen textual content and labels captured at the input stage 702 represent the raw textual information rendered on the user interface that the semantic interpretation module processes to determine which interface elements are relevant to access privilege controls and security configurations.

At step 704, a language model applies to the interface text captured at the input stage 702. The language model is the same language model employed by the semantic interpretation module 422, as described with reference to FIG. 4. The language model processes the textual content of each interface element to derive contextual meaning and to determine whether each interface element relates to access privilege controls, security configurations, or non-security content.

The pipeline 700 proceeds to a security relevance decision at step 706. At step 706, the semantic interpretation module evaluates whether each interface element processed by the language model at step 704 is security relevant. For interface elements determined to be security relevant, the pipeline 700 proceeds along the “Yes” path to step 706A, where the security-relevant elements are retained for further processing. For interface elements determined to be non-security content, the pipeline 700 proceeds along the “No” path to step 706B, where the non-security content is excluded from further processing. For example, the language model identifies “enable two-factor auth,” “password expiry: 90 days,” “session timeout: 30 min,” and “access level: Full” as security-relevant elements and retains the security-relevant elements at step 706A. The language model identifies “display language: English,” “role: Administrator,” “department: Engineering,” and “theme: Dark mode” as non-security content and excludes the non-security content at step 706B. The security relevance filtering at step 706 reduces the volume of interface elements passed to downstream processing by retaining interface elements that are functionally relevant to access privilege controls.

At step 708, the pipeline 700 performs per-element structured record generation. The per-element structured record generation at step 708 converts each security-relevant element retained at step 706A into a structured record. Each structured record comprises an interface element field, a security policy classification field, and a compliance state field.

At step 710, the pipeline 700 produces output comprising per-element structured records. The per-element structured records at step 710 are organized in a tabular format with three columns: an interface element column, a security policy classification column, and a compliance state column. A first record maps the interface element “two-factor auth” to a security policy classification of “authentication control” with a compliance state of “non-compliant.” A second record maps the interface element “password expiry: 90 days” to a security policy classification of “credential management” with a compliance state of “compliant.” A third record maps the interface element “session timeout: 30 min” to a security policy classification of “session control” with a compliance state of “compliant.” A fourth record maps the interface element “access level: Full” to a security policy classification of “access privilege control” with a compliance state of “non-compliant.” The compliance state for each interface element is determined by evaluating the current value of the interface element against the predefined access control policies (described as predefined access control policies 426 with reference to FIG. 4).

At step 712, the per-element structured records generated at step 710 are passed as structured records to downstream policy evaluation and remediation. The policy evaluation engine (described as policy evaluation engine 428 with reference to FIG. 4) receives the structured records to identify entitlement violations based on interface elements classified as non-compliant. The entitlement actioning module (described as entitlement actioning module 430 with reference to FIG. 4) receives the structured records to execute entitlement modifications for interface elements identified as non-compliant, including directing the AI agent (described as AI agent 418 with reference to FIG. 4) to generate and execute simulated user interactions with the corresponding user interface elements to remediate the non-compliant access privilege controls.

### Dual-Pathway Entitlement Discovery Architecture

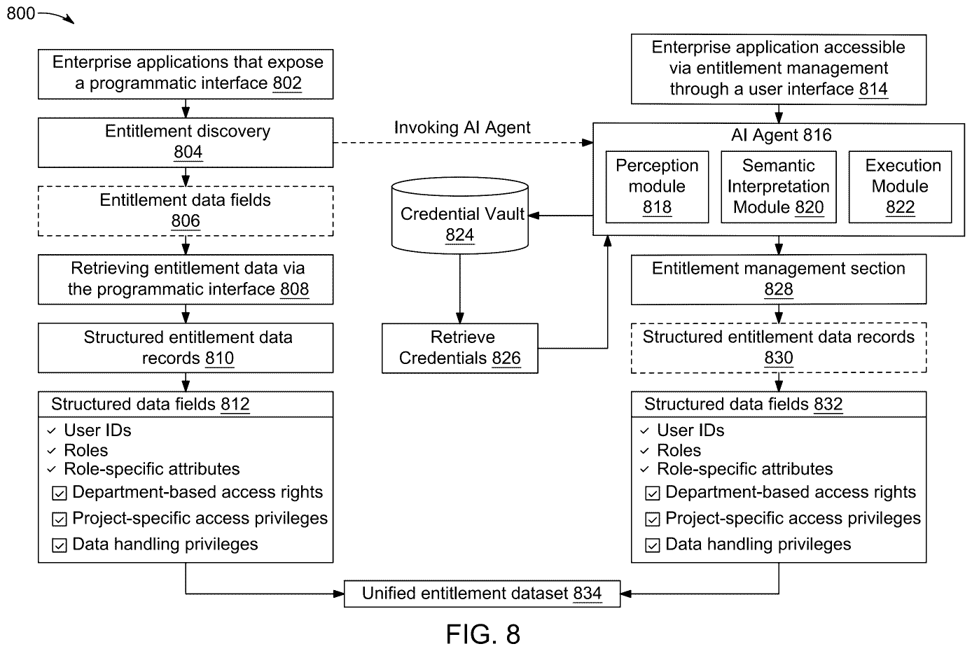

FIG. 8 illustrates a dual-pathway entitlement discovery architecture 800 depicting the entitlement data retrieval process across both enterprise applications that expose a programmatic interface and enterprise applications accessible for entitlement management through a user interface, in accordance with the entitlement discovery engine 410 described with reference to FIG. 4. The architecture 800 illustrates the data flow from each category of enterprise application through structured entitlement data records into a unified entitlement dataset and further illustrates the structured data fields retrieved through each pathway.

The architecture 800 depicts enterprise applications that expose a programmatic interface 802. The enterprise applications that expose a programmatic interface 802 are enterprise applications that provide a programmatic interface, including representational state transfer (REST) application programming interfaces, system for cross-domain identity management (SCIM) endpoints, or security assertion markup language (SAML) interfaces, through which entitlement data can be queried and retrieved programmatically. An entitlement discovery process 804 operates within the enterprise applications that expose a programmatic interface 802 to extract entitlement data fields 806. The entitlement data fields 806 represent the raw data elements retrieved from the programmatic interface, including user identifiers and roles. A retrieving entitlement data via the programmatic interface step 808 transfers the entitlement data fields 806 from the enterprise applications that expose a programmatic interface 802 into a first structured entitlement data records 810. The first structured entitlement data records 810 organize the retrieved entitlement data into a standardized format suitable for downstream policy evaluation. The first structured entitlement data records 810 comprise first structured data fields 812, the first structured data fields 812 including user identifiers, roles, role-specific attributes, department-based access rights, project-specific access privileges, and data handling privileges.

The right side of the architecture 800 depicts an enterprise application accessible via entitlement management through a user interface 814 (described as enterprise application (user interface) 414 with reference to FIG. 4). The enterprise application accessible via entitlement management through a user interface 814 is an enterprise application that does not expose a programmatic interface and is accessible for entitlement management through a user interface. An AI agent 816 (described as AI agent 418 with reference to FIG. 4) is deployed to extract entitlement data from the enterprise application accessible via entitlement management through a user interface 814. The architecture 800 depicts an invoking AI agent operation in which the entitlement discovery engine activates the AI agent 816 to begin the entitlement data extraction process.

Prior to interacting with the user interface, the AI agent 816 authenticates to the enterprise application accessible via entitlement management through a user interface 814 using credentials retrieved from a credential vault 824 (described as credential vault 370 with reference to FIG. 4). A retrieve credentials step 826 obtains credentials stored in an encrypted format from the credential vault 824. The credential vault 824 supports credential versioning, rotation, and time-to-live enforcement, and the AI agent 816 retrieves credentials that are valid and within expiration boundaries at the time of authentication.

The AI agent 816 comprises a perception module 818, a semantic interpretation module 820, and an execution module 822, as described with reference to FIG. 4. Upon authenticating to the enterprise application accessible via entitlement management through a user interface 814, the AI agent 816 navigates to an entitlement management section 828. The entitlement management section 828 is the region of the user interface where user roles, access privileges, and role-specific entitlements are displayed and managed. The perception module 818 detects and classifies user interface elements associated with access privilege controls rendered within the entitlement management section 828 using computer vision. The semantic interpretation module 820 interprets the meaning of textual content associated with the detected user interface elements using a language model. The execution module 822 generates and executes simulated user interactions with the detected user interface elements to navigate the entitlement management section 828 and extract the entitlement data displayed within the user interface. The entitlement data extracted by the AI agent 816 from the entitlement management section 828 is organized into a second structured entitlement data records 830. The second structured entitlement data records 830 comprise second structured data fields 832, the second structured data fields 832 including user identifiers, roles, role-specific attributes, department-based access rights, project-specific access privileges, and data handling privileges.

The structured entitlement data records 810 from the programmatic interface pathway and the second structured entitlement data records 830 from the user interface pathway converge into a unified entitlement dataset. The unified entitlement dataset consolidates the entitlement data from both pathways into a single dataset spanning the full enterprise application estate. The unified entitlement dataset enables a policy evaluation engine (described as policy evaluation engine 428 with reference to FIG. 4) to identify entitlement violations across both enterprise applications queried via programmatic interfaces and enterprise applications accessed through user interfaces.

### AI Agent Three-Module Pipeline

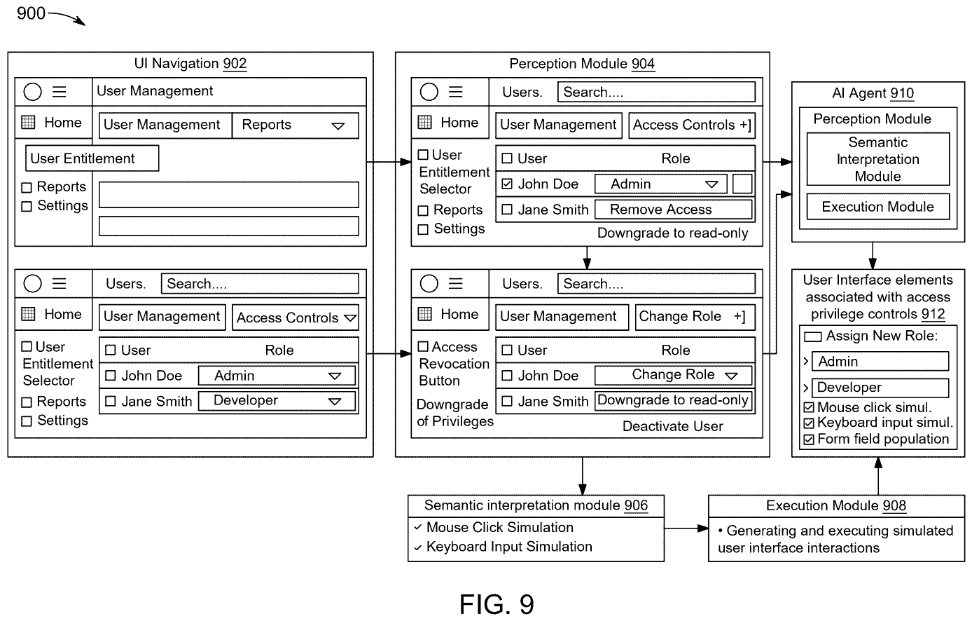

FIG. 9 illustrates an AI agent three-module pipeline 900 operating on the user interface of an enterprise application accessible for entitlement management through a user interface, in accordance with the AI agent 418 described with reference to FIG. 4. The pipeline 900 depicts the sequential operation of the perception module, the semantic interpretation module, and the execution module of the AI agent as the AI agent navigates the user interface of the enterprise application, detects and classifies user interface elements, interprets the meaning of the detected elements, and generates and executes simulated user interactions to apply entitlement modifications. The pipeline 900 is illustrated across two representative user interface screens of the enterprise application, showing how the AI agent processes the user interface at each stage of the pipeline.

The left panel of the pipeline 900 depicts UI navigation 902. The UI navigation 902 represents the raw user interface screens of the enterprise application as rendered before the AI agent processes the user interface elements. A first screen of the UI navigation 902 displays a user management page with navigation elements including “Home,” “User Management,” and “Reports” tabs, and a user entitlement section listing subordinate navigation options including “Reports” and “Settings.” A second screen of the UI navigation 902 displays a user page with navigation elements including “User Management” and “Access Controls” tabs, and a user entitlement table listing users and associated roles. For example, the user entitlement table displays a first user “John Doe” assigned the role “Admin” and a second user “Jane Smith” assigned the role “Developer.” The UI navigation 902 illustrates the raw interface that the AI agent encounters when autonomously navigating to an entitlement management section of the enterprise application.

The center panel of the pipeline 900 depicts a perception module 904 (described as perception module 420 with reference to FIG. 4). The perception module 904 processes the user interface screens displayed in the UI navigation 902 using computer vision to detect and classify user interface elements associated with access privilege controls. In the first screen processed by the perception module 904, the perception module 904 detects a user entitlement selector adjacent to user names, role dropdown menus displaying role assignments for each user, and a “Remove Access” button adjacent to the second user. The perception module 904 classifies the “Remove Access” button as an access revocation button and identifies the label “Downgrade to read-only” as a downgrade of privileges control. In the second screen processed by the perception module 904, the perception module 904 detects a “Change Role” dropdown adjacent to the first user, a “Downgrade to read-only” control adjacent to the second user, an access revocation button, and a “Deactivate User” control. The perception module 904 classifies each detected element by its function relative to access privilege management, identifying entitlement selectors, user role dropdowns, access revocation buttons, and user deactivation controls rendered on the user interface.

The right side of the pipeline 900 depicts an AI agent 910 (described as AI agent 418 with reference to FIG. 4) comprising the perception module, the semantic interpretation module, and the execution module arranged in sequential order. The AI agent 910 further depicts user interface elements associated with access privilege controls 912. The user interface elements associated with access privilege controls 912 represent the output of the perception module 904 and include the detected access privilege controls, including an “Assign New Role” control with role options including “Admin” and “Developer.” The user interface elements associated with access privilege controls 912 further depict the types of simulated user interactions available to the execution module, including mouse click simulation, keyboard input simulation, and form field population.

The bottom of the pipeline 900 depicts a semantic interpretation module 906 (described as semantic interpretation module 422 with reference to FIG. 4). The semantic interpretation module 906 receives the user interface elements detected and classified by the perception module 904 and interprets the meaning of textual content associated with the detected elements using a language model. The semantic interpretation module 906 distinguishes between user interface elements associated with different access privilege actions, including distinguishing between labels indicating revocation of access, modification of a role, deactivation of an account, and downgrading of privileges. For example, the semantic interpretation module 906 interprets the label “Remove Access” as indicating revocation of access, interprets the label “Change Role” as indicating modification of a role, interprets the label “Downgrade to read-only” as indicating downgrading of privileges, and interprets the label “Deactivate User” as indicating deactivation of an account. The semantic interpretation module 906 selects the user interface element corresponding to the entitlement modification to be performed based on the interpreted meaning of each detected element.

The pipeline 900 further depicts an execution module 908 (described as execution module 424 with reference to FIG. 4) coupled to the semantic interpretation module 906. The execution module 908 is configured to apply the entitlement modification by generating and executing simulated user interactions with the detected user interface elements. The execution module 908 performs simulated user interactions comprising at least one of mouse click simulation, keyboard input simulation, or form field population. For example, to revoke a user's access, the execution module 908 may simulate a mouse click on the “Remove Access” button identified by the perception module 904 and interpreted by the semantic interpretation module 906 as an access revocation control. In another example, to downgrade a user's privileges, the execution module 908 may simulate a mouse click on the “Downgrade to read-only” control followed by keyboard input to confirm the privilege downgrade. In yet another example, to reassign a user to a different role, the execution module 908 may perform form field population on the “Assign New Role” dropdown to select a target role, followed by a mouse click on a confirmation control to apply the role change.

### Dual-Pathway Enforcement Architecture

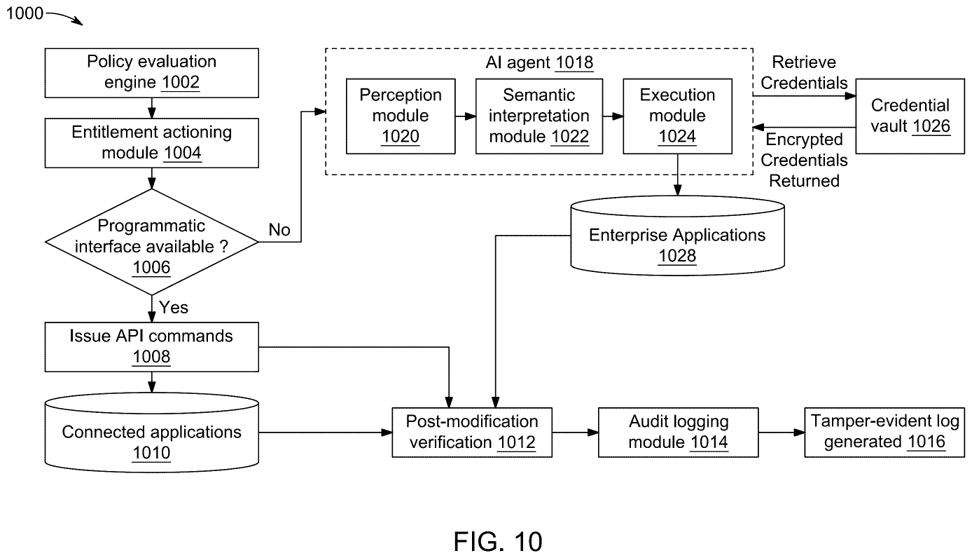

FIG. 10 illustrates a dual-pathway enforcement architecture 1000 with post-modification verification, in accordance with the entitlement actioning module 430 described with reference to FIG. 4. The architecture 1000 depicts the entitlement modification process from policy evaluation through dual-pathway enforcement, verification, audit logging, and tamper-evident log generation. The architecture 1000 illustrates how the entitlement actioning module selects between issuing commands via a programmatic interface and invoking an AI agent based on the integration capabilities of the target enterprise application, and how both pathways converge at a verification step before audit logging.

The architecture 1000 begins at a policy evaluation engine 1002 (described as policy evaluation engine 428 with reference to FIG. 4). The policy evaluation engine 1002 evaluates entitlement data against predefined access control policies and identifies one or more entitlement violations, as described with reference to FIG. 4. The policy evaluation engine 1002 passes the identified entitlement violations to an entitlement actioning module 1004 (described as entitlement actioning module 430 with reference to FIG. 4). The entitlement actioning module 1004 receives the identified entitlement violations and initiates at least one entitlement modification comprising revoking or downgrading access privileges.

The entitlement actioning module 1004 reaches a decision point at step 1006, where the entitlement actioning module 1004 determines whether the target enterprise application exposes a programmatic interface. For enterprise applications that expose a programmatic interface, the architecture 1000 proceeds along the “Yes” path to an issue API commands step 1008. At step 1008, the entitlement actioning module 1004 issues application programming interface commands to execute the entitlement modification in connected applications 1010. The connected applications 1010 represent enterprise applications that expose a programmatic interface through which entitlement modifications can be applied programmatically. The application programming interface commands issued at step 1008 may include commands to revoke access tokens, remove users from privileged groups, or modify role assignments.

For enterprise applications that do not expose a programmatic interface, the architecture 1000 proceeds along the “No” path to an AI agent 1018 (described as AI agent 418 with reference to FIG. 4). The AI agent 1018 comprises a perception module 1020, a semantic interpretation module 1022, and an execution module 1024, operating sequentially as described with reference to FIG. 4. Prior to interacting with the user interface of the target enterprise application, the AI agent 1018 retrieves credentials from a credential vault 1026 (described as credential vault 370 with reference to FIG. 4). The credential vault 1026 returns encrypted credentials to the AI agent 1018, and the AI agent 1018 authenticates to an enterprise application 1028 using the retrieved credentials. The enterprise application 1028 represents the target enterprise application accessible for entitlement management through a user interface. Upon authenticating to the enterprise application 1028, the perception module 1020 detects and classifies user interface elements associated with access privilege controls using computer vision, the semantic interpretation module 1022 interprets the meaning of textual content associated with the detected user interface elements using a language model, and the execution module 1024 applies the entitlement modification by generating and executing simulated user interactions with the detected user interface elements.

The programmatic path from the connected applications 1010 and the AI agent path from the enterprise application 1028 converge at a post-modification verification step 1012. At step 1012, the AI agent 1018 verifies that the entitlement modification has been successfully applied by inspecting a resulting state of the user interface after the simulated user interactions have been executed. For entitlement modifications applied via the programmatic interface at step 1008, the post-modification verification step 1012 confirms the result status returned by the application programming interface. For entitlement modifications applied via the AI agent 1018, the post-modification verification step 1012 re-examines the user interface elements through the perception module 1020 and the semantic interpretation module 1022 to confirm that the access privileges have been updated in accordance with the entitlement modification.

Following the post-modification verification step 1012, the architecture 1000 proceeds to an audit logging module 1014 (described as audit logging module 432 with reference to FIG. 4). The audit logging module 1014 generates a tamper-evident log record at step 1016. The tamper-evident log generated at step 1016 comprises at least a user identifier, an identifier of the enterprise application in which the modification was applied, a timestamp of the modification, a description of the modification performed, and a result status indicating whether the modification was successfully applied. The tamper-evident log generated at step 1016 further comprises an indication of whether the entitlement modification was executed via the programmatic interface at step 1008 or via the AI agent 1018 interacting with the user interface, enabling differentiated audit review of programmatic and AI-agent-mediated entitlement modifications.

### Trigger Taxonomy, Policy Type Classification, and Violation Category Reference

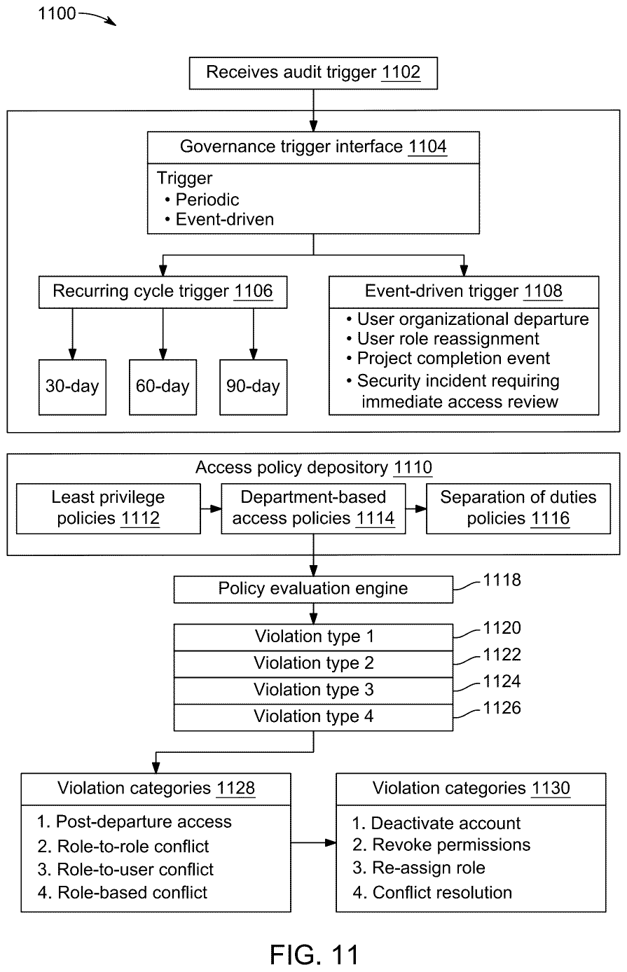

FIG. 11 illustrates a trigger taxonomy, policy type classification, and violation category reference 1100, in accordance with the system 400 described with reference to FIG. 4. The reference 1100 depicts the classification of audit triggers received by the governance trigger interface, the types of predefined access control policies stored in an access policy depository, the violation types identified by the policy evaluation engine 1118, and the corresponding violation categories and remediation actions. The reference 1100 provides a structured taxonomy of the inputs, policy rules, and outputs of the entitlement management workflow.

The reference 1100 begins at a receives audit trigger step 1102, where an audit trigger is received from an identity governance system. The audit trigger is received by a governance trigger interface 1104 (described as governance trigger interface 404 with reference to FIG. 4). The governance trigger interface 1104 classifies the received audit trigger as one of two trigger types: periodic or event-driven.

A recurring cycle trigger 1106 represents a periodic trigger generated on a recurring audit cycle. The recurring cycle trigger 1106 is generated at predetermined time intervals, including a 30-day audit cycle, a 60-day audit cycle, or a 90-day audit cycle. For example, an organization subject to quarterly compliance requirements may configure the identity governance system to generate a recurring cycle trigger 1106 on a 90-day audit cycle to align entitlement reviews with regulatory reporting timelines.

An event-driven trigger 1108 represents a trigger generated in response to a specific identity lifecycle event. The event-driven trigger 1108 is generated in response to at least one of a user's organizational departure, a user role reassignment, a project completion event, or a security incident requiring immediate access review. For example, when an employee departs the organization, the identity governance system generates an event-driven trigger 1108 to initiate an immediate review of the departed employee's access privileges across the plurality of enterprise applications.

The reference 1100 further depicts an access policy depository 1110. The access policy depository 1110 stores predefined access control policies (described as predefined access control policies 426 with reference to FIG. 4) that specify permissible user-role combinations for the plurality of enterprise applications. The access policy depository 1110 comprises three categories of predefined access control policies: least privilege policies 1112, department-based access policies 1114, and separation of duties policies 1116. The least privilege policies 1112 specify that users are permitted the minimum access privileges necessary for their current role. For example, a least privilege policy 1112 may specify that a standard user in a project management tool is permitted task creation and editing privileges but is not permitted user administration or billing privileges. The department-based access policies 1114 specify that users assigned to a particular department are permitted access to a defined set of enterprise applications. For example, a department-based access policy 1114 may specify that users assigned to the marketing department are permitted access to a content management system and a social media analytics platform but are not permitted access to financial reporting systems. The separation of duties policies 1116 specify that a single user is prohibited from holding access privileges to two or more enterprise applications that together create a conflict of interest. For example, a separation of duties policy 1116 may specify that a single user is prohibited from holding both purchase order approval privileges and payment processing privileges.

A policy evaluation engine 1118 (described as policy evaluation engine 428 with reference to FIG. 4) evaluates the obtained entitlement data against the predefined access control policies stored in the access policy depository 1110. The policy evaluation engine 1118 identifies one or more entitlement violations, categorized as violation type 1 at reference 1120, violation type 2 at reference 1122, violation type 3 at reference 1124, and violation type 4 at reference 1126. Each violation type corresponds to a distinct category of mismatch between the obtained entitlement data and the predefined access control policies.

The reference 1100 further depicts two violation category panels that classify the identified entitlement violations and their corresponding remediation actions. A first violation categories panel 1128 classifies entitlement violations into four categories: post-departure access, representing a user retaining access privileges after organizational departure; role-to-role conflict, representing a user retaining access privileges associated with a previously held role after transitioning to a different role; role-to-user conflict, representing a user possessing access privileges that are inconsistent with the user's current organizational assignment; and role-based conflict, representing a user possessing access privileges that violate a separation of duties policy by combining conflicting privileges across enterprise applications.

A second violation categories panel 1130 classifies the remediation actions corresponding to each violation category: deactivate account, corresponding to the remediation of post-departure access violations by deactivating the orphan account; revoke permissions, corresponding to the remediation of role-to-role conflicts by revoking access privileges associated with the previously held role; re-assign role, corresponding to the remediation of role-to-user conflicts by reassigning the user to a role consistent with the user's current organizational assignment; and conflict resolution, corresponding to the remediation of role-based conflicts by revoking one or more conflicting access privileges to restore compliance with the separation of duties policy.

### Credential Vault Authentication Sequence

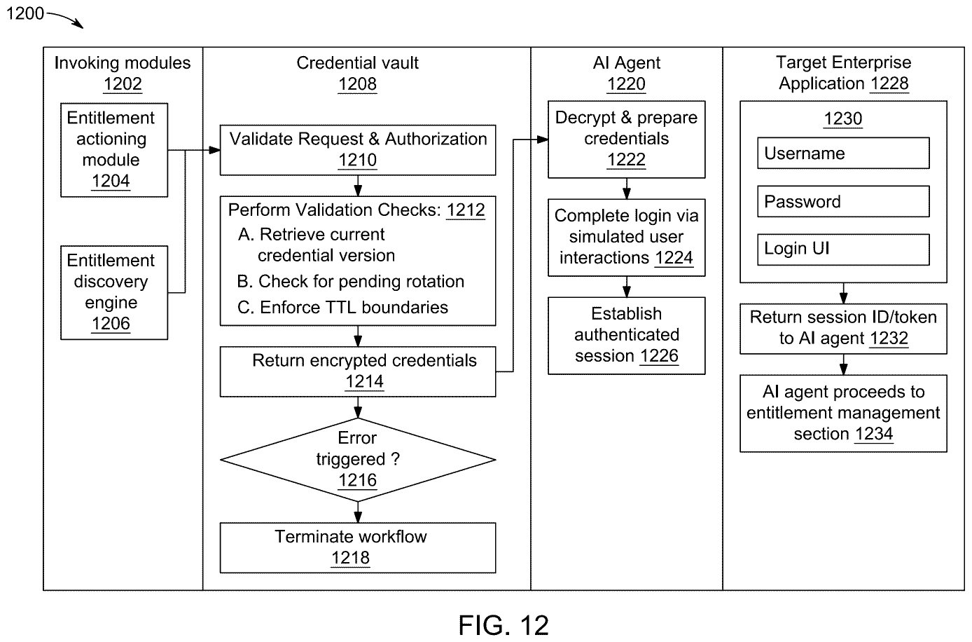

FIG. 12 illustrates a credential vault authentication sequence 1200 depicting the process by which the AI agent authenticates to a target enterprise application accessible for entitlement management through a user interface, in accordance with the credential vault 370 and the AI agent 418 described with reference to FIG. 4. The sequence 1200 is organized across four swim lanes representing the invoking modules 1202, a credential vault 1208, an AI agent 1220, and a target enterprise application 1228. The sequence 1200 traces the flow from credential request through validation, encrypted credential retrieval, decryption, login via simulated user interactions, session establishment, and navigation to an entitlement management section.

The first swim lane of the sequence 1200 depicts invoking modules 1202. The invoking modules 1202 represent the components of the system 400 (described with reference to FIG. 4) that initiate the credential retrieval process. The invoking modules 1202 comprise an entitlement actioning module 1204 (described as entitlement actioning module 430 with reference to FIG. 4) and an entitlement discovery engine 1206 (described as entitlement discovery engine 410 with reference to FIG. 4). The entitlement actioning module 1204 invokes the credential retrieval process when executing an entitlement modification on an enterprise application accessible for entitlement management through a user interface. The entitlement discovery engine 1206 invokes the credential retrieval process when retrieving entitlement data from an enterprise application accessible for entitlement management through a user interface. Either the entitlement actioning module 1204 or the entitlement discovery engine 1206 initiates the sequence 1200 by transmitting a credential request to the credential vault 1208.

The second swim lane of the sequence 1200 depicts a credential vault 1208 (described as credential vault 370 with reference to FIG. 4). Upon receiving the credential request from the invoking modules 1202, the credential vault 1208 performs a validate request and authorization step 1210, where the credential vault 1208 verifies that the requesting module is authorized to retrieve credentials for the target enterprise application. The credential vault 1208 then proceeds to a perform validation checks step 1212. The validation checks at step 1212 comprise three operations: retrieving the current credential version at sub-step A, checking for pending rotation at sub-step B, and enforcing time-to-live (TTL) boundaries at sub-step C. The retrieval of the current credential version at sub-step A confirms that the credential vault 1208 returns the most recent version of the stored credentials. The check for pending rotation at sub-step B verifies whether a credential rotation is scheduled or in progress and, if so, returns the appropriate credential version. The enforcement of TTL boundaries at sub-step C confirms that the credentials have not exceeded their designated expiration period. Upon successful completion of the validation checks at step 1212, the credential vault 1208 proceeds to a return encrypted credentials step 1214, where the credential vault 1208 transmits credentials stored in an encrypted format to the AI agent 1220.

The sequence 1200 reaches a decision point at step 1216, where the credential vault 1208 determines whether an error has been triggered during the validation checks at step 1212. If an error is triggered, the sequence 1200 proceeds to a terminate workflow step 1218, where the credential retrieval process is terminated and the entitlement modification or entitlement discovery operation is halted. For example, if the credentials have exceeded the TTL boundaries, the credential vault 1208 triggers an error at step 1216, and the workflow terminates at step 1218 without returning credentials to the AI agent 1220. If no error is triggered, the sequence 1200 proceeds to the AI agent 1220.

The third swim lane of the sequence 1200 depicts the AI agent 1220 (described as AI agent 418 with reference to FIG. 4). Upon receiving the encrypted credentials from the credential vault 1208 at step 1214, the AI agent 1220 performs a decrypt and prepare credentials step 1222, where the AI agent 1220 decrypts the encrypted credentials and prepares the credentials for use in the authentication process. The AI agent 1220 then proceeds to a complete login via simulated user interactions step 1224, where the AI agent 1220 interacts with the login interface of the target enterprise application 1228 by generating and executing simulated user interactions to enter the decrypted credentials. Upon successful login, the AI agent 1220 proceeds to an establish authenticated session step 1226, where a session is established between the AI agent 1220 and the target enterprise application 1228.

The fourth swim lane of the sequence 1200 depicts the target enterprise application 1228. The target enterprise application 1228 presents a login user interface 1230 comprising input fields for a username, a password, and a login control. The AI agent 1220 interacts with the login user interface 1230 at step 1224 by populating the username and password fields using simulated user interactions and activating the login control. Upon successful authentication, the target enterprise application 1228 proceeds to a return session ID/token to AI agent step 1232, where the target enterprise application 1228 returns a session identifier or authentication token to the AI agent 1220 to maintain the authenticated session. Following receipt of the session identifier or authentication token, the AI agent 1220 proceeds to an AI agent proceeds to entitlement management section step 1234, where the AI agent 1220 navigates to the entitlement management section of the target enterprise application 1228 to perform entitlement data extraction or entitlement modification operations.

### Audit Log Record Structure and Centralized Governance Dashboard

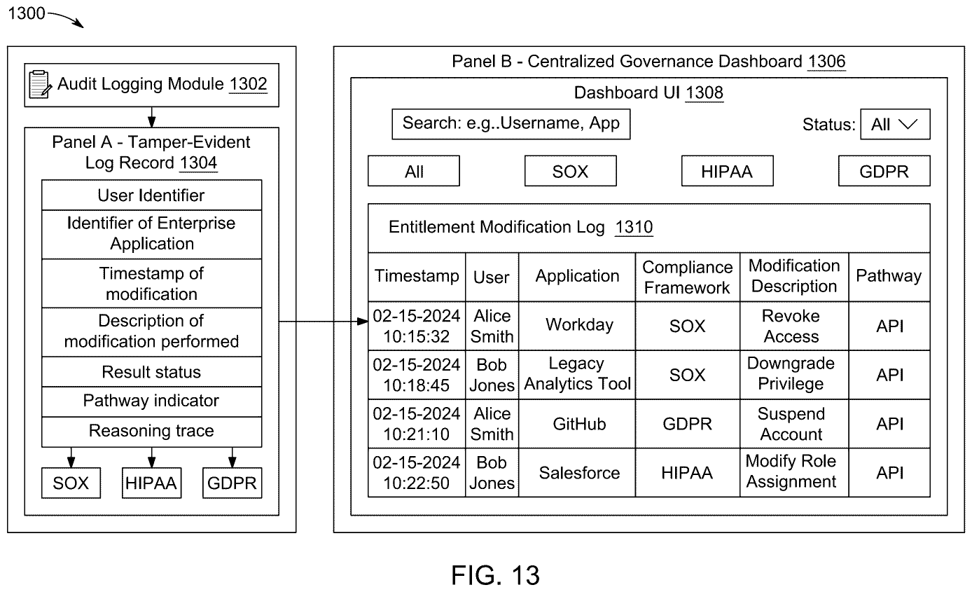

FIG. 13 illustrates a system 1300 block diagram depicting an audit log record structure and centralized governance dashboard, in accordance with the audit logging module 432 described with reference to FIG. 4. The FIG. 13 is organized into two panels: a Panel A depicting the structure of a tamper-evident log record, and a Panel B depicting a centralized governance dashboard that surfaces the tamper-evident log records to administrator and compliance personnel.

Panel A depicts an audit logging module 1302 (described as audit logging module 432 with reference to FIG. 4) and a tamper-evident log record 1304. The tamper-evident log record 1304 illustrates the structured fields that the audit logging module 1302 generates for each entitlement modification. The tamper-evident log record 1304 comprises a user identifier field identifying the user whose access privileges were modified, an identifier of enterprise application field identifying the enterprise application in which the modification was applied, a timestamp of modification field recording the date and time at which the modification was executed, a description of modification performed field recording the nature of the entitlement modification, a result status field indicating whether the modification was successfully applied, a pathway indicator field indicating whether the entitlement modification was executed via the programmatic interface or via the AI agent interacting with the user interface, and a reasoning trace field recording which user interface elements were detected by the perception module, how the semantic interpretation module interpreted each detected element, and which user interface element was selected for the entitlement modification. The pathway indicator field enables differentiated audit review of programmatic and AI-agent-mediated entitlement modifications. The tamper-evident log record 1304 further depicts compliance framework labels including the Sarbanes-Oxley Act (SOX), the Health Insurance Portability and Accountability Act (HIPAA), and the General Data Protection Regulation (GDPR), indicating that the tamper-evident log records may be formatted for compliance reporting under at least one of the three compliance frameworks.

Panel B depicts a centralized governance dashboard 1306. The centralized governance dashboard 1306 is accessible to administrator and compliance personnel and provides real-time visibility into entitlement modification status across all queried enterprise applications. The centralized governance dashboard 1306 comprises a dashboard user interface 1308 and an entitlement modification log 1310. The dashboard user interface 1308 includes a search bar configured to filter entitlement modification records by username, application name, or other search criteria. The dashboard user interface 1308 further includes a status dropdown and compliance framework filter tabs labeled “All,” “SOX,” “HIPAA,” and “GDPR,” enabling compliance personnel to filter the entitlement modification log 1310 by the applicable compliance framework.

The entitlement modification log 1310 displays the tamper-evident log records generated by the audit logging module 1302 in a tabular format. The entitlement modification log 1310 comprises columns for timestamp, user, application, compliance framework, pathway, and result status. FIG. 13 illustrates four representative entitlement modification records within the entitlement modification log 1310.

A first record displays a timestamp of “02-15-2024 10:15:32,” a user identifier of “Alice Smith,” an application identifier of “Workday,” a compliance framework of “SOX,” a pathway of “Revoke Access,” and a result status of “API,” indicating that the entitlement modification was executed via the programmatic interface.

A second record displays a timestamp of “02-15-2024 10:18:45,” a user identifier of “Bob Jones,” an application identifier of “Legacy Analytics Tool,” a compliance framework of “SOX,” a pathway of “Downgrade Privilege,” and a result status of “Agent,” indicating that the entitlement modification was executed via the AI agent interacting with the user interface of the legacy analytics tool, a disconnected enterprise application accessible for entitlement management through a user interface.

A third record displays a timestamp of “02-15-2024 10:21:10,” a user identifier of “Alice Smith,” an application identifier of “GitHub,” a compliance framework of “GDPR,” a pathway of “Suspend Account,” and a result status of “API,” indicating that the entitlement modification was executed via the programmatic interface.

A fourth record displays a timestamp of “02-15-2024 10:22:50,” a user identifier of “Bob Jones,” an application identifier of “Salesforce,” a compliance framework of “HIPAA,” a pathway of “Modify Role Assignment,” and a result status of “API,” indicating that the entitlement modification was executed via the programmatic interface.

The entitlement modification log 1310 illustrates the differentiated audit review enabled by the pathway indicator, where three of the four records indicate entitlement modifications executed via the programmatic interface (“API”) and one record indicates an entitlement modification executed via the AI agent (“Agent”) interacting with the user interface of a disconnected enterprise application. The centralized governance dashboard 1306 enables compliance personnel to review, filter, and audit all entitlement modifications across the enterprise application estate in real time.

### Dynamic UI Adaptation

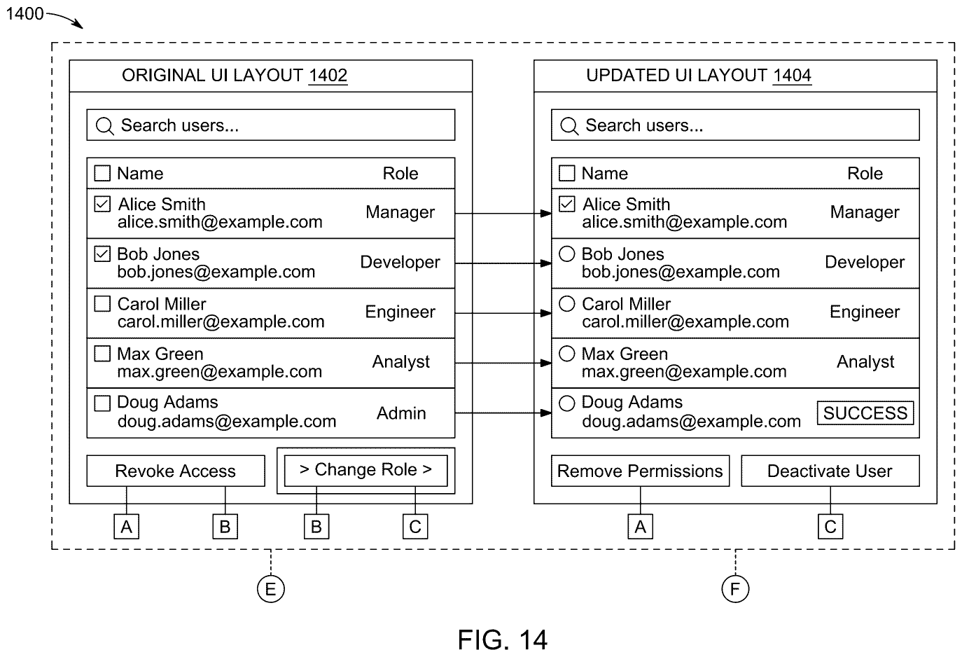

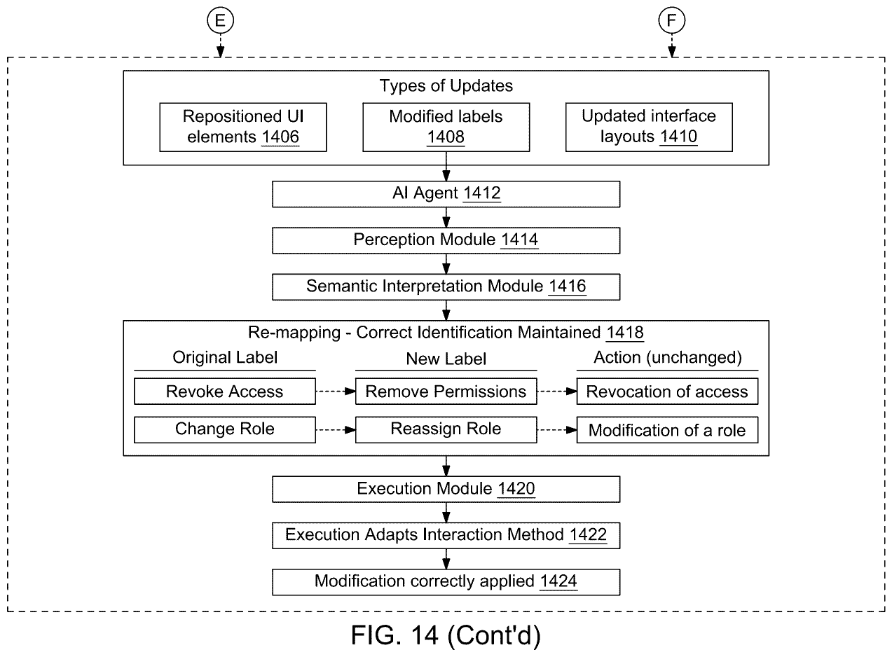

FIG. 14 illustrates a dynamic UI adaptation 1400 depicting how the AI agent (described as AI agent 418 with reference to FIG. 4) dynamically adapts to changes in the user interface of an enterprise application accessible for entitlement management through a user interface, including repositioned user interface elements, modified labels, and updated interface layouts, without requiring reconfiguration of the AI agent. The figure depicts a side-by-side comparison of an original UI layout and an updated UI layout, followed by the processing pipeline through which the AI agent re-detects, re-interprets, and correctly applies entitlement modifications despite the user interface changes.

The original UI layout 1402 displays a user management interface of the enterprise application comprising a search bar, a user table with columns for name and role, and action buttons at the bottom of the interface. The user table in the original UI layout 1402 lists five users: Alice Smith assigned the role “Manager” with email alice.smith@example.com, Bob Jones assigned the role “Developer” with email bob.jones@example.com, Carol Miller assigned the role “Engineer” with email carol.miller@example.com, Max Green assigned the role “Analyst” with email max.green@example.com, and Doug Adams assigned the role “Admin” with email doug.adams@example.com. The original UI layout 1402 displays action buttons labelled “Revoke Access” and “>Change Role>” at the bottom of the interface. Element type indicators A, B, B, and C mark the positions of user interface element categories across the original UI layout 1402, where indicator A marks the user selection area, indicator B marks the role controls area, and indicator C marks the action button area.

The updated UI layout 1404 displays the same user management interface after the enterprise application has undergone a user interface redesign. The user table in the updated UI layout 1404 lists the same five users with the same email addresses and role assignments, but the user interface elements have been repositioned, labels have been modified, and the overall interface layout has been updated. The action buttons in the updated UI layout 1404 are labelled “Remove Permissions” and “Deactivate User,” replacing the original labels “Revoke Access” and “>Change Role>.” The element type indicators in the updated UI layout 1404 show indicators A and C, reflecting the repositioned arrangement of user interface elements. A “SUCCESS” indicator adjacent to Doug Adams in the updated UI layout 1404 indicates that a deactivation action has been successfully completed by the AI agent despite the modified labels and updated layout. Connector labels E and F at the bottom of the original UI layout 1402 and the updated UI layout 1404 link to the continuation of the figure.

Inputs from connectors E and F classify the differences between the original UI layout 1402 and the updated UI layout 1404 into three categories of user interface changes at a types of updates step. The three categories comprise repositioned UI elements 1406, modified labels 1408, and updated interface layouts 1410. The repositioned UI elements 1406 represent user interface elements that have changed position within the interface without changing function. The modified labels 1408 represent user interface elements whose textual labels have changed while the underlying access privilege action remains the same. The updated interface layouts 1410 represent structural changes to the overall arrangement and organization of the user interface.

An AI agent 1412 (described as AI agent 418 with reference to FIG. 4) processes the types of updates. A perception module 1414 (described as perception module 420 with reference to FIG. 4) re-detects user interface elements associated with access privilege controls after the changes in the user interface layout. The perception module 1414 identifies the repositioned elements, the modified labels, and the updated layout structure in the updated UI layout 1404. A semantic interpretation module 1416 (described as semantic interpretation module 422 with reference to FIG. 4) re-interprets the textual content associated with the re-detected elements to maintain correct identification of access privilege actions despite the layout change.

The semantic interpretation module 1416 performs a re-mapping operation at step 1418, where correct identification of access privilege actions is maintained despite the modified labels. The re-mapping at step 1418 maps an original label “Revoke Access” to a new label “Remove Permissions” with the access privilege action “revocation of access” remaining unchanged. The re-mapping at step 1418 further maps an original label “Change Role” to a new label “Reassign Role” with the access privilege action “modification of a role” remaining unchanged. The re-mapping at step 1418 demonstrates that the semantic interpretation module 1416 correctly identifies the underlying access privilege action regardless of the specific textual label used by the enterprise application, enabling the AI agent 1412 to operate across enterprise applications with different labelling conventions and to continue operating correctly when an enterprise application modifies its labels.

An execution module 1420 (described as execution module 424 with reference to FIG. 4) receives the re-mapped access privilege actions from the semantic interpretation module 1416. At step 1422, the execution module 1420 adapts the interaction method to account for the repositioned user interface elements and updated interface layout. The execution module 1420 generates and executes simulated user interactions with the re-detected and re-interpreted user interface elements in the updated UI layout 1404. At step 1424, the entitlement modification is correctly applied, confirming that the AI agent 1412 has successfully adapted to the changes in the user interface without requiring reconfiguration of the AI agent 1412.

### Continuous Monitoring and Anomaly Detection Process

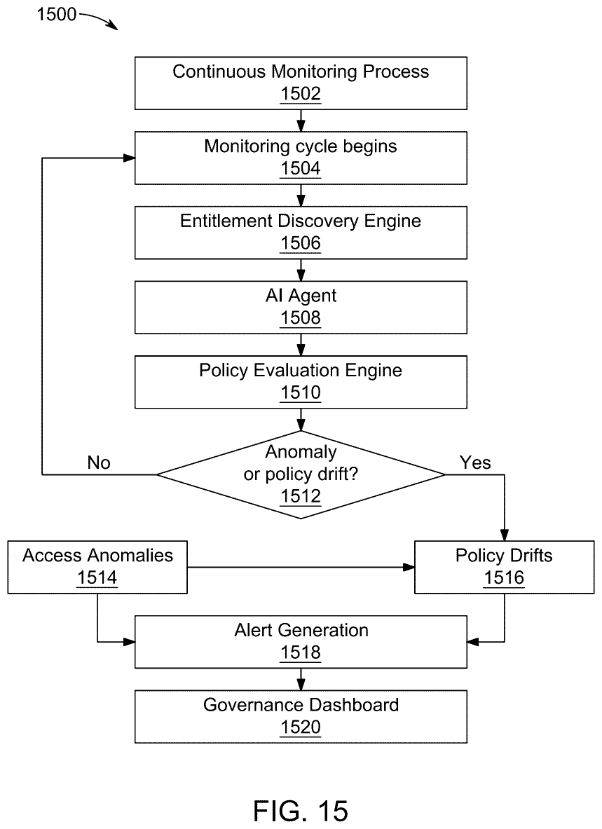

FIG. 15 illustrates a continuous monitoring and anomaly detection process 1500, in accordance with the entitlement discovery engine 410 described with reference to FIG. 4. The process 1500 depicts a recurring monitoring loop in which the entitlement discovery engine periodically monitors entitlement data from at least one enterprise application accessible for entitlement management through a user interface to identify access anomalies or policy drifts prior to receipt of an audit trigger from the governance trigger interface. The process 1500 enables the system 400 (described with reference to FIG. 4) to detect entitlement violations proactively between scheduled audit cycles rather than relying exclusively on periodic triggers or event-driven triggers to initiate entitlement review workflows.

The process 1500 begins at a continuous monitoring process step 1502. The continuous monitoring process represents an automated, recurring process that operates independently of the audit triggers received by the governance trigger interface 404 (described with reference to FIG. 4). At step 1504, a monitoring cycle begins. The monitoring cycle at step 1504 initiates a new iteration of the continuous monitoring loop, and the process 1500 repeats the monitoring cycle at predetermined intervals to maintain ongoing visibility into the entitlement state of the enterprise application estate.

At step 1506, an entitlement discovery engine (described as entitlement discovery engine 410 with reference to FIG. 4) retrieves entitlement data from the plurality of enterprise applications. The entitlement discovery engine queries both enterprise applications that expose a programmatic interface and enterprise applications accessible for entitlement management through a user interface to obtain current entitlement data comprising user identifiers, roles, and role-specific attributes. At step 1508, an AI agent (described as AI agent 418 with reference to FIG. 4) navigates the user interface of enterprise applications that do not expose a programmatic interface to extract entitlement data therefrom, as described with reference to FIG. 4.

At step 1510, a policy evaluation engine (described as policy evaluation engine 428 with reference to FIG. 4) evaluates the obtained entitlement data against predefined access control policies (described as predefined access control policies 426 with reference to FIG. 4). The policy evaluation engine compares the current entitlement state retrieved at step 1506 against the predefined access control policies to determine whether any deviations have occurred since the previous monitoring cycle or since the most recent audit trigger.

The process 1500 reaches a decision point at step 1512, where the policy evaluation engine determines whether an access anomaly or a policy drift has been detected. An access anomaly is a deviation from expected entitlement patterns that may indicate unauthorized access changes, privilege escalation, or entitlement modifications performed outside of approved governance workflows. A policy drift is a gradual divergence between the current entitlement state of an enterprise application and the permissible user-role combinations defined by the predefined access control policies, occurring over time as incremental changes accumulate without triggering an audit review. If no anomaly or policy drift is detected, the process 1500 follows the “No” path and returns to the monitoring cycle begins step 1504 to initiate the next monitoring cycle. If an anomaly or policy drift is detected, the process 1500 follows the “Yes” path and classifies the detected deviation.

Upon detection, the process 1500 classifies the deviation as one of two categories: access anomalies 1514 or policy drifts 1516. The access anomalies represent deviations in which a user's access privileges have changed in a manner inconsistent with the predefined access control policies, including unauthorized privilege escalation, unexpected account activation, or entitlement modifications not initiated through the governance trigger interface. The policy drifts represent gradual deviations in which the entitlement state of one or more enterprise applications has diverged from the predefined access control policies over successive monitoring cycles without any single triggering event.

At step 1518, the process 1500 performs alert generation. The alert generation at step 1518 generates an alert upon detection of an entitlement violation prior to a scheduled audit cycle. The alert generated at step 1518 is transmitted to the identity governance system (described as identity governance system 402 with reference to FIG. 4) or to designated compliance personnel to notify relevant stakeholders of the detected access anomaly or policy drift. At step 1520, the alert generated at step 1518 is surfaced in a centralized governance dashboard (described as centralized governance dashboard 1306 with reference to FIG. 13) accessible to administrator and compliance personnel, enabling real-time visibility into the detected anomalies and policy drifts across the enterprise application estate.

### Severity Classification and Dual Execution Path

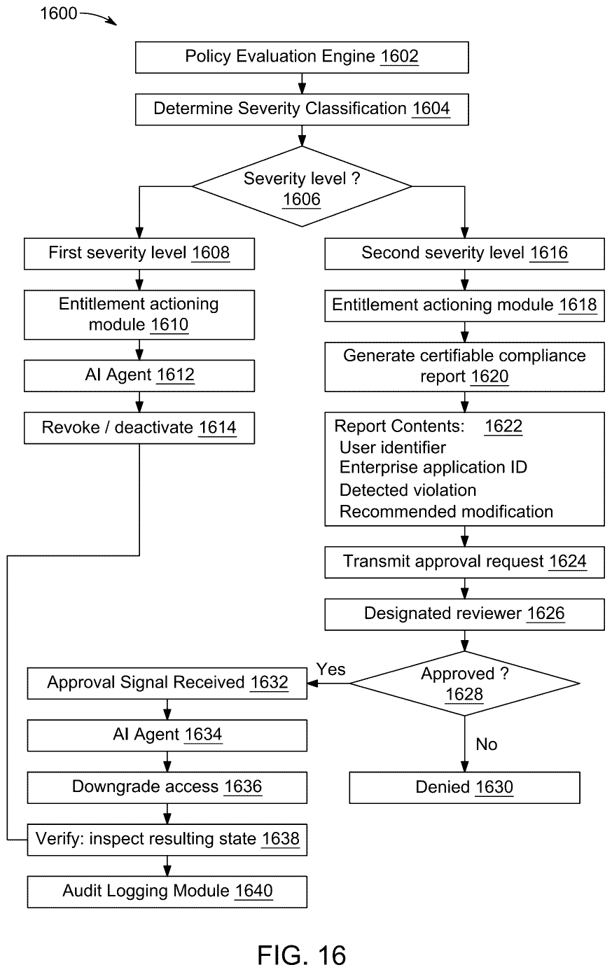

FIG. 16 illustrates a severity classification and dual execution path 1600, in accordance with the policy evaluation engine 428 and the entitlement actioning module 430 described with reference to FIG. 4. The figure depicts the process by which the policy evaluation engine determines a severity classification for each identified entitlement violation and the entitlement actioning module selects between an immediate execution path for first severity level violations and an asynchronous execution path for second severity level violations.

FIG. 16 begins at a policy evaluation engine 1602 (described as policy evaluation engine 428 with reference to FIG. 4). At step 1604, the policy evaluation engine 1602 determines a severity classification for each identified entitlement violation based on a degree of semantic mismatch between the obtained entitlement data and the predefined access control policies. The FIG. 16 proceeds to a decision point at step 1606, where the severity level of the identified entitlement violation is evaluated.

If the entitlement violation is classified at a first severity level at step 1608, the FIG. 16 proceeds along the immediate execution path on the left side. The first severity level comprises at least one of an active user account for a user whose employment has been terminated, the active user account constituting an orphan account, or an active user account with administrative or privileged access for a user whose current role assignment does not include administrative or privileged access. An entitlement actioning module 1610 (described as entitlement actioning module 430 with reference to FIG. 4) receives the first severity level violation and directs an AI agent 1612 (described as AI agent 418 with reference to FIG. 4) to immediately execute the entitlement modification. At step 1614, the AI agent 1612 revokes the access privileges or deactivates the user account by generating and executing simulated user interactions with the user interface elements associated with access privilege controls, without transmitting an approval request and without awaiting external authorization. The immediate execution path from step 1608 through step 1614 proceeds directly to a verify step at 1638 and an audit logging module at step 1640.

If the entitlement violation is classified at a second severity level at step 1616, the FIG. 16 proceeds along the asynchronous execution path on the right side. The second severity level comprises at least one of a user possessing access privileges that exceed those defined for the user's current role where the user's employment status remains active, or a user retaining access privileges associated with a previously held role where the predefined access control policies specify a grace period for role transitions. An entitlement actioning module 1618 (described as entitlement actioning module 430 with reference to FIG. 4) receives the second severity level violation and suspends the execution module from generating simulated user interactions with the user interface. At step 1620, the entitlement actioning module 1618 generates a certifiable compliance report. The certifiable compliance report comprises report contents at reference 1622, the report contents including a user identifier, an enterprise application identifier, a detected violation description, and a recommended modification. At step 1624, the entitlement actioning module 1618 transmits an approval request to a designated reviewer at step 1626. The designated reviewer is a designated system owner or compliance reviewer authorized to approve or deny the recommended entitlement modification.

The FIG. 16 reaches a decision point at step 1628, where the designated reviewer evaluates the certifiable compliance report and determines whether to approve the recommended entitlement modification. If the designated reviewer denies the recommended modification, the FIG. 16 proceeds along the “No” path to a denied step 1630, and the entitlement modification is not executed. If the designated reviewer approves the recommended modification, the FIG. 16 proceeds along the “Yes” path to an approval signal received step 1632. The approval signal received at step 1632 comprises at least one of a cryptographic approval token signed by the designated system owner or compliance reviewer, the token comprising at least an identifier of the reviewer, a timestamp of the approval, and a reference to the entitlement modification being approved, or a programmatic approval signal received via an application programming interface of the identity governance system.

Upon receiving the approval signal at step 1632, an AI agent 1634 (described as AI agent 418 with reference to FIG. 4) resumes execution of the entitlement modification. At step 1636, the AI agent 1634 downgrades the access privileges by generating and executing simulated user interactions with user interface elements associated with access privilege controls to reduce the user's access to a privilege level consistent with the user's current role. At step 1638, the AI agent 1634 verifies the entitlement modification by inspecting a resulting state of the user interface after the simulated user interactions have been executed. The verification at step 1638 re-examines the user interface elements through the perception module and the semantic interpretation module of the AI agent 1634 to confirm that the access privileges have been updated in accordance with the entitlement modification. Both the immediate execution path from step 1614 and the asynchronous execution path from step 1636 converge at the verification step 1638.

At step 1640, an audit logging module (described as audit logging module 432 with reference to FIG. 4) generates a tamper-evident log record for the entitlement modification, comprising at least a user identifier, an identifier of the enterprise application, a timestamp, a description of the modification performed, a result status, the severity classification, and an indication of whether the modification was executed via the immediate execution path or the asynchronous execution path.

### Artificial Intelligence System Implementation

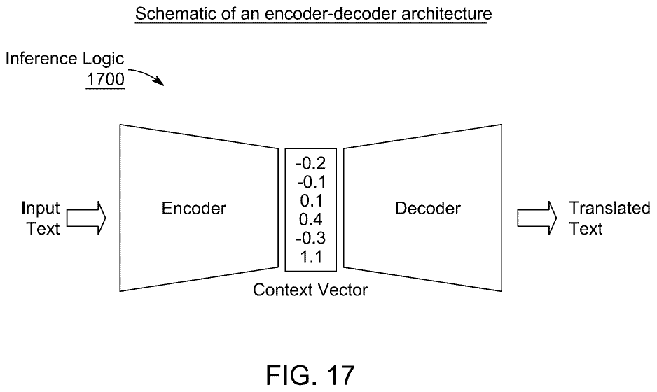

The system 400 described in conjunction with FIG. 4 through FIG. 16 comprises one or more subsystems based on artificial intelligence. Implementation of the subsystems based on artificial intelligence is illustrated by FIG. 17 through FIG. 26. The artificial intelligence subsystems provide the computational models, training architectures, and inference pipelines that enable the perception module 420 to perform computer vision operations on user interface elements, the semantic interpretation module 422 to perform language model inference on textual content associated with detected user interface elements, and the execution module 424 to generate and execute simulated user interactions based on the outputs of the perception module 420 and the semantic interpretation module 422. The following description of FIG. 17 through FIG. 26, depicting inference logic 1700, applies to various implementations of the artificial intelligence subsystems and is not limited to any single model architecture, training methodology, or hardware configuration.

Some implementations of the technology disclosed relate to using a Transformer model to provide an AI system. In particular, the technology disclosed proposes a parallel input, parallel output (PIPO) AI system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically have a limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLAMA versions, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, VITB/16-FRCNN, VIT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bi-directional LSTM (Bi-LSTM), or a gated recurrent unit (GRU). In yet another implementation, the disclosed AI system includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

FIG. 17 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using only RNNs in an encoder-decoder architecture.

### Attention Mechanism

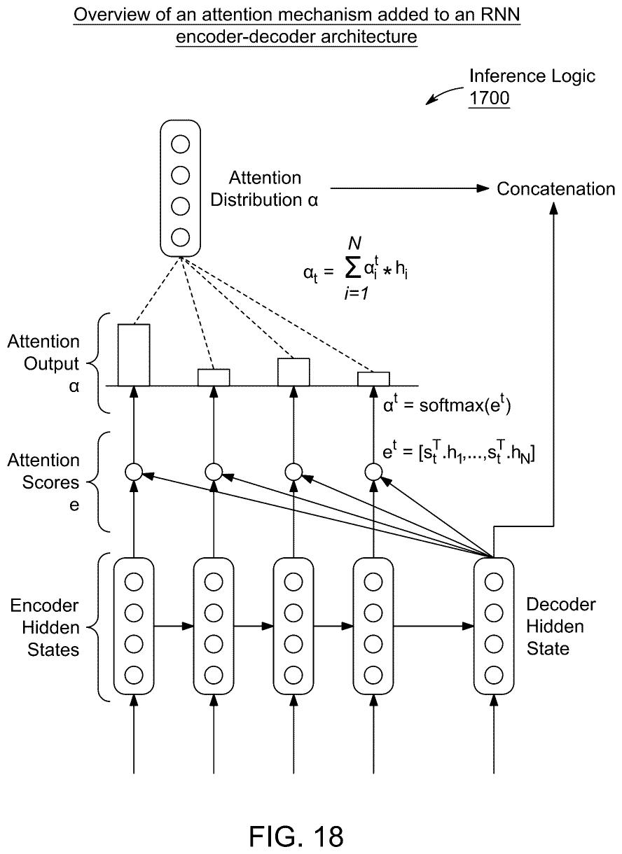

Attention mechanisms distinguish Transformers from other machine learning models. The attention mechanism provides a solution for the vanishing gradient problem. FIG. 18 shows an overview of an attention mechanism added onto an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

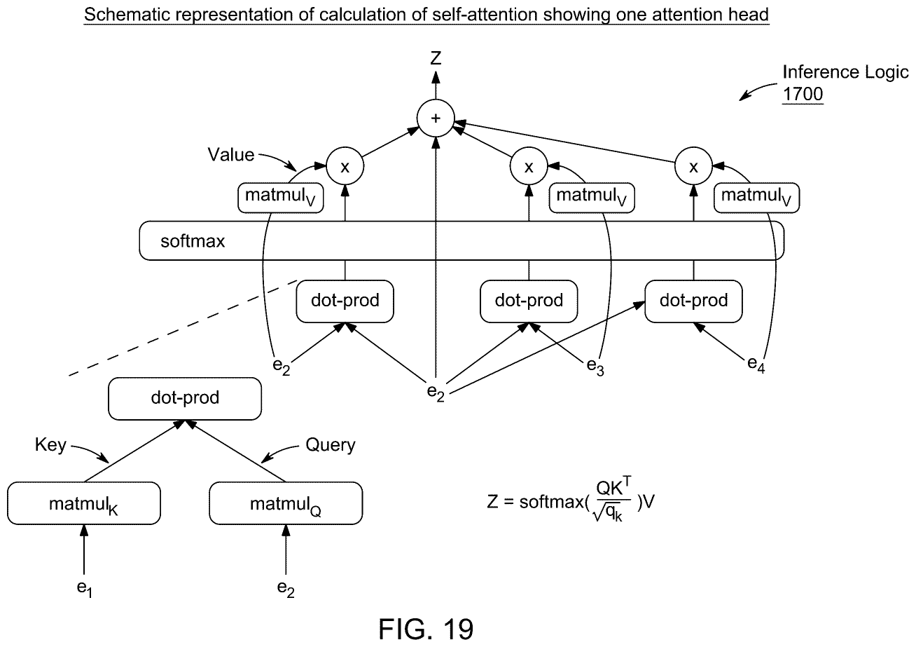

Multi-headed attention is executed in the Transformer. FIG. 19 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

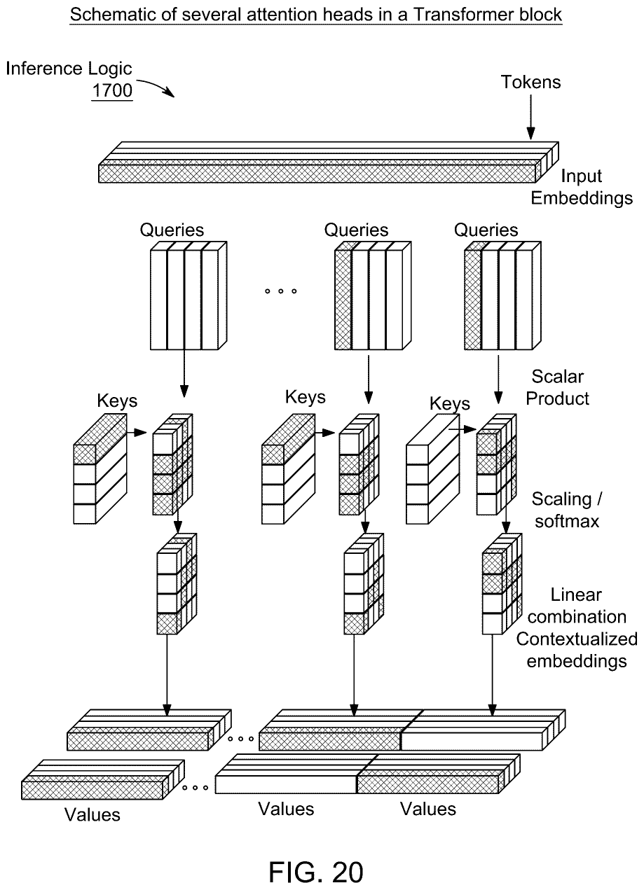

FIG. 20 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and dis the hidden representation of each element (also called the hidden vector). Attention is then computed as:

$$Attention ( Q , K , V ) = ( \frac{Q {K}^{T}}{\sqrt{d k}} ) V$$

where Q, K, V are computed as:
X. W_{Q}, X·W_{K}, X·W_{V}

X is the input matrix and W_{Q}, W_{K}, W_{V} are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:
MultiHeadAttention (Q, K, V)=[head₁, . . . , headₙ] W₀ where headᵢ=Attention

$$( Q {W}_{i}^{Q} , {KW}_{i}^{K} , V {W}_{i}^{V} )$$

The outputs of all heads are concatenated together and projected again using the learned weights matrix W₀ to match the dimensions expected by the next block of heads or the output of the Transformer. Using the multi-head attention instead of the simpler scaled dot-product attention enables Transformers to jointly attend to information from different representation subspaces at different positions.

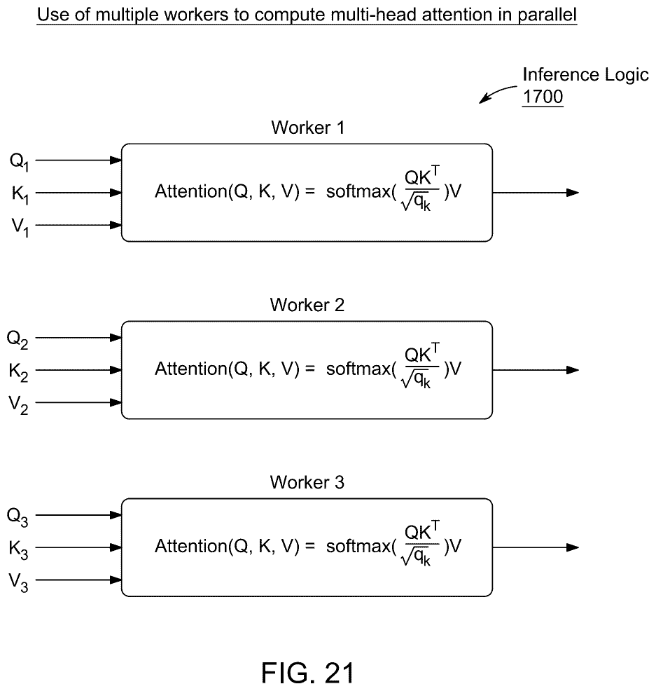

As shown in FIG. 21, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

a·b·c

For matrices of shape (a, b) and (c, d), to obtain values Q, K, V, we need to compute the operations:

X·W_{Q},X·W_{K},X·WV

The matrix X is of shape (n, d) where n is the number of patches and d is the hidden vector dimension. The weights W_{Q}, W_{K}, W_{V} are all of shape (d, d). Omitting the constant factor 3, the resulting complexity is:

n·d²

We can proceed to the estimation of the complexity of the attention function itself, i.e., of

$$Softmax ( \frac{Q {K}^{T}}{\sqrt{d k}} ) V .$$

The matrices Q and K are both of shape (n, d). The transposition operation does not influence the asymptotic complexity of computing the dot product of matrices of shapes (n, d)·(d, n), therefore its complexity is:

n²·d

Scaling by a constant factor of \sqrt{dk}, where dk is the dimension of the keys vector, as well as applying the SoftMax function, both have the complexity of a·b for a matrix of shape (a, b), hence they do not influence the asymptotic complexity. Lastly the dot product SoftMax

$$( \frac{Q {K}^{T}}{\sqrt{d k}} ) \cdot V$$

is between matrices of shapes (n, n) and (n, d) and so its complexity is:

n²·d

The final asymptotic complexity of scaled dot-product attention is obtained by summing the complexities of computing Q, K, V, and of the following attention function:

n·d²+n²·d.

The asymptotic complexity of multi-head attention is the same since the original input matrix X is projected into h matrices of shapes

$$( n , \frac{d}{h} ) ,$$

where h is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

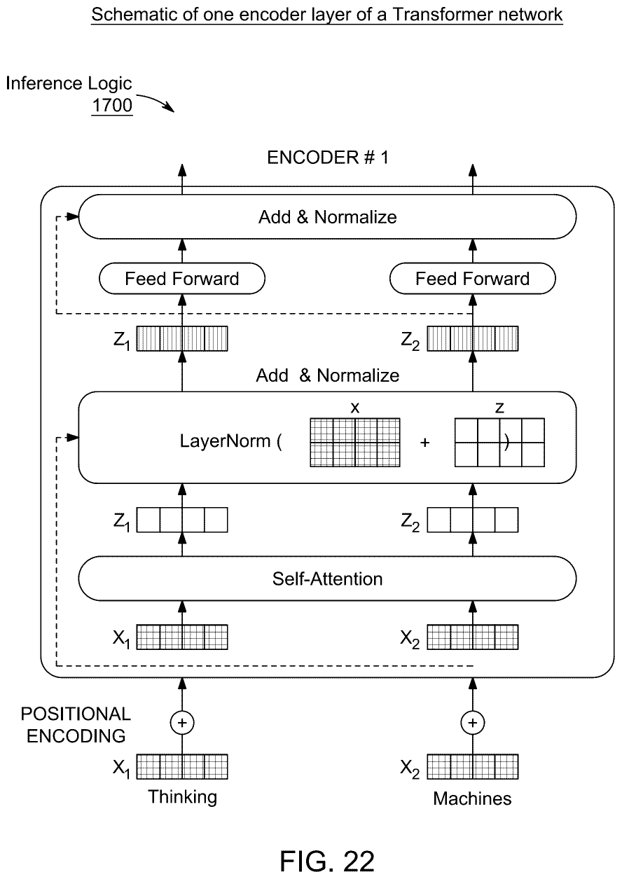

FIG. 22 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

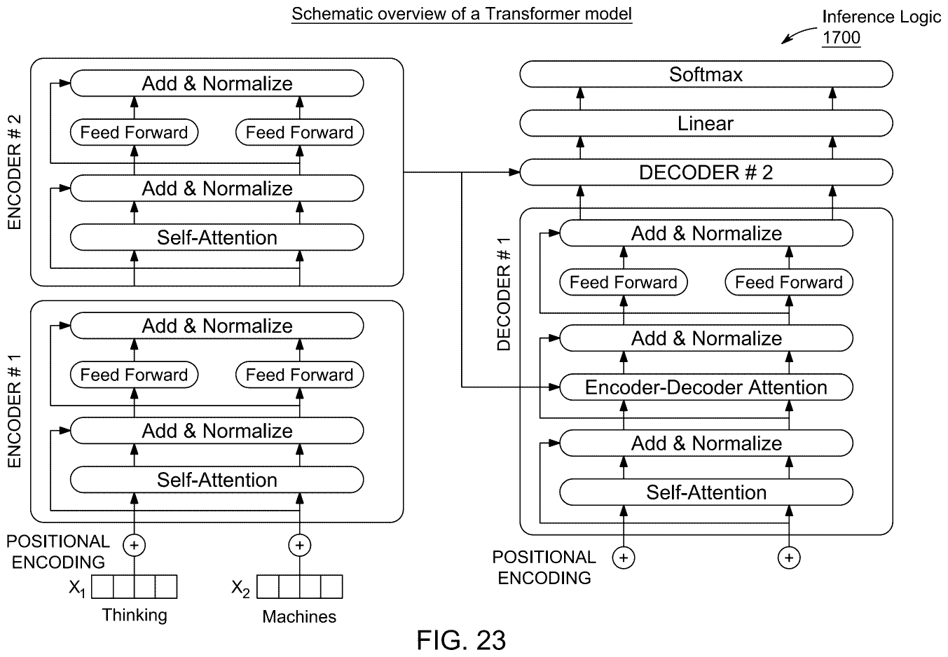

FIG. 23 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

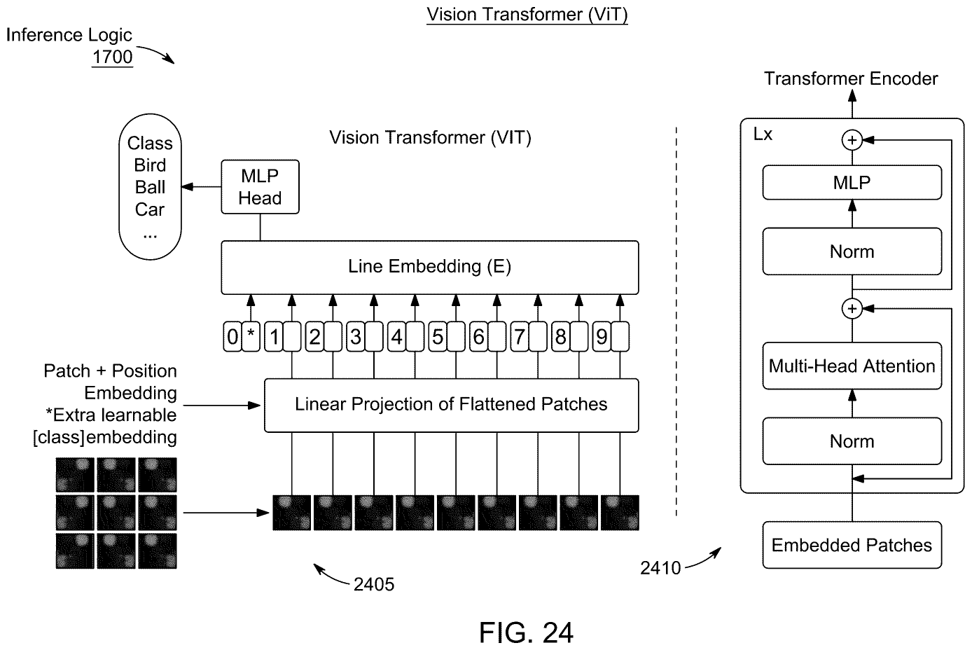

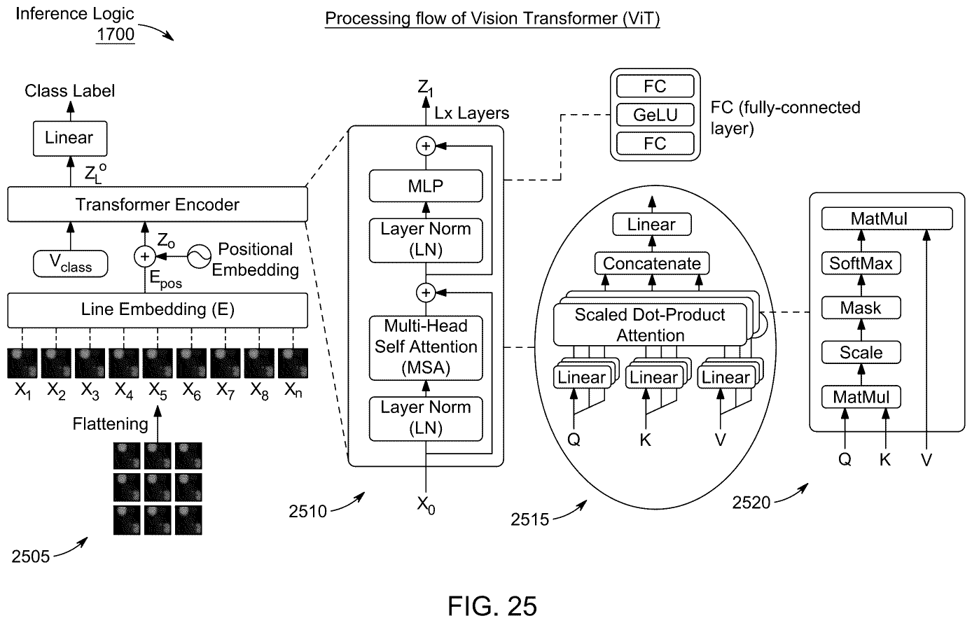

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIG. 24 (2405, 2410) and FIG. 25 (2505, 2510, 2515, and 2520). Unfortunately, important positional information is lost because image sets are position-invariant. This problem is solved by adding a learned positional encoding into the image patches.

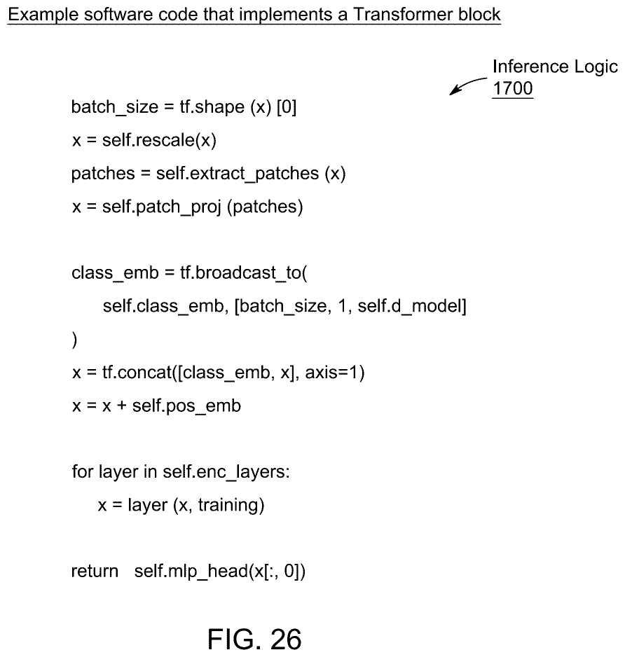

The computations of the ViT architecture can be summarized as follows. The first layer of a ViT extracts a fixed number of patches from an input image (2505). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 26.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block in FIG. 25, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

### Computer System

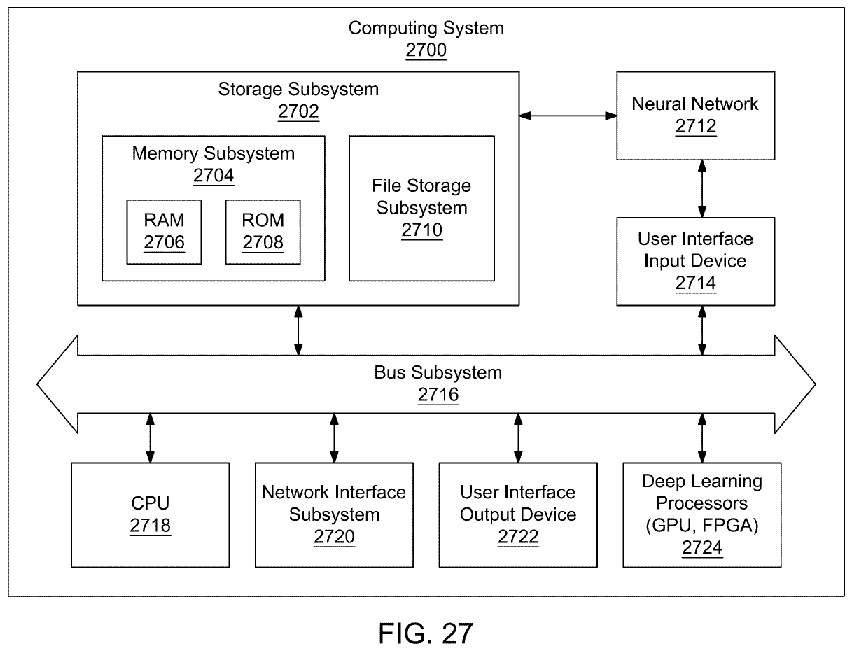

FIG. 27 shows an example computer system 2700 that can be used to implement the technology disclosed. The computer system 2700 is a representation of the system, as described in FIG. 4. The computer system 2700 includes at least one central processing unit (CPU) 2718 that communicates with a number of peripheral devices via bus subsystem 2716. These peripheral devices can include a storage subsystem 2702 including, for example, memory devices and a file storage subsystem 2710, user interface input devices 2714, user interface output devices 2722, and a network interface subsystem 2720. The input and output devices allow user interaction with computer system 2700. Network interface subsystem 2720 provides an interface to outside networks, including an interface to corresponding interface devices in other computer systems.

In one implementation, a neural network 2712 is communicably linked to the storage subsystem 2702 and the user interface input devices 2714.

User interface input devices 2714 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 2700.

User interface output devices 2722 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 2700 to the user or to another machine or computer system.

Storage subsystem 2702 stores programming and data constructs that provide the functionality of some or all of the modules and methods described herein. These software modules are generally executed by deep learning processors 2724.

Deep learning processors 2724 can be graphics processing units (GPUs), field-programmable gate arrays (FPGAs), application-specific integrated circuits (ASICs), and/or coarse-grained reconfigurable architectures (CGRAs). Processors 2724 can be hosted by a deep learning cloud platform such as Google Cloud Platform™, Xilinx™, and Cirrascale™ Examples of processors 2724 include Google's Tensor Processing Unit (TPU)™, rackmount solutions like GX4 Rackmount Series™, GX6 Rackmount Series™, NVIDIA DGX-1™, Microsoft's Stratix V aFPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 2704 used in the storage subsystem 2702 can include a number of memories including a main random-access memory (RAM) 2706 for storage of instructions and data during program execution and a read only memory (ROM) 2708 in which fixed instructions are stored. A file storage subsystem 2710 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 2710 in the storage subsystem 2702, or in other machines accessible by the processor.

Bus subsystem 2716 provides a mechanism for letting the various components and subsystems of computer system 2700 communicate with each other as intended. Although bus subsystem 2716 is shown schematically as a single bus, alternative implementations of the bus subsystem can use multiple buses.

Computer system 2700 itself can be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 2700 depicted in FIG. 27 is intended only as a specific example for the purpose of illustrating the preferred implementations of the present technology disclosed. Many other configurations of computer system 2700 are possible having more or fewer components than the computer system depicted in FIG. 27.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 27, computer system/server in computing node is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

### CLAUSES

A 1. A computer-implemented method for managing access entitlements across a plurality of enterprise systems, the method comprising:
receiving an audit trigger from an identity governance platform or an access management system;
obtaining entitlement data from the plurality of enterprise systems, the plurality of enterprise systems including at least one enterprise system accessible for entitlement management only through a user interface, the obtaining comprising:
   (i) querying, via a programmatic interface, enterprise systems that expose an entitlement management application programming interface to retrieve entitlement data therefrom; and
   (ii) navigating, by an AI agent, the user interface of the at least one enterprise system to extract entitlement data therefrom;
identifying one or more entitlement violations in the at least one enterprise system accessible for entitlement management only through the user interface by evaluating the obtained entitlement data against one or more access control policies, and by performing a cross-source comparison between the entitlement data extracted by the AI agent and user status data and role assignment data maintained in the identity governance platform; and
for at least one identified entitlement violation, executing at least one modification by controlling access privileges, where:
   for an enterprise system that exposes the entitlement management application programming interface, the at least one modification is executed by issuing commands via the application programming interface; and
   for the at least one enterprise system accessible for entitlement management only through the user interface, the at least one modification is executed by the AI agent detecting user interface elements rendered on the user interface using a computer vision algorithm, the user interface elements being associated with access privilege controls, interpreting textual content associated with the detected user interface elements using a language model to identify, from the detected user interface elements, a target user interface element corresponding to the at least one modification, and applying the at least one modification by generating and executing simulated user interactions with the target user interface element.
2. The computer-implemented method of clause 1, where the AI agent comprises:
a perception module configured to detect and classify the user interface elements associated with access privilege controls using the computer vision algorithm;
a semantic interpretation module configured to interpret the textual content associated with the detected user interface elements using the language model; and
an execution module configured to generate and execute the simulated user interactions with the target user interface element to apply the at least one modification.
3. The computer-implemented method of clause 2, where the perception module is configured to detect user interface elements comprising at least one of entitlement selectors, user role dropdowns, access revocation buttons, or user deactivation controls, and to classify the detected user interface elements by their function relative to access privilege management.
4. The computer-implemented method of clause 2, where the semantic interpretation module is configured to distinguish between user interface elements associated with different access privilege actions, including labels indicating at least one of revocation of access, modification of a role, deactivation of an account, or downgrading of privileges, and to select the target user interface element for the at least one modification.
5. The computer-implemented method of clause 2, where the execution module is configured to generate and execute the simulated user interactions comprising at least one of mouse click simulation, keyboard input simulation, or form field population, to apply the at least one modification by controlling access privileges in the at least one enterprise system.
6. The computer-implemented method of clause 2, where the AI agent is further configured to dynamically adapt to changes in the user interface of the at least one enterprise system, including repositioned user interface elements, modified labels, and updated interface layouts, by the perception module re-detecting the user interface elements associated with access privilege controls after a change in the user interface and the semantic interpretation module re-interpreting textual content associated with the re-detected user interface elements to maintain identification of the access privilege actions despite the change in the user interface.
7. The computer-implemented method of clause 2, where the perception module, the semantic interpretation module, and the execution module operate sequentially, where the perception module first detects the user interface elements, the semantic interpretation module then interprets the detected user interface elements to identify an access privilege action to perform, and the execution module then generates and executes the simulated user interactions to perform the identified access privilege action.
8. The computer-implemented method of clause 1, where the audit trigger comprises a periodic trigger generated by the identity governance platform or the access management system on a recurring schedule, including at least one of a 30-day, 60-day, or 90-day audit cycle.
9. The computer-implemented method of clause 1, where the audit trigger comprises an event-driven trigger generated by the identity governance platform or the access management system in response to at least one of detection of a user's organizational departure, a user role reassignment, or a project completion event.
10. The computer-implemented method of clause 1, further comprising periodically monitoring entitlement data from the at least one enterprise system accessible for entitlement management only through the user interface to identify access anomalies or policy drifts prior to receipt of the audit trigger, and generating an alert upon detection of an entitlement violation prior to a scheduled audit cycle.
11. The computer-implemented method of clause 1, where the entitlement data obtained from the plurality of enterprise systems comprises at least one of user identifiers, roles, or role-specific attributes, and where at least one of the user identifiers, the roles, or the role-specific attributes is evaluated against the one or more access control policies to identify the one or more entitlement violations.
12. The computer-implemented method of clause 1, where navigating, by the AI agent, the user interface of the at least one enterprise system comprises the AI agent autonomously navigating to an entitlement management section of the at least one enterprise system and extracting user roles and role-specific entitlements displayed within the user interface.
13. The computer-implemented method of clause 1, where obtaining entitlement data from the plurality of enterprise systems further comprises mapping entitlement data retrieved via the programmatic interface and entitlement data extracted by the AI agent from the user interface into a unified entitlement dataset according to a common entitlement schema specifying field types including at least user identifiers, role identifiers, and access privilege identifiers, the unified entitlement dataset spanning both enterprise systems queried via the programmatic interface and enterprise systems accessed only through the user interface.
14. The computer-implemented method of clause 1, where the at least one enterprise system accessible for entitlement management only through the user interface comprises at least one of a legacy on-premises application, a third-party web application, a graphical user interface only platform, or a disconnected enterprise tool not integrated with an identity and access management system.
15. The computer-implemented method of clause 1, where the one or more access control policies comprise predefined access control policies specifying permissible user-role combinations for the plurality of enterprise systems.
16. The computer-implemented method of clause 1, where identifying the one or more entitlement violations comprises identifying at least one of:
a user retaining access privileges inconsistent with the user's current role assignment;
a user retaining access privileges to systems associated with a previously held role or project after the role or project assignment has ended; or
a user possessing access privileges exceeding those defined for the user's current role by the one or more access control policies.
17. The computer-implemented method of clause 1, where identifying the one or more entitlement violations comprises identifying a user who has departed the organization or whose employment has been terminated and who retains access privileges in at least one enterprise system, the identifying being performed by the cross-source comparison between the entitlement data extracted by the AI agent and the user status data maintained in the identity governance platform.
18. The computer-implemented method of clause 1, where identifying the one or more entitlement violations comprises identifying a user who has transitioned to a different role or organizational assignment and who retains access privileges associated with a previously held role in at least one enterprise system, the identifying being performed by the cross-source comparison between the entitlement data extracted by the AI agent and the role assignment data maintained in the identity governance platform, where the one or more access control policies specify that the retained access privileges constitute an entitlement violation.
19. The computer-implemented method of clause 1, where the at least one modification by controlling access privileges comprises at least one of revoking access privileges, downgrading access privileges to a lower privilege level, suspending access privileges, or reassigning a user to a different role.
20. The computer-implemented method of clause 1, where for the at least one enterprise system accessible for entitlement management only through the user interface, the AI agent is further configured to authenticate to the at least one enterprise system, prior to interacting with the user interface, by retrieving credentials from a credential vault that stores credentials in an encrypted format and by selecting only credentials whose version is current, whose rotation status is not pending, and whose time-to-live has not expired.
21. The computer-implemented method of clause 1, where the AI agent, upon applying the at least one modification through the user interface, verifies that the at least one modification has been successfully applied by inspecting a resulting state of the user interface after the simulated user interactions have been executed.
22. The computer-implemented method of clause 1, further comprising:
determining a severity classification for at least one identified entitlement violation based on a degree of semantic mismatch between the obtained entitlement data and at least one of the one or more access control policies, the user status data, or the role assignment data maintained in the identity governance platform, the severity classification comprising at least a first severity level and a second severity level; and
selecting, based on the severity classification, between an immediate execution path and an asynchronous execution path for the at least one modification, where:
   for an entitlement violation classified at the first severity level, the AI agent autonomously executes the at least one modification by generating and executing the simulated user interactions with the target user interface element responsive to the first severity classification alone; and
   for an entitlement violation classified at the second severity level, execution of the at least one modification by the AI agent is suspended pending receipt of an approval signal, a certifiable compliance report describing the entitlement violation and a recommended modification is generated, an approval request is transmitted to a designated reviewer, and the AI agent executes the at least one modification responsive to receipt of the approval signal from the designated reviewer.
23. The computer-implemented method of clause 22, where the first severity level comprises at least one of:
an active user account in the at least one enterprise system accessible for entitlement management only through the user interface for a user marked as terminated or departed in a human resources system or the identity governance platform, the active user account constituting an orphan account; or
an active user account with administrative or privileged access for a user whose role assignment in the one or more access control policies does not include administrative or privileged access;
and where, responsive to detecting the first severity level violation, the AI agent autonomously executes the at least one modification comprising at least one of revoking access privileges or deactivating the user account by generating and executing the simulated user interactions with the user interface.
24. The computer-implemented method of clause 22, where the second severity level comprises at least one of:
a user possessing access privileges in the at least one enterprise system that exceed those defined for the user's current role by the one or more access control policies where the user's employment status remains active; or
a user retaining access privileges associated with a previously held role where the one or more access control policies specify a grace period for role transitions;
and where the certifiable compliance report comprises at least the user identifier, the enterprise system identifier, the entitlement violation, the recommended modification, and a reference to the applicable access control policy.
25. The computer-implemented method of clause 22, where the approval signal comprises at least one of:
a cryptographic approval token signed by the designated reviewer, the cryptographic approval token comprising at least an identifier of the designated reviewer, a timestamp of the approval, and a reference to the entitlement modification being approved; or
a programmatic approval signal received via an application programming interface of the identity governance platform or the access management system;
and where, responsive to receipt of the approval signal, the AI agent resumes execution by generating and executing the simulated user interactions with the user interface to apply the approved at least one modification.
26. The computer-implemented method of clause 22, where, responsive to the AI agent executing the at least one modification via the immediate execution path or the asynchronous execution path, the AI agent verifies the at least one modification by inspecting a resulting state of the user interface after the simulated user interactions have been executed.
27. The computer-implemented method of clause 1, further comprising generating, for at least one modification by controlling access privileges, a tamper-evident log record stored in a secure repository, the tamper-evident log record comprising at least:
a user identifier;
an identifier of the enterprise system in which the at least one modification was applied;
a timestamp of the at least one modification;
a description of the at least one modification performed; and
a result status indicating whether the at least one modification was successfully applied.
28. The computer-implemented method of clause 27, where the tamper-evident log record is formatted for compliance reporting under at least one of:
the Sarbanes-Oxley Act requiring demonstrable control over user access to financial systems;
the Health Insurance Portability and Accountability Act requiring audit trails for access to protected health information; or
the General Data Protection Regulation requiring verifiable access control and data subject rights enforcement.
29. The computer-implemented method of clause 27, where the tamper-evident log record is surfaced in a centralized governance dashboard accessible to administrator and compliance personnel, the centralized governance dashboard providing real-time visibility into entitlement modification status across queried enterprise systems, including both enterprise systems queried via the programmatic interface and enterprise systems accessed only through the user interface.
30. The computer-implemented method of clause 27, where the tamper-evident log record further comprises an indication of whether the at least one modification was executed via the application programming interface or via the AI agent interacting with the user interface, the indication enabling differentiated audit review of programmatic and AI-agent-mediated entitlement modifications.
31. The computer-implemented method of clause 27, where the tamper-evident log record further comprises:
the severity classification assigned to the entitlement violation;
an indication of whether the at least one modification was executed via the immediate execution path or the asynchronous execution path; and
for an at least one modification executed via the asynchronous execution path, an identifier of the designated reviewer, a timestamp of the approval signal, and a duration between detection of the entitlement violation and execution of the at least one modification.
32. A system for managing access entitlements across a plurality of enterprise systems, the system comprising:
a computer processor;
a non-transitory computer-readable storage medium storing instructions; and
an AI agent comprising one or more modules communicatively coupled to at least one of the plurality of enterprise systems and configured to process user interface elements of the at least one enterprise system;
where the computer processor, executing the instructions, performs actions comprising:
   receiving an audit trigger from an identity governance platform or an access management system;
   obtaining entitlement data from the plurality of enterprise systems, the plurality of enterprise systems including at least one enterprise system accessible for entitlement management only through a user interface, the obtaining comprising querying, via a programmatic interface, enterprise systems that expose an entitlement management application programming interface to retrieve entitlement data therefrom, and navigating, by the AI agent, the user interface of the at least one enterprise system to extract entitlement data therefrom;
   identifying one or more entitlement violations in the at least one enterprise system accessible for entitlement management only through the user interface by evaluating the obtained entitlement data against one or more access control policies, and by performing a cross-source comparison between the entitlement data extracted by the AI agent and user status data and role assignment data maintained in the identity governance platform; and
   for at least one identified entitlement violation, executing at least one modification by controlling access privileges, where for an enterprise system that exposes the entitlement management application programming interface, the at least one modification is executed by issuing commands via the application programming interface, and where for the at least one enterprise system accessible for entitlement management only through the user interface, the at least one modification is executed by the AI agent detecting user interface elements rendered on the user interface using a computer vision algorithm, the user interface elements being associated with access privilege controls, interpreting textual content associated with the detected user interface elements using a language model to identify a target user interface element corresponding to the at least one modification, and applying the at least one modification by generating and executing simulated user interactions with the target user interface element.
33. The system of clause 32, where the AI agent comprises a perception module configured to detect and classify the user interface elements associated with access privilege controls using the computer vision algorithm, a semantic interpretation module configured to interpret the textual content associated with the detected user interface elements using the language model, and an execution module configured to generate and execute the simulated user interactions with the target user interface element to apply the at least one modification.
34. The system of clause 32, the actions further comprising:
classifying at least one identified entitlement violation at one of a first severity level or a second severity level based on a degree of semantic mismatch between the obtained entitlement data and at least one of the one or more access control policies, the user status data, or the role assignment data;
for an entitlement violation classified at the first severity level, the AI agent autonomously executing the at least one modification responsive to the first severity classification alone; and
for an entitlement violation classified at the second severity level, suspending execution pending receipt of an approval signal from a designated reviewer.
35. The system of clause 32, the actions further comprising generating, for at least one modification by controlling access privileges, a tamper-evident log record comprising at least a user identifier, an identifier of the enterprise system, a timestamp, a description of the at least one modification performed, and a result status.
36. The system of clause 32, the actions further comprising periodically monitoring entitlement data from the at least one enterprise system accessible for entitlement management only through the user interface to identify access anomalies or policy drifts prior to receipt of the audit trigger.
37. A non-transitory computer-readable storage medium storing instructions that, when executed by a computer processor, perform actions comprising:
receiving an audit trigger from an identity governance platform or an access management system;
obtaining entitlement data from a plurality of enterprise systems, the plurality of enterprise systems including at least one enterprise system accessible for entitlement management only through a user interface, the obtaining comprising querying, via a programmatic interface, enterprise systems that expose an entitlement management application programming interface to retrieve entitlement data therefrom, and navigating, by an AI agent, the user interface of the at least one enterprise system to extract entitlement data therefrom;
identifying one or more entitlement violations in the at least one enterprise system accessible for entitlement management only through the user interface by evaluating the obtained entitlement data against one or more access control policies, and by performing a cross-source comparison between the entitlement data extracted by the AI agent and user status data and role assignment data maintained in the identity governance platform; and
for at least one identified entitlement violation, executing at least one modification by controlling access privileges, where for an enterprise system that exposes the entitlement management application programming interface, the at least one modification is executed by issuing commands via the application programming interface, and where for the at least one enterprise system accessible for entitlement management only through the user interface, the at least one modification is executed by the AI agent detecting user interface elements rendered on the user interface using a computer vision algorithm, the user interface elements being associated with access privilege controls, interpreting textual content associated with the detected user interface elements using a language model to identify a target user interface element corresponding to the at least one modification, and applying the at least one modification by generating and executing simulated user interactions with the target user interface element.
38. The non-transitory computer-readable storage medium of clause 37, the actions further comprising:
classifying at least one identified entitlement violation at one of a first severity level or a second severity level;
for an entitlement violation classified at the first severity level, the AI agent autonomously executing the at least one modification responsive to the first severity classification alone; and
for an entitlement violation classified at the second severity level, suspending execution, generating a compliance report, and executing the at least one modification responsive to receipt of a cryptographic or programmatic approval signal from a designated reviewer.
39. The non-transitory computer-readable storage medium of clause 37, the actions further comprising generating, for at least one modification by controlling access privileges, a tamper-evident log record comprising at least a user identifier, an identifier of the enterprise system, a timestamp, a description of the at least one modification performed, and a result status.
40. A computer-implemented method for managing user entitlements across a plurality of enterprise applications, the method comprising:
receiving, by a governance trigger interface, an audit trigger from an identity governance system, the audit trigger being at least one of a periodic trigger generated on a recurring audit cycle or an event-driven trigger generated in response to a user's organizational departure or a user role reassignment;
querying, by an entitlement discovery engine, the plurality of enterprise applications to obtain entitlement data comprising at least one of user identifiers, roles, or role-specific attributes, the querying comprising:
(i) for an enterprise application that exposes a programmatic interface, retrieving the entitlement data via the programmatic interface; and
(ii) for at least one enterprise application accessible for entitlement management only through a user interface, navigating, by an AI agent, the user interface of the at least one enterprise application to extract the entitlement data;
identifying, by a policy evaluation engine, one or more entitlement violations in the at least one enterprise application by evaluating the obtained entitlement data against predefined access control policies and by performing a cross-source comparison between the entitlement data extracted by the AI agent and user status data and role assignment data maintained in the identity governance system, the one or more entitlement violations including at least one of a user retaining access privileges after organizational departure or a user retaining access privileges associated with a previously held role;
determining, by the policy evaluation engine, a severity classification for at least one identified entitlement violation based on a degree of semantic mismatch between the obtained entitlement data and at least one of the predefined access control policies, the user status data, or the role assignment data, the severity classification comprising at least a first severity level and a second severity level;
executing, by an entitlement actioning module responsive to the at least one identified entitlement violation, at least one entitlement modification comprising revoking or downgrading access privileges, where:
for the enterprise application that exposes the programmatic interface, the at least one entitlement modification is executed by issuing commands via the programmatic interface; and
for the at least one enterprise application accessible for entitlement management only through the user interface, the at least one entitlement modification is executed by the AI agent, the AI agent comprising:
a perception module configured to detect and classify user interface elements associated with access privilege controls rendered on the user interface using a computer vision algorithm;
a semantic interpretation module configured to interpret textual content associated with the detected user interface elements using a language model and to identify, from the detected user interface elements, a target user interface element corresponding to the at least one entitlement modification; and
an execution module configured to apply the at least one entitlement modification by generating and executing simulated user interactions with the target user interface element;
where the entitlement actioning module selects, based on the severity classification, between an immediate execution path in which the execution module of the AI agent generates and executes the simulated user interactions to apply the at least one entitlement modification responsive to the first severity classification alone, and an asynchronous execution path in which the entitlement actioning module suspends the execution module pending receipt of an approval signal, generates a certifiable compliance report, transmits an approval request to a designated reviewer, and, responsive to receipt of a cryptographic approval signal or a programmatic approval signal from the designated reviewer, directs the execution module to resume generating and executing the simulated user interactions to apply the at least one entitlement modification; and
generating, by an audit logging module, for at least one entitlement modification, a tamper-evident log record comprising at least a user identifier, an identifier of the enterprise application in which the at least one entitlement modification was applied, a timestamp of the at least one entitlement modification, a description of the at least one entitlement modification performed, a result status indicating whether the at least one entitlement modification was successfully applied, and the severity classification assigned to the entitlement violation.
41. The computer-implemented method of clause 40, where the perception module is configured to detect user interface elements comprising at least one of entitlement selectors, user role dropdowns, access revocation buttons, or user deactivation controls, and to classify the detected user interface elements by their function relative to access privilege management.
42. The computer-implemented method of clause 40, where the semantic interpretation module is configured to distinguish between user interface elements associated with different access privilege actions, including labels indicating at least one of:
revocation of access;
modification of a role;
deactivation of an account; or
downgrading of privileges;
and to select the target user interface element corresponding to the at least one entitlement modification.
43. The computer-implemented method of clause 40, where the execution module is configured to generate and execute the simulated user interactions comprising at least one of mouse click simulation, keyboard input simulation, or form field population, to apply the at least one entitlement modification through the user interface of the at least one enterprise application.
44. The computer-implemented method of clause 40, where the perception module, the semantic interpretation module, and the execution module operate sequentially, where the perception module first detects and classifies the user interface elements rendered on the user interface, the semantic interpretation module then interprets the detected user interface elements to identify the target user interface element corresponding to the at least one entitlement modification, and the execution module then generates and executes the simulated user interactions with the target user interface element.
45. The computer-implemented method of clause 40, where the AI agent is further configured to dynamically adapt to changes in the user interface of the at least one enterprise application, including repositioned user interface elements, modified labels, and updated interface layouts, by the perception module re-detecting the user interface elements after a change in the user interface and the semantic interpretation module re-interpreting the textual content associated with the re-detected user interface elements to maintain identification of the access privilege actions despite the change in the user interface.
46. The computer-implemented method of clause 45, where dynamically adapting to the changes in the user interface comprises the perception module re-detecting the user interface elements associated with access privilege controls after a change in user interface layout and the semantic interpretation module re-interpreting textual content associated with the re-detected user interface elements to maintain identification of the access privilege actions despite the change in user interface layout.
47. The computer-implemented method of clause 40, where the first severity level comprises detecting, by the cross-source comparison between the entitlement data extracted by the AI agent from the user interface of the at least one enterprise application and the user status data maintained in the identity governance system, an active user account in the at least one enterprise application for a user whose employment has been terminated, the active user account constituting an orphan account, and where, responsive to detecting the orphan account, the entitlement actioning module directs the AI agent to autonomously execute the at least one entitlement modification comprising at least one of revoking the access privileges or deactivating the user account, the execution module generating and executing the simulated user interactions with user deactivation controls detected by the perception module and identified by the semantic interpretation module responsive to the first severity classification alone.
48. The computer-implemented method of clause 40, where the first severity level further comprises detecting an active user account with administrative or privileged access in the at least one enterprise application for a user whose current role assignment in the predefined access control policies does not include administrative or privileged access, and where, responsive to detecting the mismatched administrative access, the entitlement actioning module directs the AI agent to autonomously execute the at least one entitlement modification comprising at least one of revoking the administrative access privileges or downgrading the user's access to a privilege level consistent with the user's current role responsive to the first severity classification alone.
49. The computer-implemented method of clause 40, where the second severity level comprises detecting a user possessing access privileges in the at least one enterprise application that exceed those defined for the user's current role by the predefined access control policies, and where, responsive to detecting the excess privileges, the entitlement actioning module:
suspends the execution module from generating the simulated user interactions with the user interface;
generates a certifiable compliance report comprising at least the user identifier, the identifier of the at least one enterprise application, a description of the excess privileges, the recommended at least one entitlement modification comprising downgrading access privileges to a privilege level consistent with the user's current role, and a reference to an applicable predefined access control policy;
transmits an approval request to a designated reviewer via the identity governance system; and
responsive to receipt of an approval signal from the designated reviewer, directs the AI agent to resume execution by generating and executing the simulated user interactions with the user interface to apply the approved at least one entitlement modification.
50. The computer-implemented method of clause 40, where the approval signal comprises at least one of:
a cryptographic approval token signed by the designated reviewer, the cryptographic approval token comprising at least an identifier of the designated reviewer, a timestamp of the approval, and a reference to the at least one entitlement modification being approved; or
a programmatic approval signal received via an application programming interface of the identity governance system or an access management system.
51. The computer-implemented method of clause 49, where, responsive to receipt of the approval signal, the entitlement actioning module directs the AI agent to execute the approved at least one entitlement modification, the execution module generates and executes the simulated user interactions with user interface elements associated with access privilege controls to downgrade the user's access privileges, and the AI agent verifies the at least one entitlement modification by inspecting a resulting state of the user interface after the simulated user interactions have been executed.
52. The computer-implemented method of clause 40, where the periodic trigger is generated by the identity governance system on a recurring schedule comprising at least one of a 30-day, 60-day, or 90-day audit cycle.
53. The computer-implemented method of clause 40, where the event-driven trigger is generated in response to at least one of detection of a user's organizational departure, a user role reassignment, a project completion event, or a security incident requiring immediate access review.
54. The computer-implemented method of clause 40, further comprising periodically monitoring, by the entitlement discovery engine, entitlement data from the at least one enterprise application accessible for entitlement management only through the user interface to identify access anomalies or policy drifts prior to receipt of the audit trigger, and generating an alert upon detection of an entitlement violation prior to a scheduled audit cycle.
55. The computer-implemented method of clause 40, where navigating, by the AI agent, the user interface of the at least one enterprise application to extract the entitlement data comprises the AI agent autonomously navigating to an entitlement management section of the at least one enterprise application and extracting user roles and role-specific entitlements displayed within the user interface.
56. The computer-implemented method of clause 40, where querying, by the entitlement discovery engine, the plurality of enterprise applications further comprises mapping the entitlement data retrieved via the programmatic interface and the entitlement data extracted by the AI agent from the user interface into a unified entitlement dataset according to a common entitlement schema specifying field types including at least user identifiers, role identifiers, and access privilege identifiers, the unified entitlement dataset spanning both the enterprise applications queried via the programmatic interface and the at least one enterprise application accessed only through the user interface, the unified entitlement dataset enabling the policy evaluation engine to identify the one or more entitlement violations across an enterprise application estate.
57. The computer-implemented method of clause 40, where the at least one enterprise application accessible for entitlement management only through the user interface comprises at least one of a legacy on-premises application, a third-party web application, a graphical user interface only platform, or a disconnected enterprise tool not integrated with an identity and access management system.
58. The computer-implemented method of clause 40, where the predefined access control policies specify permissible user-role combinations for the plurality of enterprise applications, and where a user possessing a role not among the permissible user-role combinations for a given enterprise application constitutes an entitlement violation.
59. The computer-implemented method of clause 40, where the predefined access control policies further comprise at least one of:
department-based access policies specifying that users assigned to a particular department are permitted access to a defined set of enterprise applications;
least privilege policies specifying that users are permitted the minimum access privileges necessary for the user's current role; or
separation of duties policies specifying that a single user is prohibited from holding access privileges to two or more enterprise applications that together create a conflict of interest.
60. The computer-implemented method of clause 40, where, for the at least one enterprise application accessible for entitlement management only through the user interface, the AI agent is further configured to authenticate to the at least one enterprise application, prior to interacting with the user interface, by retrieving credentials from a credential vault that stores credentials associated with the at least one enterprise application in an encrypted format, the AI agent retrieving only credentials whose version is current, whose rotation status is not pending, and whose time-to-live has not expired at a time of authentication.
61. The computer-implemented method of clause 60, where the credential vault supports credential versioning, credential rotation, and time-to-live enforcement, and the AI agent retrieves only credentials that are valid and within expiration boundaries at the time of authentication.
62. The computer-implemented method of clause 40, where the tamper-evident log record is formatted for compliance reporting under at least one of:
the Sarbanes-Oxley Act requiring demonstrable control over user access to financial systems;
the Health Insurance Portability and Accountability Act requiring audit trails for access to protected health information; or
the General Data Protection Regulation requiring verifiable access control and data subject rights enforcement.
63. The computer-implemented method of clause 40, where the tamper-evident log record is surfaced in a centralized governance dashboard accessible to administrator and compliance personnel, the centralized governance dashboard providing real-time visibility into entitlement modification status across queried enterprise applications.
64. The computer-implemented method of clause 40, where the tamper-evident log record further comprises an indication of whether the at least one entitlement modification was executed via the programmatic interface or via the AI agent interacting with the user interface, the indication enabling differentiated audit review of programmatic and AI-agent-mediated entitlement modifications.
65. The computer-implemented method of clause 40, where the tamper-evident log record further comprises a reasoning trace generated by the semantic interpretation module, the reasoning trace recording which user interface elements were detected by the perception module, how the semantic interpretation module interpreted the detected user interface elements, and which user interface element was selected as the target user interface element for the at least one entitlement modification.
66. The computer-implemented method of clause 40, where the tamper-evident log record further comprises:
the severity classification assigned to the entitlement violation by the policy evaluation engine;
an indication of whether the at least one entitlement modification was executed via the immediate execution path or the asynchronous execution path;
for an at least one entitlement modification executed via the asynchronous execution path, an identifier of the designated reviewer, a timestamp of the approval signal, and a cryptographic hash or signature of the approval signal; and
a duration between detection of the entitlement violation and execution of the at least one entitlement modification.
67. A system for managing user entitlements across a plurality of enterprise applications, the system comprising:
a computer processor;
a non-transitory computer-readable storage medium storing instructions;
a governance trigger interface configured to receive an audit trigger from an identity governance system;
an entitlement discovery engine configured to retrieve entitlement data from the plurality of enterprise applications, including both an enterprise application that exposes a programmatic interface and at least one enterprise application accessible for entitlement management only through a user interface;
an AI agent comprising:
a perception module configured to detect and classify user interface elements associated with access privilege controls using a computer vision algorithm;
a semantic interpretation module configured to interpret textual content associated with the detected user interface elements using a language model and to identify a target user interface element corresponding to an entitlement modification; and
an execution module configured to generate and execute simulated user interactions with the target user interface element;
a policy evaluation engine configured to evaluate the retrieved entitlement data against predefined access control policies and to perform a cross-source comparison between the entitlement data extracted by the AI agent and user status data and role assignment data maintained in the identity governance system to identify one or more entitlement violations, and to determine a severity classification for at least one identified entitlement violation comprising at least a first severity level and a second severity level;
an entitlement actioning module configured to execute at least one entitlement modification, the entitlement actioning module selecting between an immediate execution path for an entitlement violation classified at the first severity level and an asynchronous execution path for an entitlement violation classified at the second severity level; and
an audit logging module configured to generate, for at least one entitlement modification, a tamper-evident log record comprising at least a user identifier, an identifier of the enterprise application, a timestamp, a description of the at least one entitlement modification performed, a result status, and the severity classification.
68. The system of clause 67, where the AI agent is further configured to dynamically adapt to changes in the user interface, including repositioned user interface elements, modified labels, and updated interface layouts, by the perception module re-detecting the user interface elements after a change in the user interface and the semantic interpretation module re-interpreting the textual content associated with the re-detected user interface elements.
69. The system of clause 67, where, for an entitlement violation classified at the first severity level, the entitlement actioning module directs the AI agent to autonomously execute the at least one entitlement modification responsive to the first severity classification alone, and where, for an entitlement violation classified at the second severity level, the entitlement actioning module suspends the execution module, generates a certifiable compliance report, and directs the AI agent to execute the at least one entitlement modification responsive to receipt of a cryptographic approval signal or a programmatic approval signal from a designated reviewer.
70. The system of clause 67, where the tamper-evident log record is formatted for compliance reporting under at least one of the Sarbanes-Oxley Act, the Health Insurance Portability and Accountability Act, or the General Data Protection Regulation.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A computer-implemented method for managing access entitlements across a plurality of enterprise systems, the method comprising:
obtaining entitlement data from the plurality of enterprise systems comprising at least one enterprise system accessible for entitlement management through a user interface, the entitlement data being extracted from the at least one enterprise system by an AI agent navigating the user interface of the at least one enterprise system;
identifying one or more entitlement violations by evaluating the entitlement data extracted by the AI agent against one or more access policies and by comparing the entitlement data extracted by the AI agent with user status data maintained in an identity governance system; and
executing, in response to the one or more entitlement violations identified, at least one modification by controlling access privileges in the at least one enterprise system through the user interface, the at least one modification being applied by the AI agent, the AI agent:
detecting user interface elements corresponding to access privilege controls rendered on the user interface of the at least one enterprise system using a computer vision algorithm,
interpreting textual content associated with the user interface elements detected by the AI agent using a language model to identify, from the user interface elements detected, a target user interface element corresponding to the at least one modification, and
applying the at least one modification to the access privileges by generating and executing simulated user interactions with the target user interface element identified by the AI agent.

2. The computer-implemented method of claim 1, wherein comparing the entitlement data extracted by the AI agent with the user status data maintained in the identity governance system identifies a mismatch between the entitlement data extracted from the user interface and the user status data, the mismatch forming a basis for at least one entitlement violation among the one or more entitlement violations identified.

3. The computer-implemented method of claim 1, wherein obtaining the entitlement data is initiated upon receipt of a trigger generated by the identity governance system, the trigger comprising at least one of: a periodic trigger generated on a recurring audit cycle, or an event-driven trigger generated in response to an organizational departure of a user or a role reassignment.

4. The computer-implemented method of claim 1, wherein the at least one modification applied by the AI agent through the simulated user interactions with the target user interface element comprises at least one of revoking the access privileges or downgrading the access privileges to a lower privilege level.

5. The computer-implemented method of claim 1, wherein the entitlement data obtained from the plurality of enterprise systems comprises user identifiers, roles, and role-specific attributes, the user identifiers, the roles, and the role-specific attributes being evaluated against the access policies to identify the one or more entitlement violations.

6. The computer-implemented method of claim 1, wherein the access policies comprise predefined access control policies specifying permissible user-role combinations for the plurality of enterprise systems, and wherein evaluating the entitlement data extracted by the AI agent comprises determining whether a user-role combination indicated by the entitlement data is among the permissible user-role combinations specified by the predefined access control policies.

7. The computer-implemented method of claim 1, wherein identifying the one or more entitlement violations comprises identifying at least one of:
a user retaining access privileges after departing an organization or having employment terminated;
a user retaining access privileges associated with a previously held role after transitioning to a different role; or
a user possessing access privileges exceeding access privileges defined for a current role of the user by the access policies,
and wherein the at least one modification corresponds to remediation of an identified entitlement violation.

8. The computer-implemented method of claim 1, wherein executing the at least one modification comprises:
for enterprise systems among the plurality of enterprise systems that expose a programmatic interface for entitlement management, issuing application programming interface commands via the programmatic interface to control the access privileges; and
for the at least one enterprise system accessible for entitlement management through the user interface, invoking the AI agent to interact with the user interface to control the access privileges through the simulated user interactions.

9. The computer-implemented method of claim 1, wherein the AI agent comprises:
a perception module configured to detect and classify the user interface elements corresponding to the access privilege controls using the computer vision algorithm and to output the user interface elements detected;
a semantic interpretation module configured to receive the user interface elements detected from the perception module, to interpret the textual content associated with the user interface elements detected using the language model, and to output the target user interface element corresponding to the at least one modification; and
an execution module configured to receive the target user interface element from the semantic interpretation module and to generate and execute the simulated user interactions with the target user interface element to apply the at least one modification.

10. The computer-implemented method of claim 9, wherein the semantic interpretation module is configured to distinguish between user interface elements corresponding to different access privilege actions, including distinguishing between labels indicating revocation of access, modification of a role, and deactivation of an account, and to select the target user interface element based on a correspondence between an interpreted label and the at least one modification.

11. The computer-implemented method of claim 2, further comprising:
determining a severity classification for each entitlement violation based on a degree of semantic mismatch between the entitlement data extracted by the AI agent from the user interface of the at least one enterprise system and the user status data maintained in the identity governance system, the severity classification comprising at least a first severity level and a second severity level; and
selecting, based on the severity classification determined, between an immediate execution path and an asynchronous execution path for the at least one modification, the execution path selected governing the AI agent in applying the at least one modification.

12. The computer-implemented method of claim 11, wherein when the entitlement violation is classified at the first severity level, the immediate execution path is selected, and the AI agent autonomously executes the at least one modification by generating and executing the simulated user interactions with the target user interface element upon classification of the at least one entitlement violation at the first severity level.

13. The computer-implemented method of claim 12, wherein the first severity level comprises an orphan account, the orphan account being an active user account in the at least one enterprise system for a user whose status in the user status data maintained in the identity governance system indicates termination, the orphan account being identified through a comparison of the entitlement data extracted by the AI agent with the user status data, and wherein upon identification of the orphan account, the AI agent autonomously executes the at least one modification comprising at least one of revoking the access privileges or deactivating the active user account by generating and executing the simulated user interactions with the target user interface element identified as a user deactivation control.

14. The computer-implemented method of claim 11, wherein the second severity level comprises a user possessing access privileges in the at least one enterprise system that exceed access privileges defined for a current role of the user by the access policies, the second severity level being identified through a comparison of the entitlement data extracted by the AI agent with role assignment data maintained in the identity governance system, and wherein when each entitlement violation is classified at the second severity level, the asynchronous execution path is selected and:
execution of the at least one modification by the AI agent is suspended pending receipt of an approval signal;
a compliance report is generated, the compliance report comprising a user identifier, an enterprise system identifier, a description of the at least one entitlement violation classified at the second severity level, a recommended modification, and a reference to an applicable access policy among the access policies;
an approval request is transmitted, together with the compliance report, to a designated reviewer; and
the AI agent executes the at least one modification upon receipt of the approval signal from the designated reviewer.

15. The computer-implemented method of claim 14, wherein the approval signal received from the designated reviewer comprises at least one of:
a cryptographic approval token signed by the designated reviewer, the cryptographic approval token comprising at least an identifier of the designated reviewer, a timestamp of an approval signal, and a reference to the at least one modification approved by the designated reviewer; or
a programmatic approval signal received via an application programming interface from the designated reviewer,
and wherein upon receipt of the approval signal, the AI agent resumes execution of the at least one modification by generating and executing the simulated user interactions with the target user interface element to apply an approved modification corresponding to the recommended modification of the compliance report.

16. The computer-implemented method of claim 11, further comprising generating, for each modification applied by the AI agent through the simulated user interactions, a tamper-evident log record, the tamper-evident log record comprising at least a user identifier, an identifier of the at least one enterprise system in which the modification was applied, a timestamp of the modification, a description of the modification performed, a result status indicating an outcome of the modification, the severity classification determined for the at least one entitlement violation corresponding to the modification, and an indication of whether the modification was applied via the immediate execution path or the asynchronous execution path.

17. The computer-implemented method of claim 8, wherein invoking the AI agent further comprises authenticating the AI agent to the at least one enterprise system, prior to interaction with the user interface, using credentials retrieved from a credential vault, the credential vault storing the credentials in an encrypted format and supporting credential versioning, rotation, and time-to-live enforcement, and wherein the AI agent uses the credentials retrieved to access the user interface of the at least one enterprise system for the simulated user interactions.

18. A system for managing access entitlements across a plurality of enterprise systems, the system comprising:
a computer processor;
a non-transitory computer-readable storage medium storing instructions; and
an AI agent communicatively coupled to at least one enterprise system of the plurality of enterprise systems and configured to interact with a user interface of the at least one enterprise system, the AI agent comprising:
a perception module configured to detect user interface elements corresponding to access privilege controls rendered on the user interface using a computer vision algorithm and to output user interface elements detected;
a semantic interpretation module configured to receive the user interface elements detected from the perception module, to interpret textual content associated with the user interface elements detected using a language model, and to output a target user interface element corresponding to at least one modification; and
an execution module configured to receive the target user interface element from the semantic interpretation module and to generate and execute simulated user interactions with the target user interface element to apply the at least one modification by controlling access privileges;
wherein the computer processor, executing the instructions, performs actions comprising:
obtaining entitlement data from the plurality of enterprise systems comprising the at least one enterprise system, the entitlement data being extracted from the at least one enterprise system by the AI agent navigating the user interface;
identifying one or more entitlement violations by evaluating the entitlement data extracted by the AI agent against one or more access policies and by comparing the entitlement data extracted by the AI agent with user status data maintained in an identity governance system; and
executing, in response to each entitlement violation identified, the at least one modification by controlling the access privileges in the at least one enterprise system through the user interface, the at least one modification being applied by the AI agent through the simulated user interactions with the target user interface element.

19. The system of claim 18, the actions further comprising:
determining a severity classification for each entitlement violation among the one or more entitlement violations identified based on a degree of semantic mismatch between the entitlement data extracted by the AI agent from the user interface of the at least one enterprise system and the user status data maintained in the identity governance system, the severity classification comprising at least a first severity level and a second severity level;
selecting, based on the severity classification determined, between an immediate execution path and an asynchronous execution path for the at least one modification;
when an entitlement violation is classified at the first severity level, directing the AI agent, via the immediate execution path, to autonomously execute the at least one modification, the AI agent generating and executing the simulated user interactions with the target user interface element identified as a user deactivation control or an access revocation control upon classification of the entitlement violation at the first severity level; and
when an entitlement violation is classified at the second severity level, directing the AI agent, via the asynchronous execution path, to suspend execution of the at least one modification, generating a compliance report, transmitting an approval request together with the compliance report to a designated reviewer, and directing the AI agent to resume execution of the at least one modification upon receipt of a cryptographic approval token or a programmatic approval signal from the designated reviewer.

20. A non-transitory computer-readable storage medium storing instructions that when executed by a computer processor perform actions comprising:
obtaining entitlement data from a plurality of enterprise systems comprising at least one enterprise system accessible for entitlement management through a user interface, the entitlement data being extracted from the at least one enterprise system by an AI agent navigating the user interface;
identifying one or more entitlement violations by evaluating the entitlement data extracted by the AI agent against one or more access policies and by comparing the entitlement data extracted by the AI agent with user status data maintained in an identity governance system;
determining a severity classification for each entitlement violation among the one or more entitlement violations identified based on a degree of semantic mismatch between the entitlement data extracted by the AI agent from the user interface and the user status data maintained in the identity governance system, the severity classification comprising at least a first severity level and a second severity level; and
executing, in response to the each entitlement violation identified and based on the severity classification determined, at least one modification by controlling access privileges in the at least one enterprise system through the user interface, the at least one modification being applied by the AI agent, the AI agent:
detecting user interface elements corresponding to access privilege controls rendered on the user interface using a computer vision algorithm,
interpreting textual content associated with the user interface elements detected using a language model to identify, from the user interface elements detected, a target user interface element corresponding to the at least one modification,
when an entitlement violation is classified at the first severity level, autonomously applying the at least one modification by generating and executing simulated user interactions with the target user interface element upon classification of the entitlement violation at the first severity level, and
when an entitlement violation is classified at the second severity level, applying the at least one modification by generating and executing the simulated user interactions with the target user interface element upon receipt of an approval signal from a designated reviewer.
